(19) United States
(12) Patent Application Publication
(10) Pub. No.: US 2006/0025222 A1
(43) Pub. Date: Feb. 2, 2006

(54) Gaming machine, service providing system, server and mobile device

(75) Inventor: Yuichi Sekine, Koto-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/188,052

(22) Filed: Jul. 25, 2005

(30) Foreign Application Priority Data
Jul. 27, 2004 (JP) 2004-219258
Jul. 27, 2004 (JP) 2004-219259
Jul. 27, 2004 (JP) 2004-219260
Aug. 4, 2004 (JP) 2004-228618

(51) Int. Cl. G06F 17/00

(52) U.S. Cl. 463/42

(57) ABSTRACT

A gaming machine is disclosed having a lottery device for performing the lottery to determine whether to afford a premium to a player, and a code information display device displaying code information which is coded based on coding lottery outcome data related to an outcome of the lotteries so that an image capture device captures the code information from an outside of the gaming machine.

### CROSS REFERENCE TO RELATED APPLICATIONS

This invention is based upon and claims the benefit of priority from the prior Japanese Patent Applications No. 2004-219258, with a filing date of Jul. 27, 2004; No. P2004-219259 with a filing date of Jul. 27, 2004; No. P2004-219260 with a filing data of Jul. 27, 2004; and No. P2004-228618 with a filing data of Aug. 4, 2004; the entire contents of which are incorporated herein by reference.

### BACKGROUND OF THE INVENTION

1. Field of the Invention

The present invention relates to a gaming machine such as, a Pachi-slot Gaming Machine (Japanese Slot Machine), a Pachinko Gaming Machine (Japanese Pinball) and a Pinball machine, a service providing system having the gaming machine, a server and a mobile device for forming the service providing system.

2. Description of the Related Art

In a Game arcade installed with gaming machines such as Pachi-slot gaming machines (see, for instance, Japanese Patent Laid Open Publication No. P2000-210413) and Pachinko Gaming Machines, attempts have heretofore been undertaken to provide a service wherein upon starting a BB (Big Bonus) game (hereinafter referred to as BB) or an RB (Regular Bonus) game (hereinafter referred to as RB) or the like of the gaming machine, effects are provided by, for instance, an announcement or variation in BGM inside the pachinko parlor to provide notification to a player per se or other players inside the pachinko parlor to further raise excitements on the BB or the RB (this service referred to as a “personal service”).

In the meanwhile, in the recent years, images and music used in the gaming machines, such as the pachi-slot gaming machines and the pinball gaming machines, have been progressed in elaborated designs that with advances in image technologies or information processing technologies, have been approaching to not only as effects for the gaming machine but also as an effect comparable to music appearing on animations or hit charts credited with high artistic reputations overseas. Such images and music have been used as, for instance, ring alerts (so-called Chaku-Melo: (Cellular Phone Ring Melody, hereinafter referred to as “Chaku-Melo”)) or awaiting images (wallpapers) of mobile phones. Further, with a home-use gaming machine (A gaming machine for home use/Video Game System), simulation games imitated for actual pinball games or pachi-slot games have been marking higher ranks in records of game software in sale charts than those of games in other genres and the number of people fanatic about the pachi-slot gaming machines and pinball gaming machines has been increasing in an outstanding fashion.

However, if personal services are provided by the pachinko parlor's stuffs for confirming the starting of the BB or RB, an issue arises with an increase in personnel cost. Further, if a large number of BB and RB winnings occur in the pachinko parlor at the same time, situation arises for adequate services to be hardly provided to the whole of the relevant players, resulting in a fear of discomfort predetermined to the players after all. Moreover, even if such a service function as a service advantageous for the pachinko parlor, this service does not function as a service with any advantage for a gaming machine manufacturer. Thus, it is strongly desired for upcoming services to appear with advantages for the gaming machine manufacturer available to be executed by the game arcade. In recent years, specifically, there are number of players who have strong supports and attachments on characters or music used in effects of the gaming machine manufactured by a certain gaming machine manufacturer and in view of a current condition with an increase in the number of customers fanatic about the gaming machine manufacturer, there has been a strong demand for services to be provided in a way to allow the players to have supports and attachments on the gaming machines.

In contrast, although related goods (premiums) (such as, for instance, Chaku-Melo, awaiting image and game software, etc.) of the gaming machines, set forth above, are advantageous for the gaming machine manufacturer in acquiring supports of the players for the own gaming machines, no advantages appear for the game arcade. Therefore, under current conditions wherein for the game arcade, there has been an increasing trend in the number of customers fanatic about a particular gaming machine manufacturer, there is a strong demand for services to appear that make it possible to allow the supports of the players for such a particular gaming machine manufacturer to result in improvement over the ability to pull in more customers.

Further, among the gaming machines such as the pachi-slot gaming machines and pinball gaming machines or the like, there is a so-called Special Gaming Mode (one of modes available for a player to get a large number of game media in a relatively easier manner than that got in a normal gaming mode within a predetermined limited period upon establishment of a predetermined condition) that makes it possible to obtain a large number of game media (coins, medals and tokens, etc.) within a short time period. Such gaming machines are becoming popular because such gaming machines cause the players to arouse the passion for the gaming. However, since the presence of an extremely aroused passion for the gaming results in social affect, the gaming machine manufacturer per se imposes self-regulation or public institution encourages restrictions. Such strength in restrictions are weakened or increased with flow in time in a current status for the purpose of maintaining balance between a popularity in the gaming machine and the social affect with the resultant issues in which profits of the game arcade and gaming machine manufacturer are remarkably subjected to such variations in regulations.

The present invention has been completed with the above issues in mind and has an object to make it possible to provide a service, which is advantageous for both of game arcade and gaming machine manufacturer while it becomes possible for players to have supports and attachments on a gaming machine coming from the gaming machine manufacturer, and a gaming machine, a service providing system, a server forming such a service providing system and a mobile device forming such a service providing system that make it possible to preclude profits of game arcade and gaming machine manufacturer from being adversely affected due to variation in restrictions for gaming machines.

### SUMMARY OF THE INVENTION

According to a first aspect of the present invention, there is provided a gaming machine comprising a lottery device executing a lottery for determining whether to afford a premium to a player, and a code information display device displaying code information which is coded based on lottery outcome data related to an outcome of the lottery executed by the lottery device so that an image capture device captures the code information from an outside of the gaming machine.

A second aspect of the present invention provides a gaming machine comprising a code information display device displaying code information which is coded based on model data uniquely numbered for each model of the gaming machine so that an image capture device captures the code information from an outside of the gaming machine.

A third aspect of the present invention provides a gaming machine comprising a payout device paying out a predetermined number of game media when a predetermined condition is established, a payout number storage device storing a payout number of game media paid-out by the payout device, and a code information display device displaying code information which is coded based on payout number data fixed depending on a payout number stored in the payout number storage device so that an image capture device captures the code information from an outside of the gaming machine.

A fourth aspect of the present invention provides a service providing system having a gaming machine, a mobile device equipped with an image capture device, and a server operative to transmit data to and receive the same from the mobile device via a network, wherein the gaming machine comprises a history data storage device storing history data related to a gaming outcome, a code information display device displaying code information which is coded based on history data stored in the history data storage device so that the image capture device captures the code information at a predetermined timing, the mobile device comprises an image data transmission device transmitting image data, obtained when the image capture device captures code information, together with unique ID data of the mobile device or player identifying information for identifying players to the server, the server comprises a point value storage device storing a point value for each of unique ID data of mobile devices or each of player identifying information, a code information recognition device recognizing code information based on image data received from the mobile device and generating the history data based on recognized code information, a point value updating device setting a point value based on history data, generated by the code information recognition device, and updating a point value, stored in the point value storage device, in correspondence to the ID data and the player identifying information based on the point value and the ID data or the player identifying information received from the mobile device, a list data generator generating list data, indicative of a list in which point values are ranked for the ID data or the player identifying information, respectively, based on the ID data, stored in the point value storage device, or the player identifying information and the point value, and a list data transmission device transmitting the list data, generated by the list data generator, to the mobile device.

### BRIEF DESCRIPTION OF THE LOTTERIES

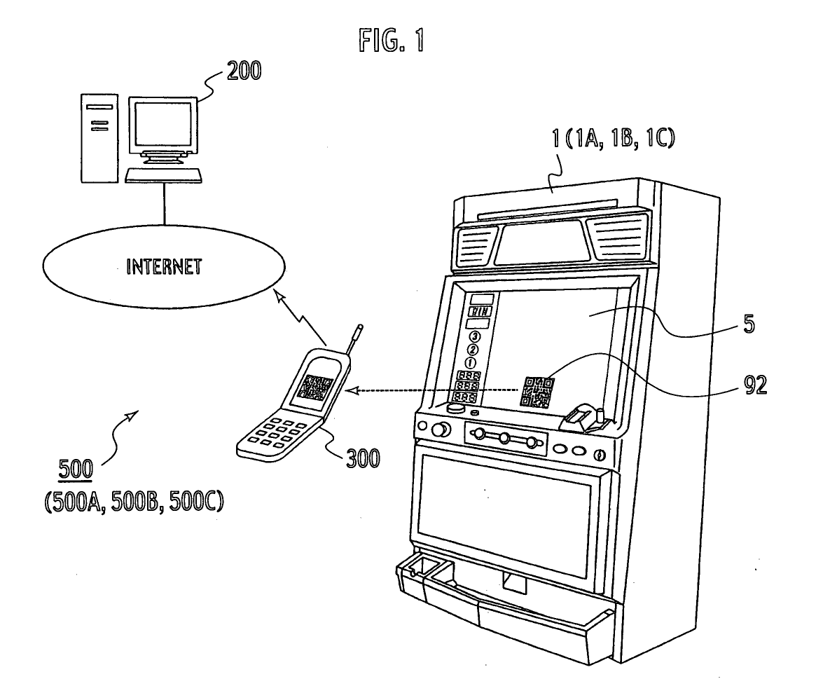

FIG. 1 is a network structural view showing one example of a service providing system of a first embodiment according to the present invention.

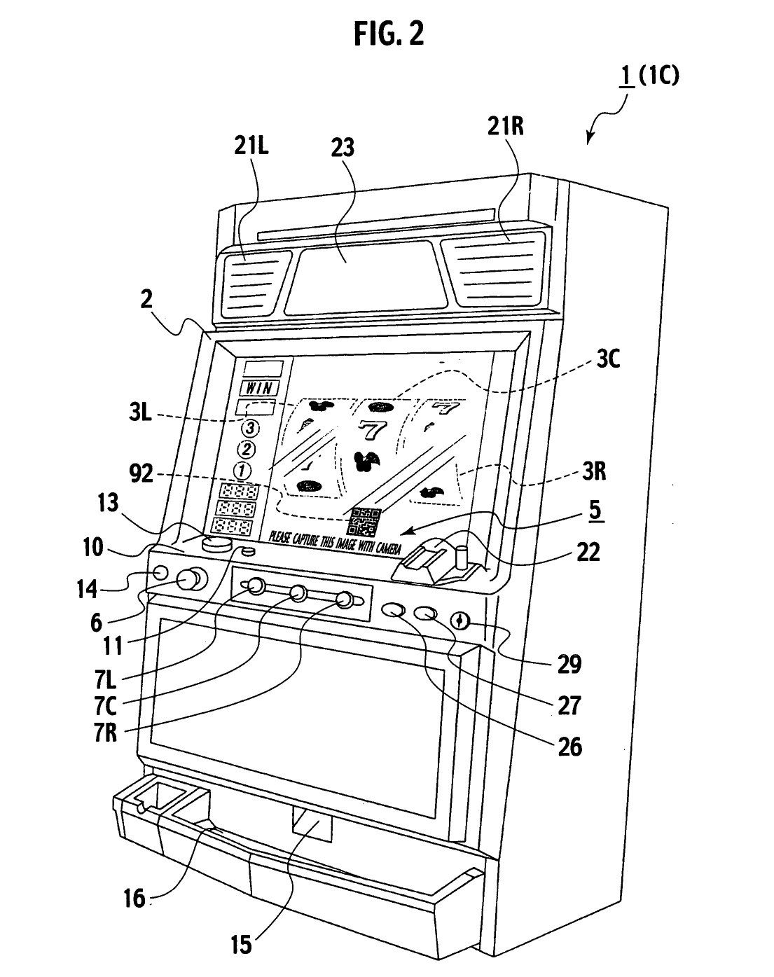

FIG. 2 is a perspective view typically showing one example of a pachi-slot gaming machine shown in FIG. 1.

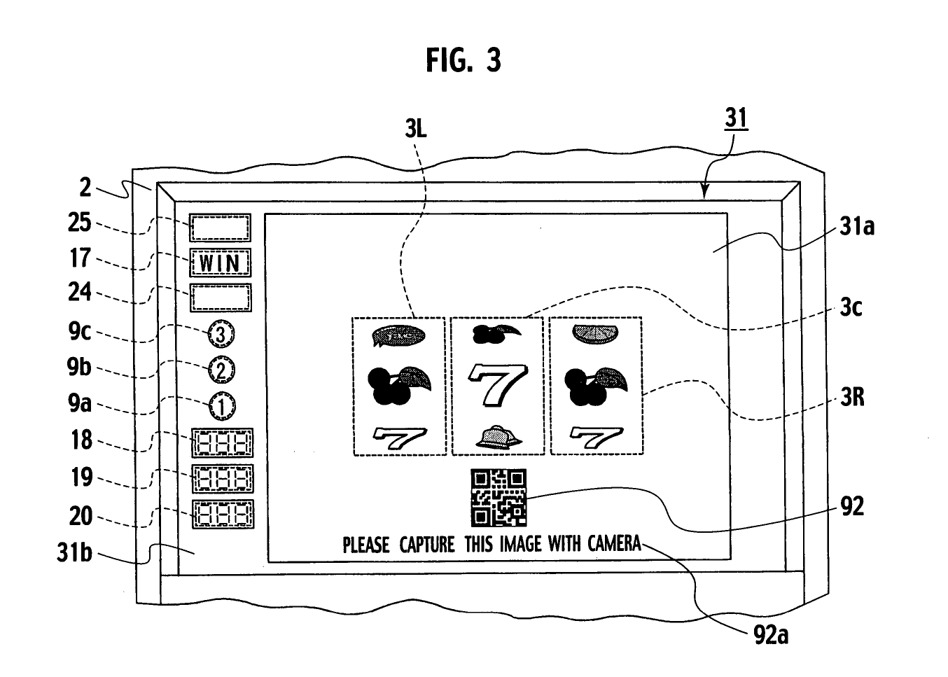

FIG. 3 is a perspective view typically showing one example of an image to be displayed over a liquid crystal display device.

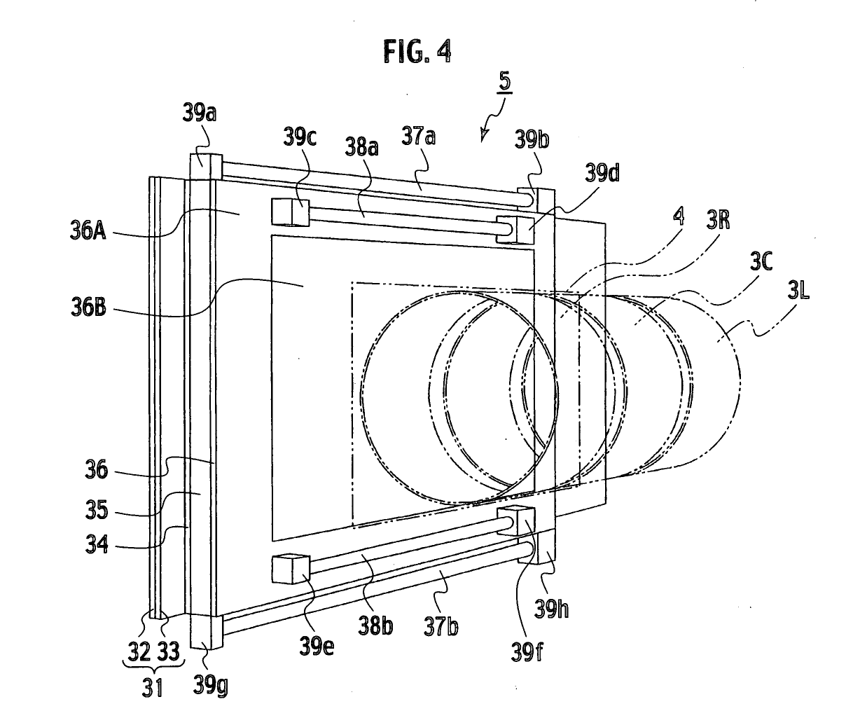

FIG. 4 is a perspective view showing a schematic structure of the liquid crystal display device of the pachi-slot gaming machine shown in FIG. 1.

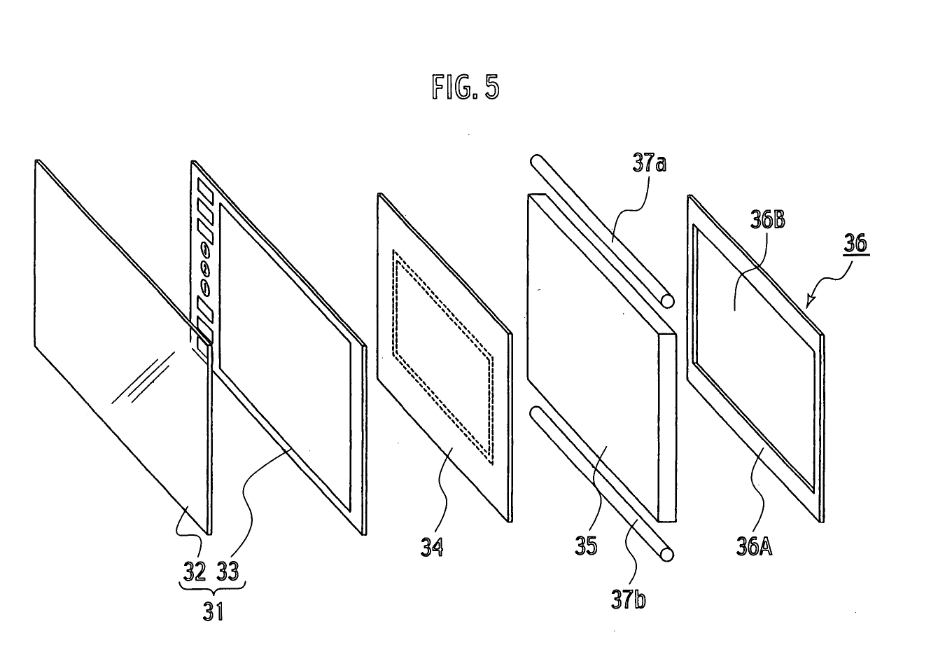

FIG. 5 is an exploded view of a structure in part of the liquid crystal display device shown in FIG. 4.

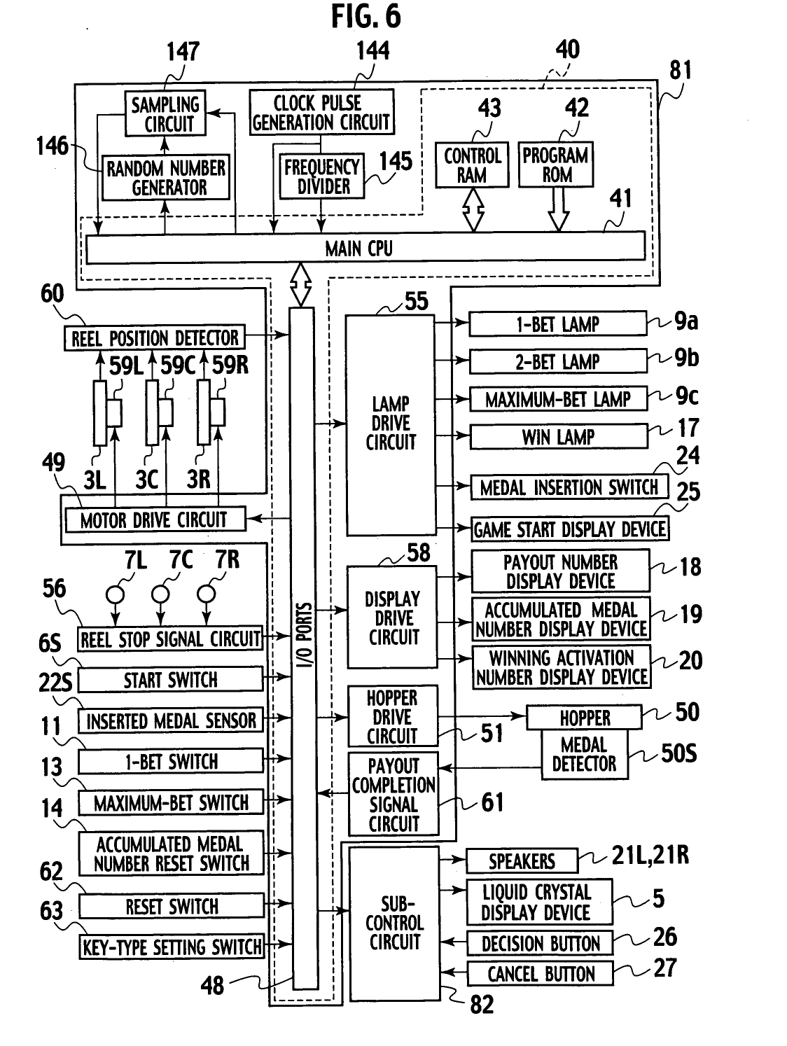

FIG. 6 is a block diagram showing an internal structure of the pachi-slot gaming machine shown in FIG. 1.

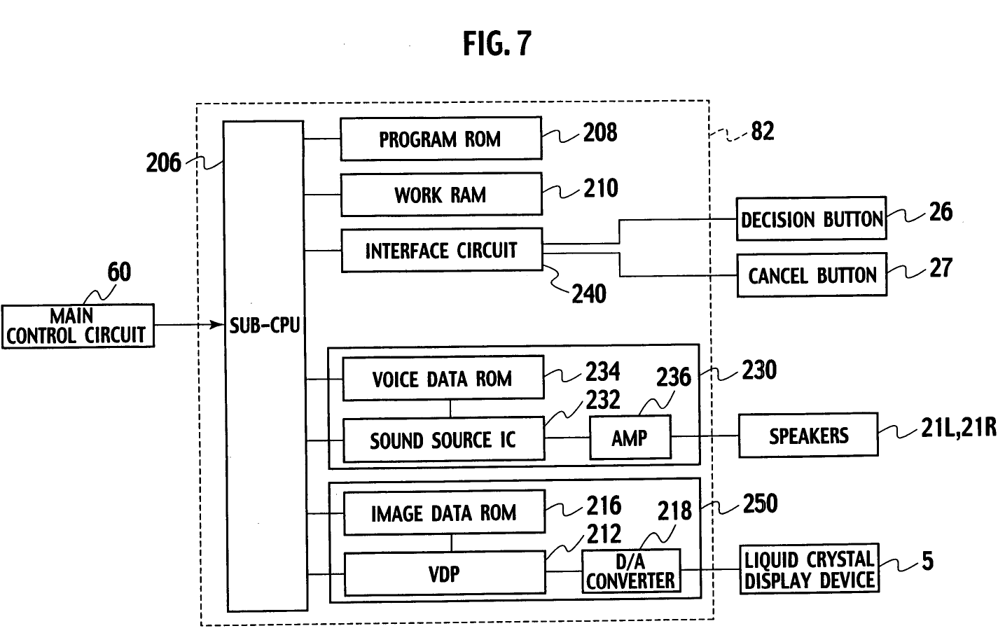

FIG. 7 is a block diagram showing a structure of a sub-control circuit shown in FIG. 6.

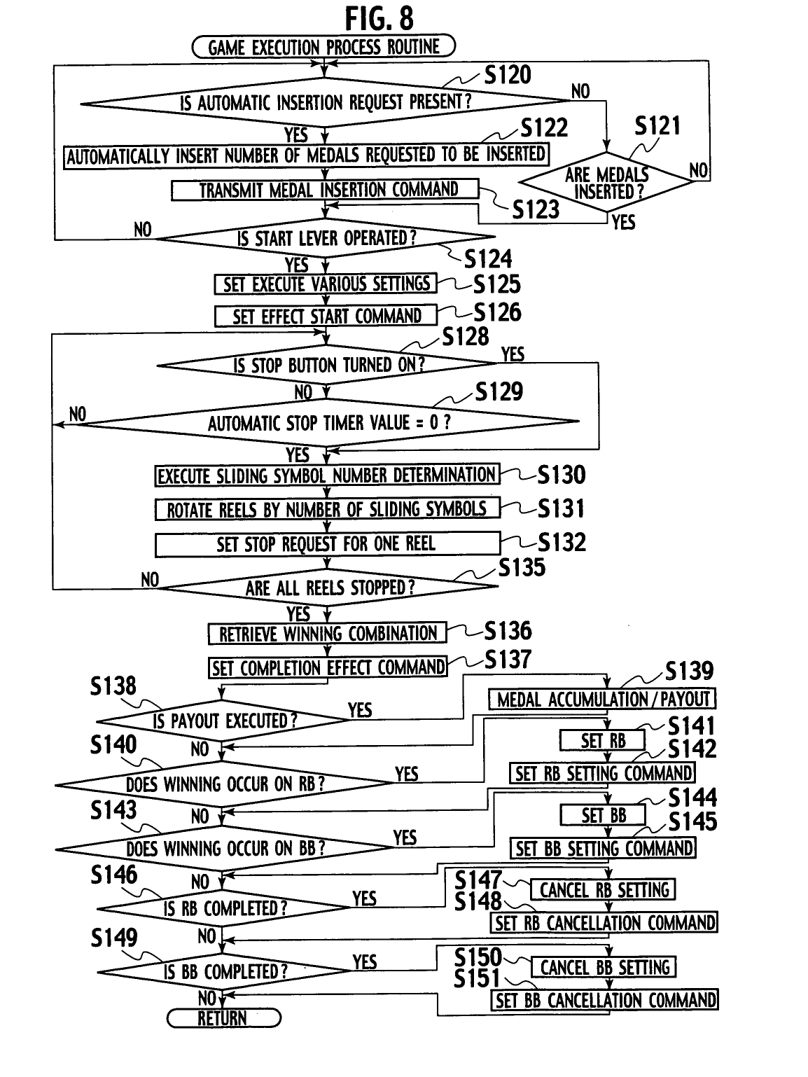

FIG. 8 is a flowchart showing a main routine of a game executing process to be executed in a main control circuit.

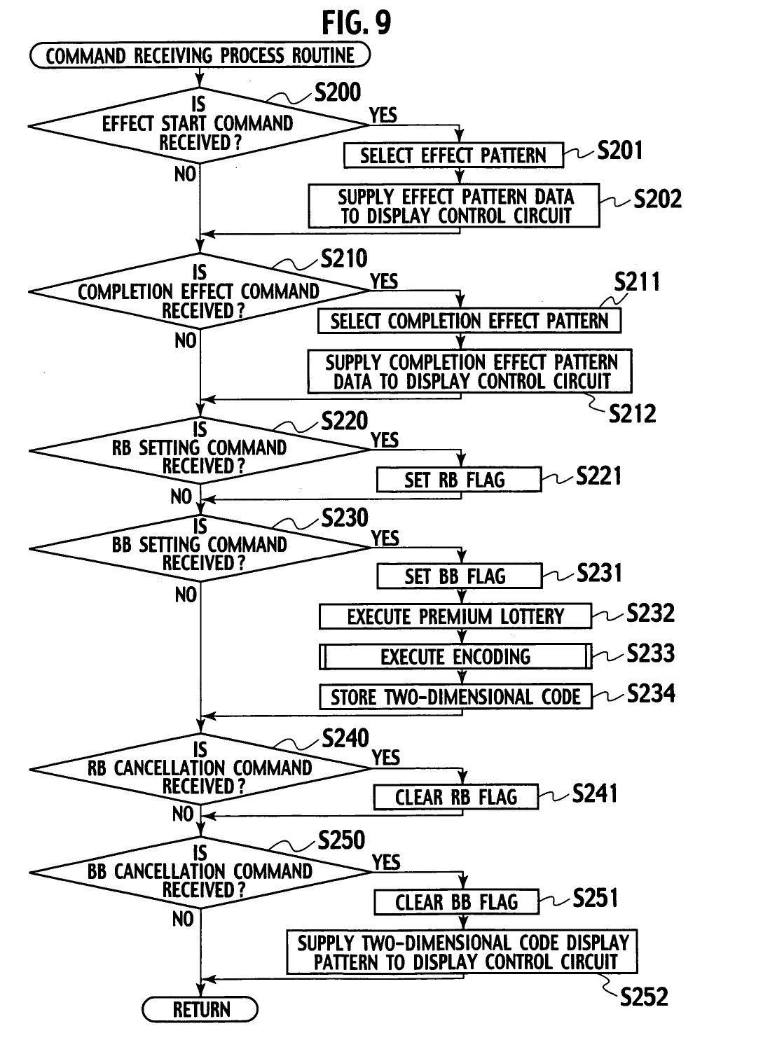

FIG. 9 is a flowchart showing a sub-routine of a command receiving process to be executed in the sub-control circuit.

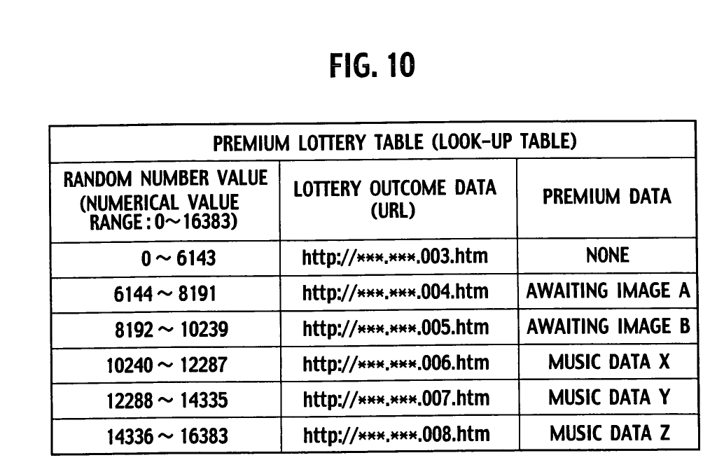

FIG. 10 is a view showing a premium lottery table for use in step S232 of the sub-routine shown in FIG. 9.

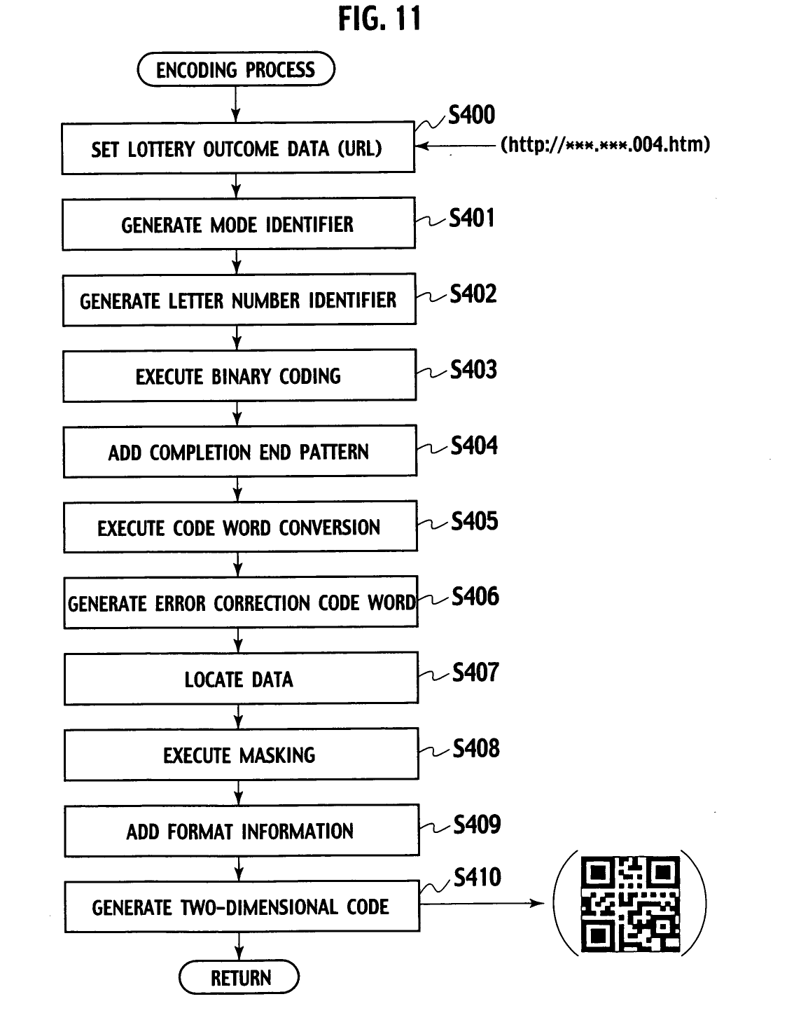

FIG. 11 is a flowchart showing a sub-routine of an encoding process to be executed in step S233 of the sub-routine shown in FIG. 9.

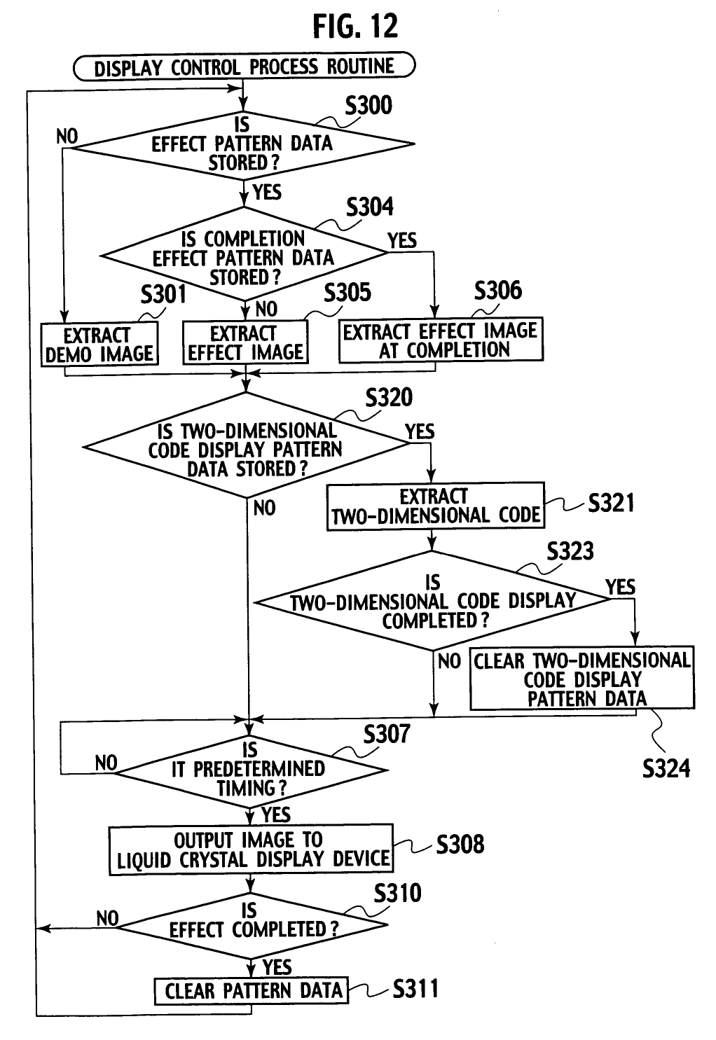

FIG. 12 is a flowchart showing a sub-routine of a display control process to be executed in the display control circuit.

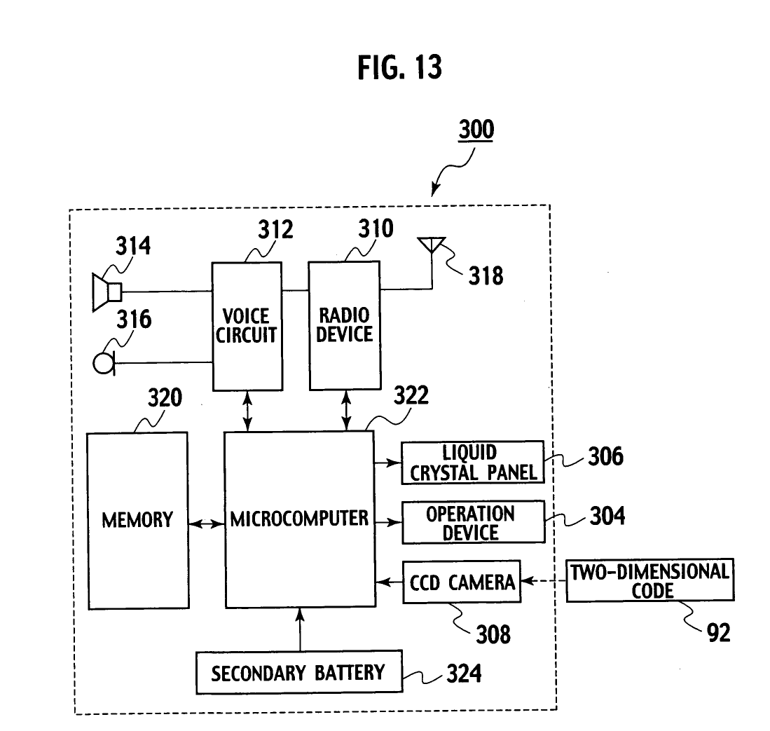

FIG. 13 is a block diagram showing an internal structure of a mobile phone shown in FIG. 1.

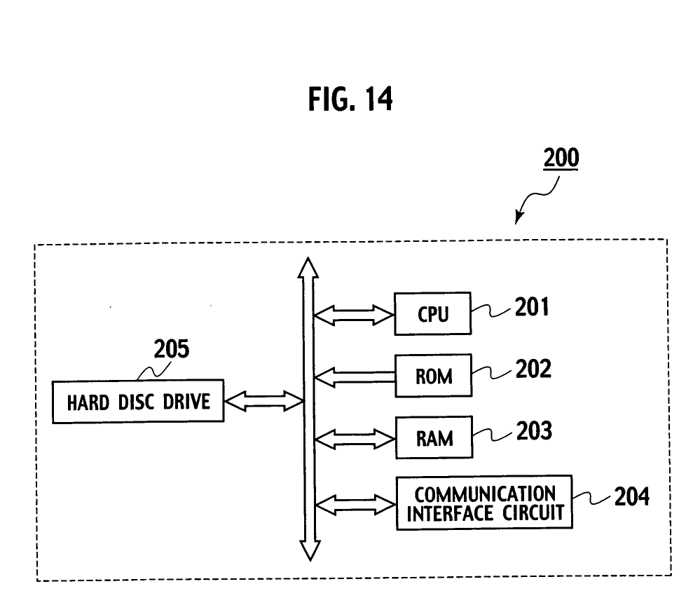

FIG. 14 is a block diagram showing an internal structure of a server shown in FIG. 1.

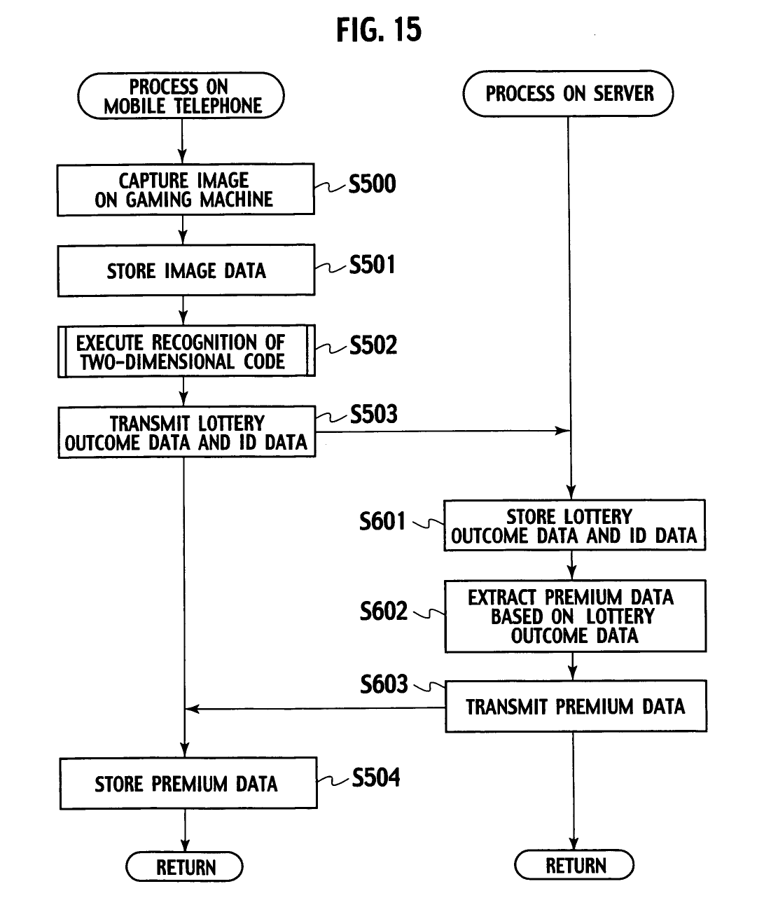

FIG. 15 is a flowchart showing a process to be executed between the mobile phone and the server.

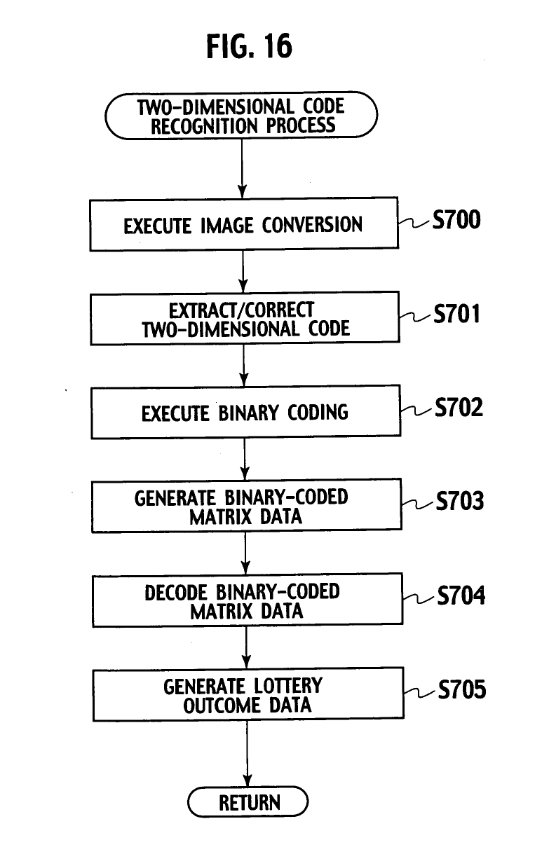

FIG. 16 is a flowchart showing a two-dimensional code recognition process to be retrieved and extracted in step S501 of the process shown in FIG. 15.

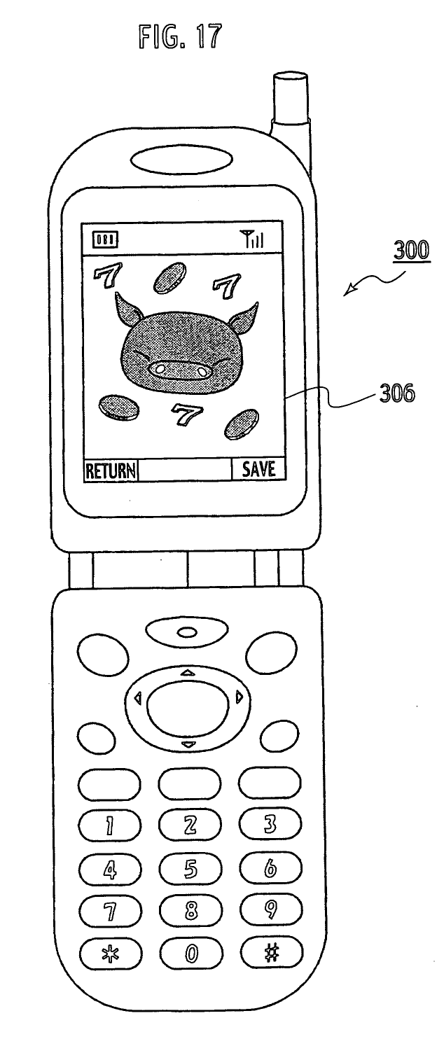

FIG. 17 is a view showing one example of an awaiting image transmitted to the mobile phone from the server as a premium.

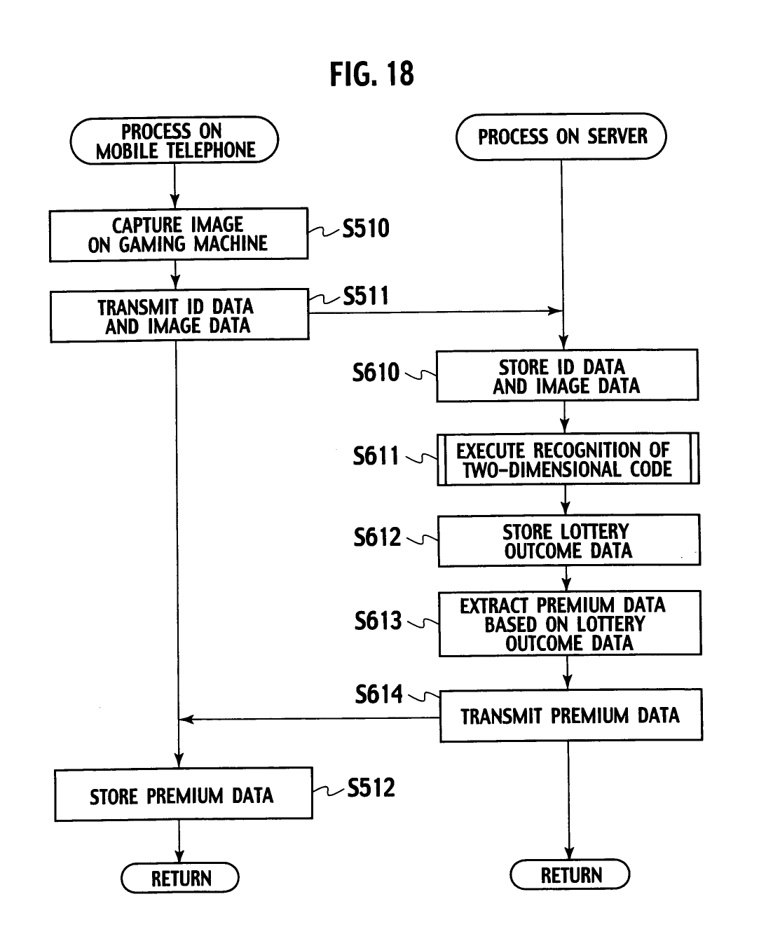

FIG. 18 is a flowchart showing a process to be executed between the mobile phone and the server forming a service providing system of a second embodiment.

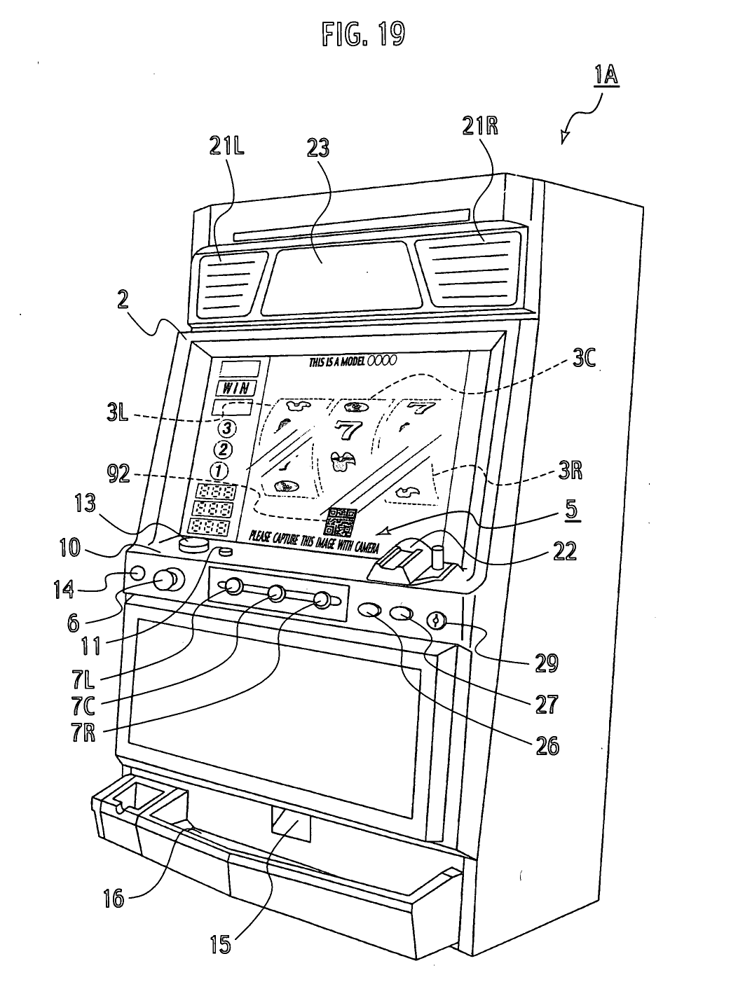

FIG. 19 is a perspective view showing one example of a pachi-slot gaming machine of a third embodiment.

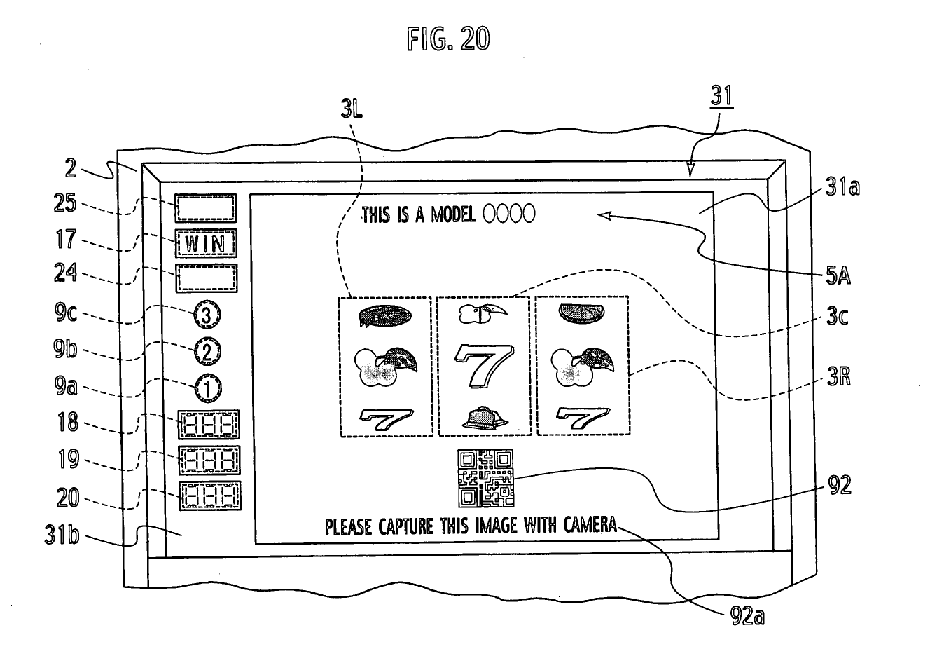

FIG. 20 is a view showing one example of an image to be displayed in a liquid crystal display device of the third embodiment.

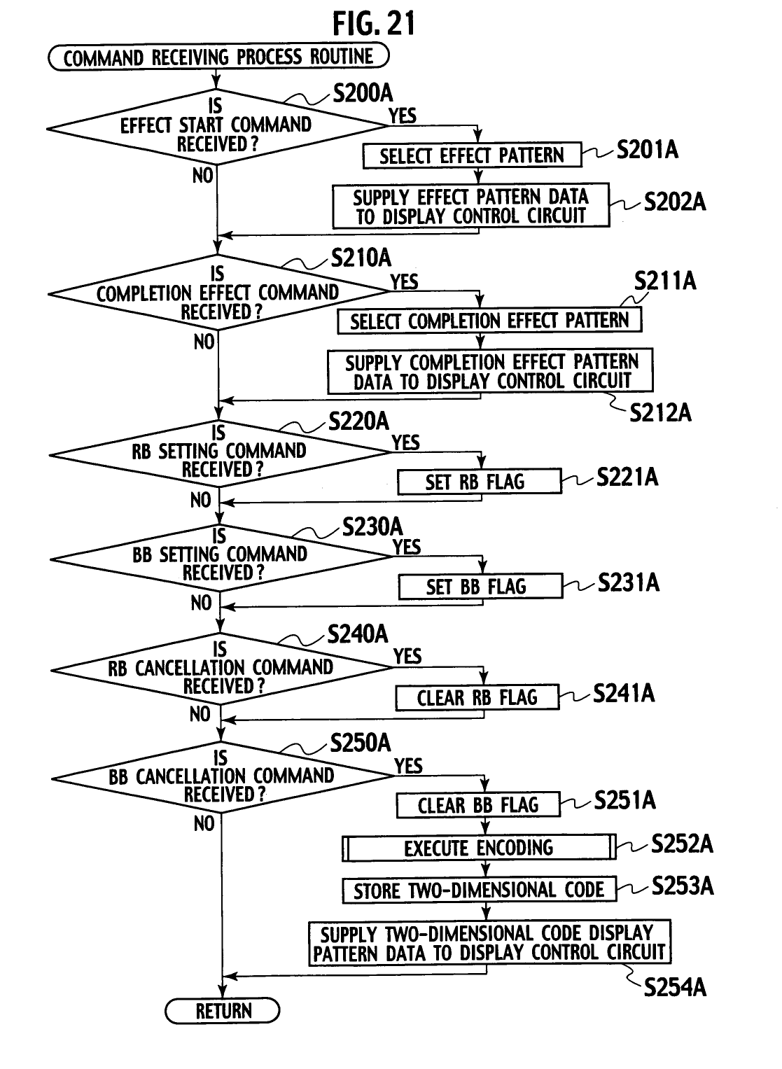

FIG. 21 is a flowchart showing a sub-routine of a command receiving process to be executed in a sub-control circuit of the third embodiment.

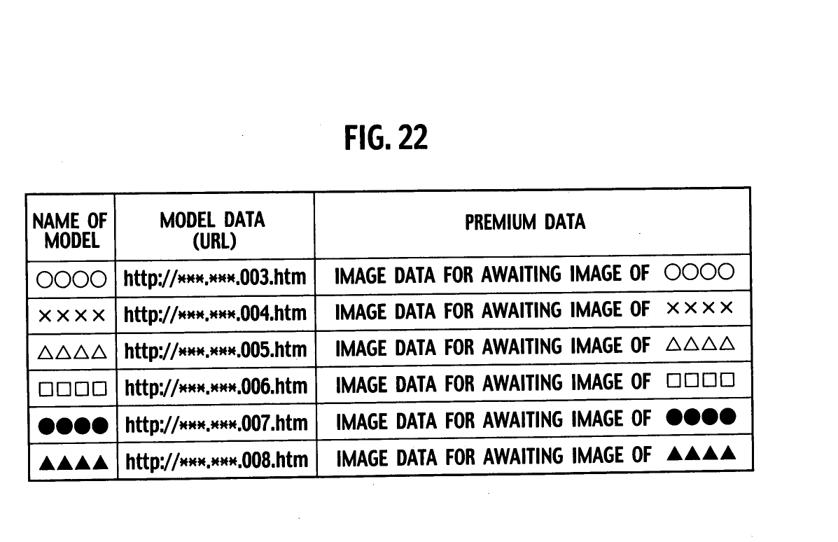

FIG. 22 is a view for illustrating a relation among model names of the gaming machines, model data and premium data.

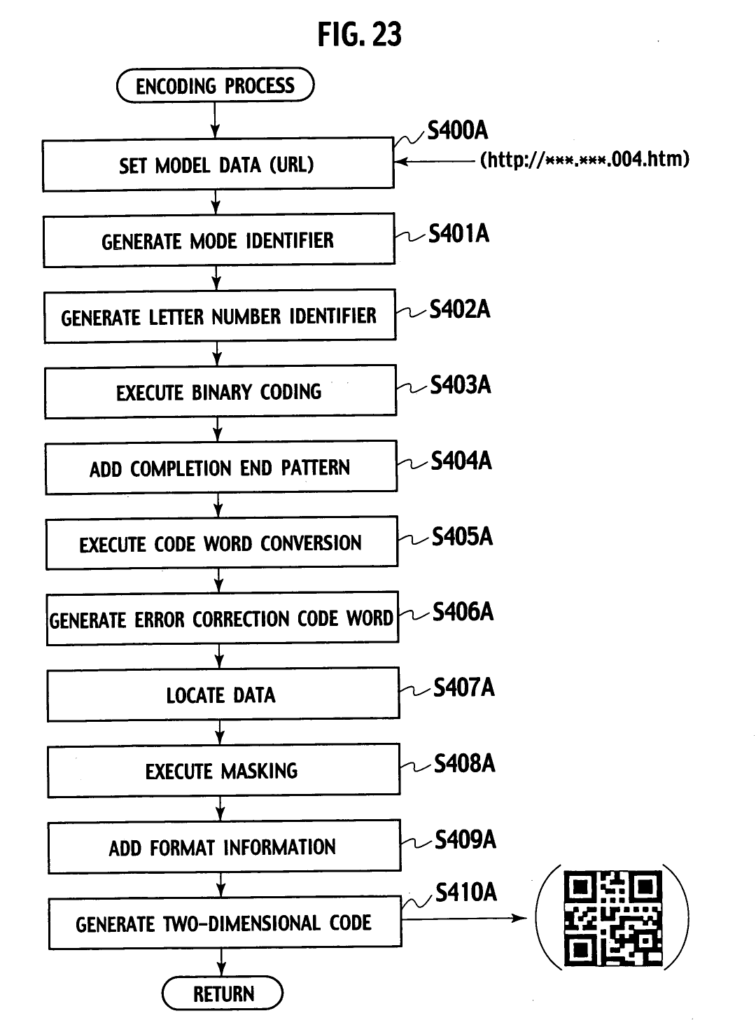

FIG. 23 is a flowchart showing a sub-routine of an encoding process in the third embodiment.

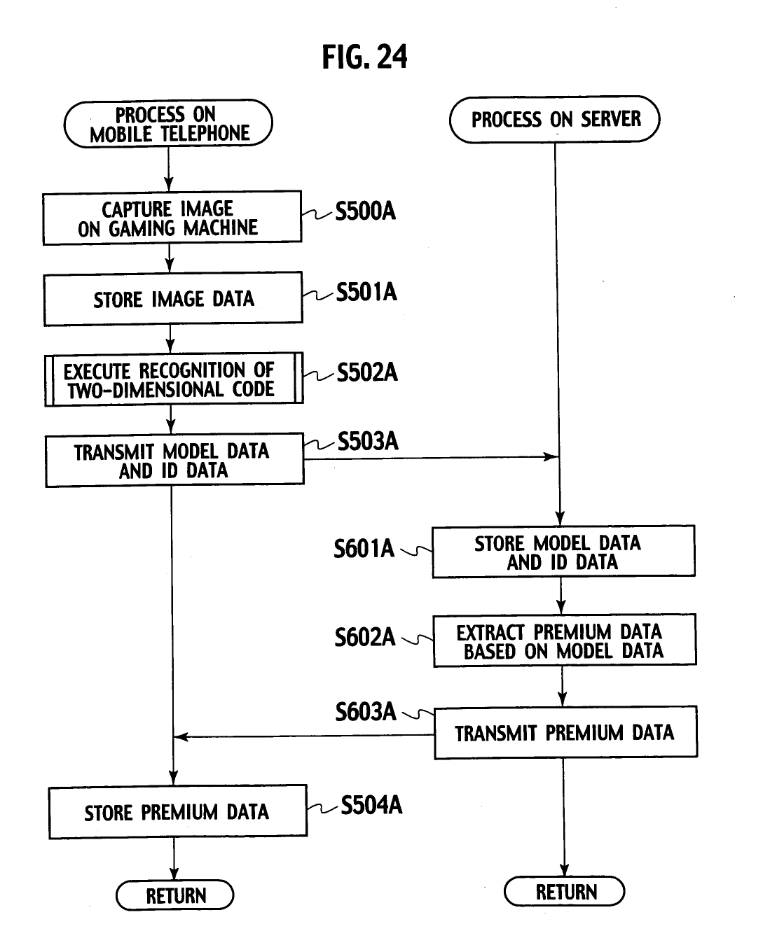

FIG. 24 is a flowchart showing a process to be executed between a mobile phone and a server in the third embodiment.

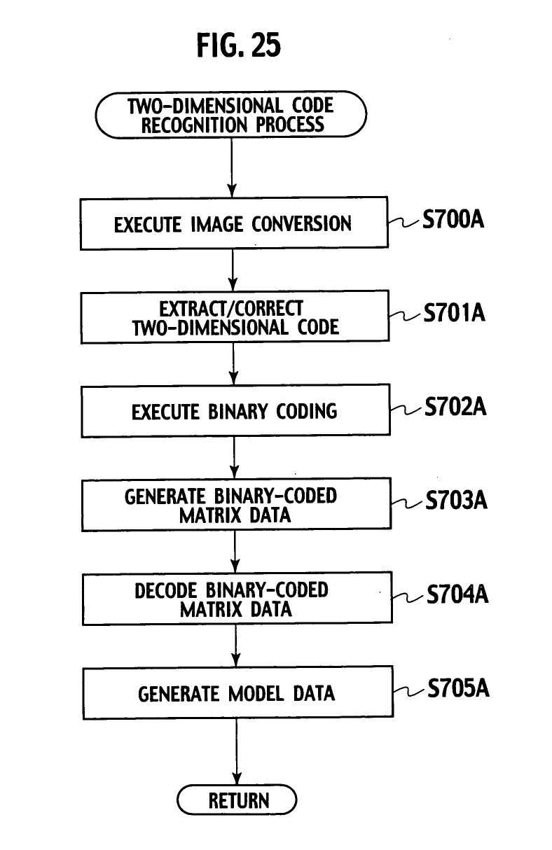

FIG. 25 is a flowchart showing a two-dimensional code recognition process in the third embodiment.

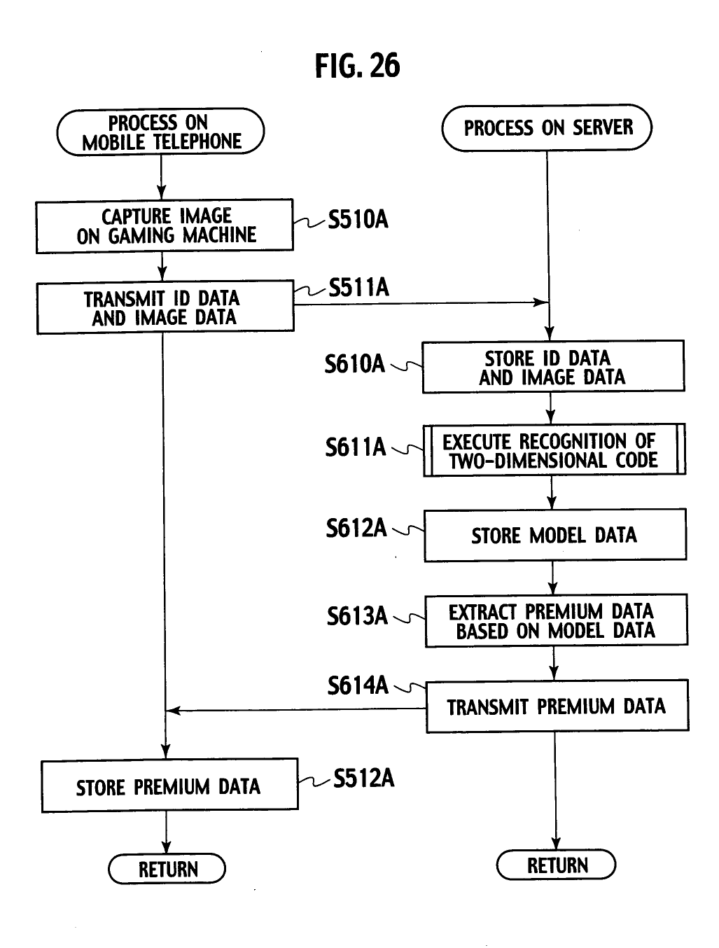

FIG. 26 is a flowchart showing a process to be executed between a mobile phone and a server that comprises a service providing system of a fourth embodiment.

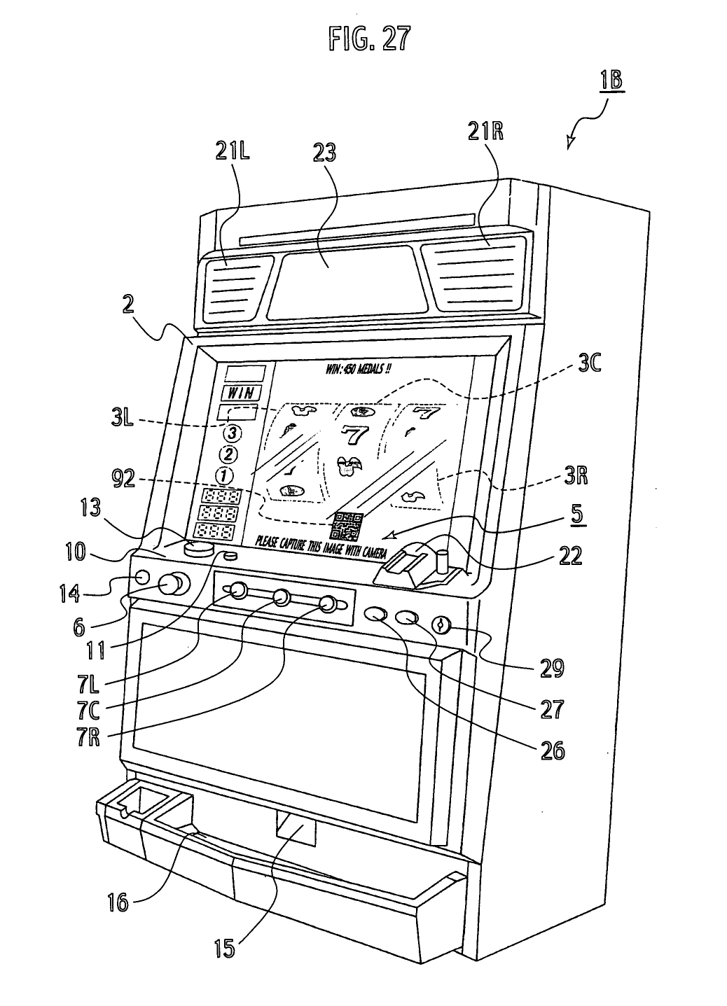

FIG. 27 is a perspective view showing one example of a pachi-slot gaming machine of a fifth embodiment.

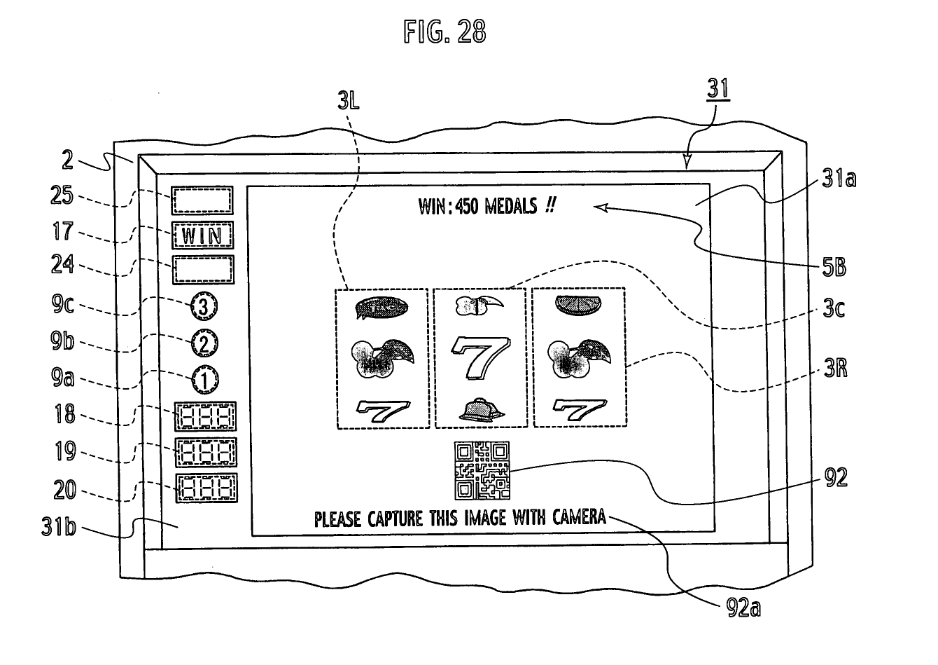

FIG. 28 is a view showing one example of an image to be displayed over a liquid crystal display device in the fifth embodiment.

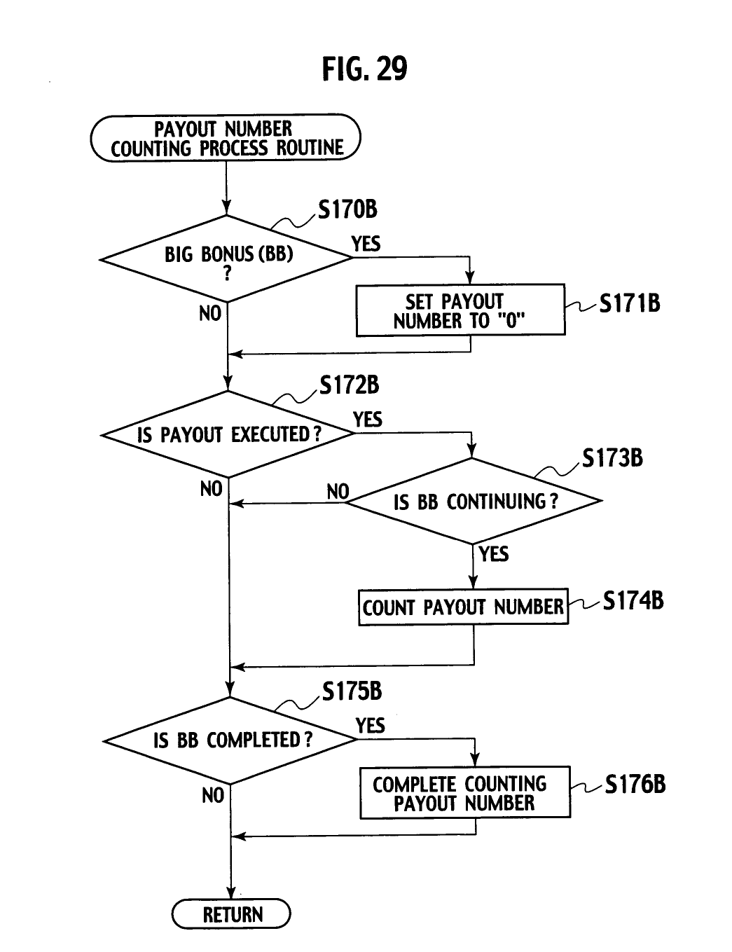

FIG. 29 is a flowchart showing a sub-routine for a payout number counting process to be executed in a main control circuit in the fifth embodiment.

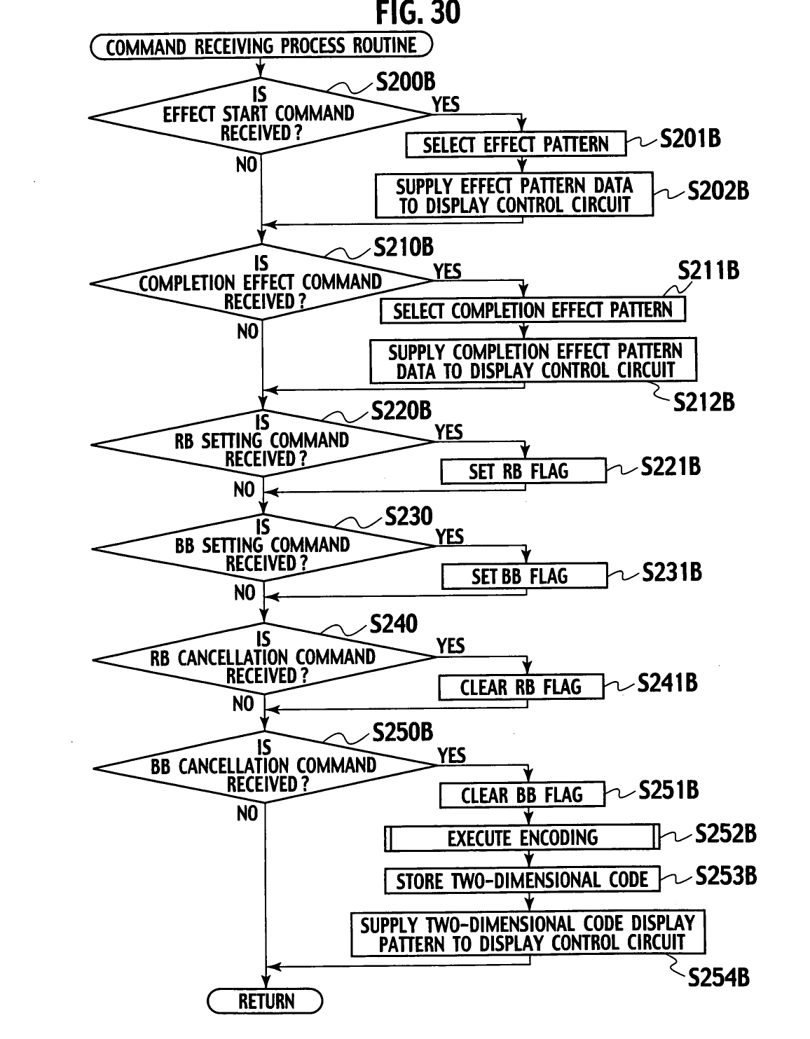

FIG. 30 is a flowchart showing a sub-routine of a command receiving process to be executed in the fifth embodiment.

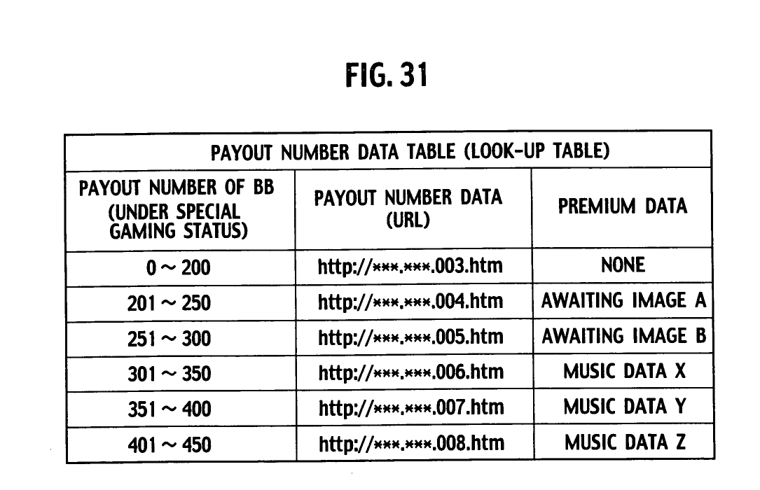

FIG. 31 is a view showing one example of a payout number data table.

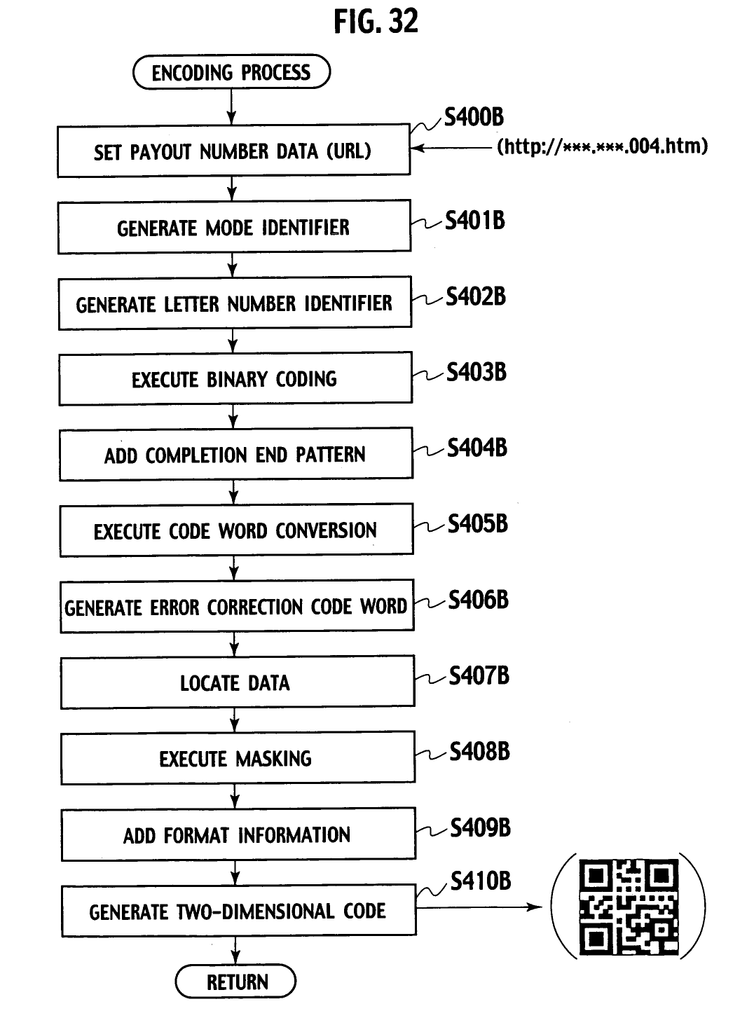

FIG. 32 is a flowchart showing a sub-routine of an encoding process in the fifth embodiment.

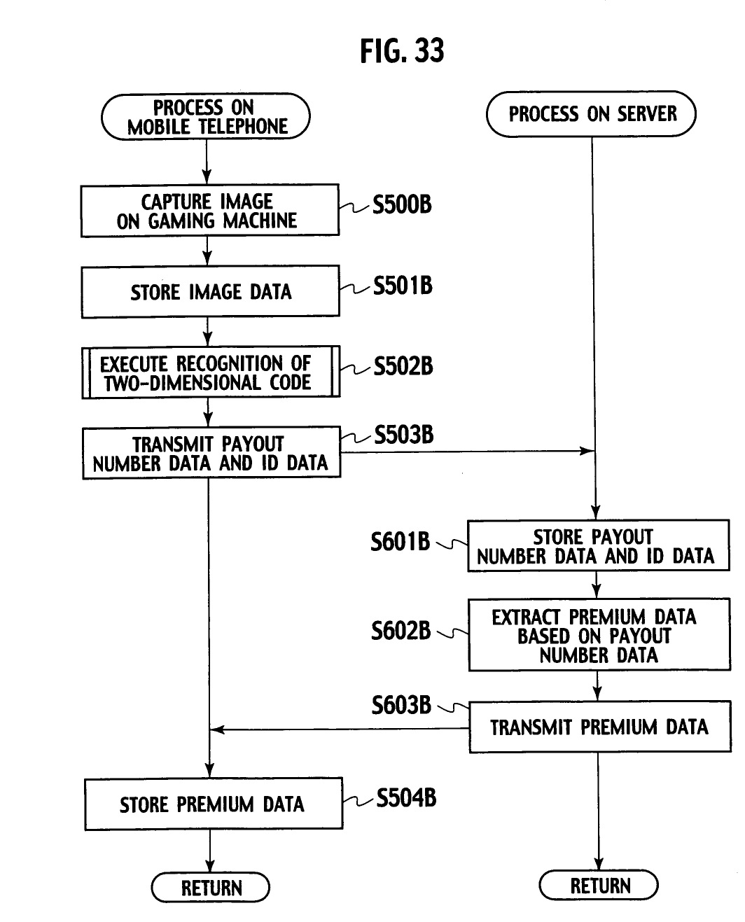

FIG. 33 is a flowchart showing a process to be executed between a mobile phone and a server in the fifth embodiment.

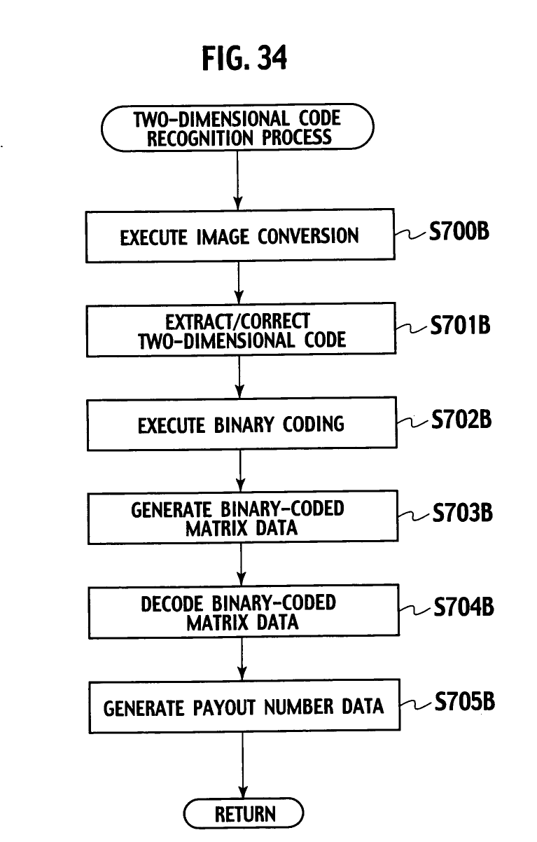

FIG. 34 is a flowchart showing a two-dimensional code recognition process in the fifth embodiment.

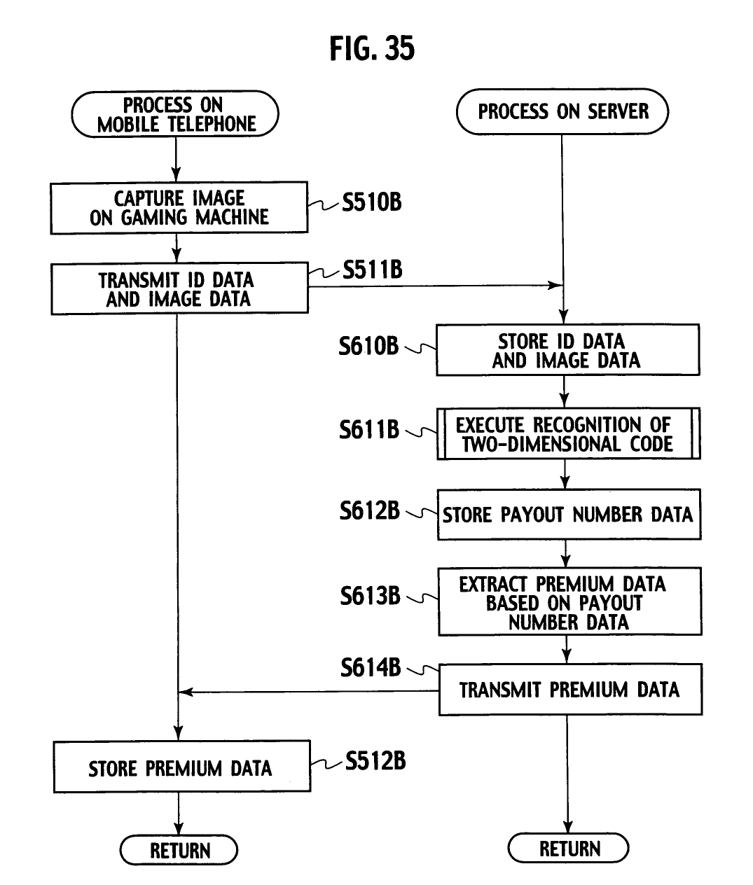

FIG. 35 is a flowchart showing a process to be executed between a mobile phone and a server forming a service providing system of a sixth embodiment.

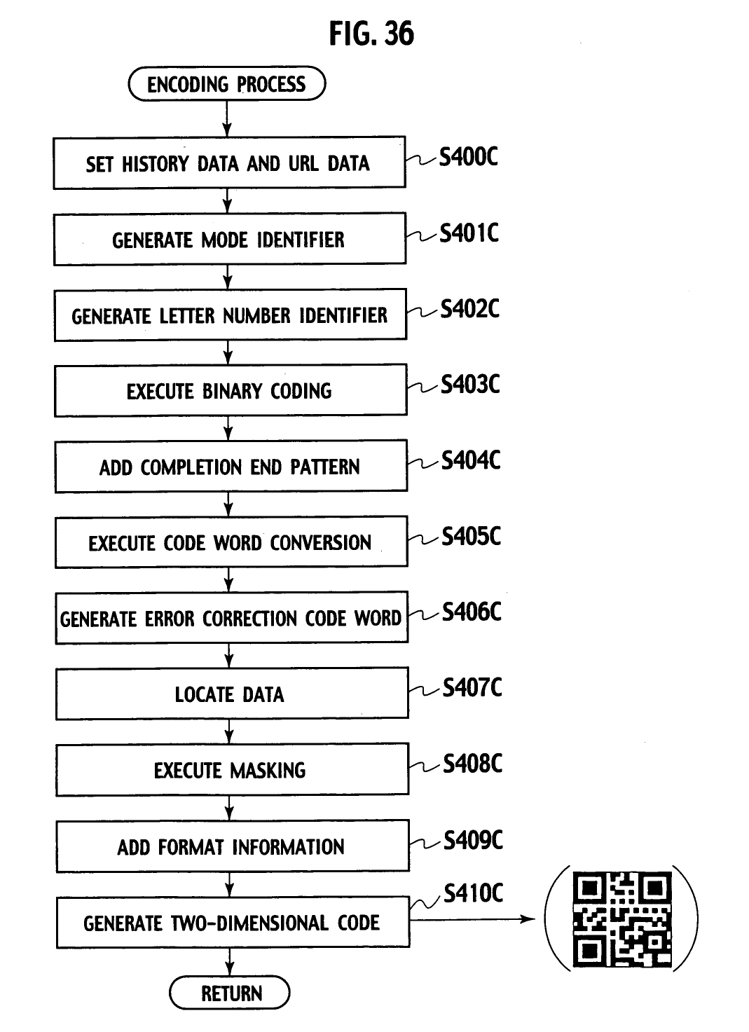

FIG. 36 is a flowchart showing a sub-routine of an encoding process in a seventh embodiment.

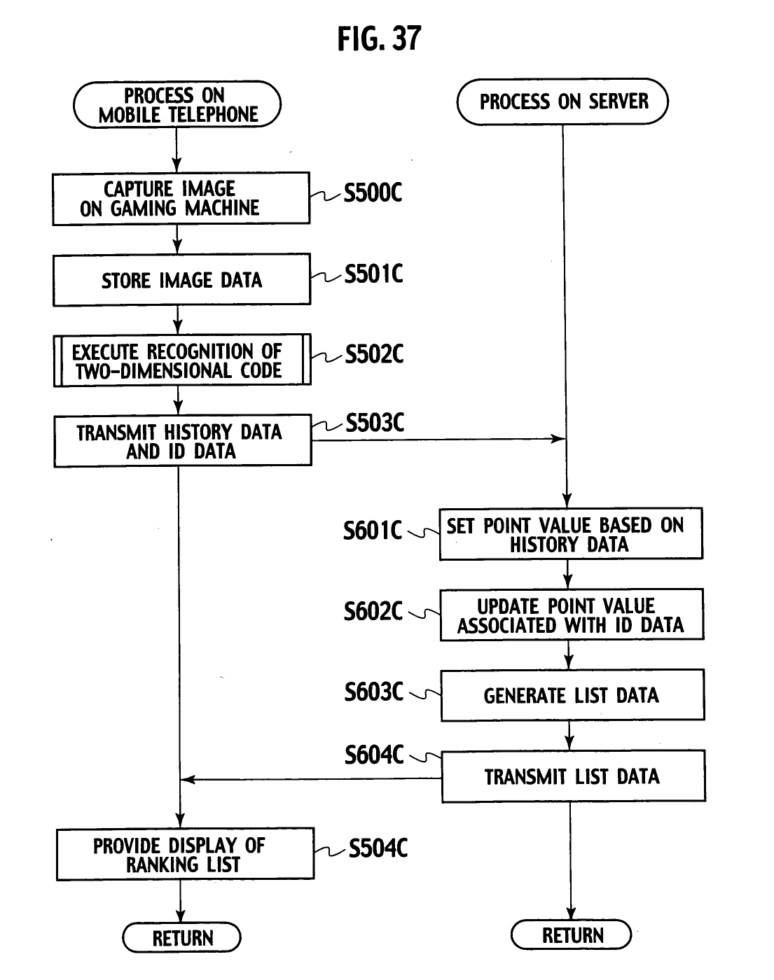

FIG. 37 is a flowchart showing a process to be executed between a mobile phone and a server in the seventh embodiment.

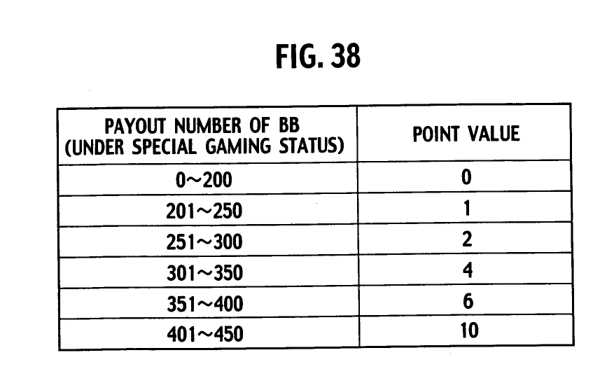

FIG. 38 is a view showing one example of a point value conversion table.

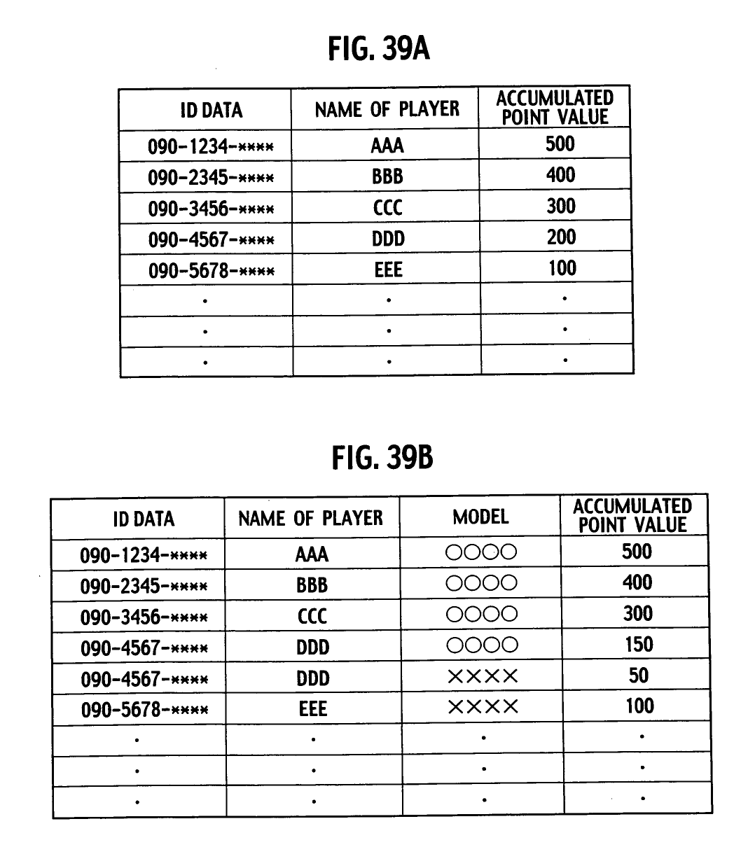

FIGS. 39A and 39B are views showing examples of an accumulative point value conversion tables.

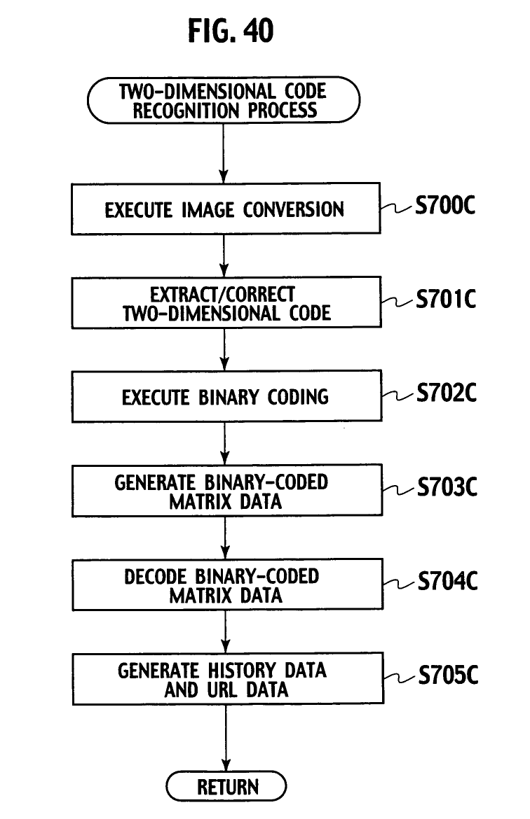

FIG. 40 is a flowchart showing a two-dimensional code recognition process in the seventh embodiment.

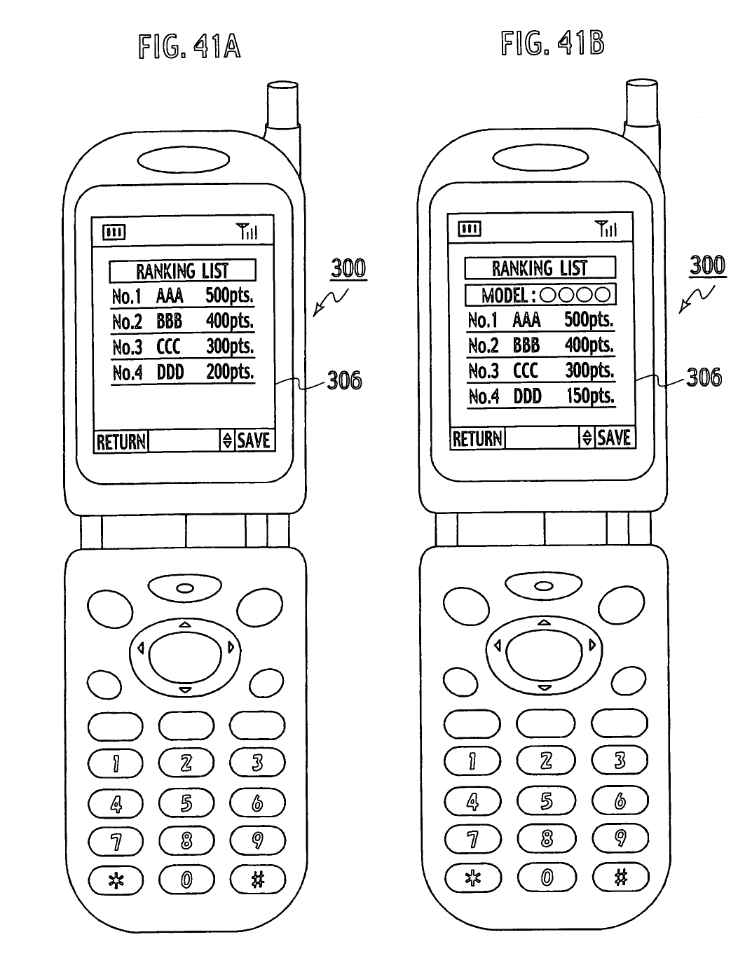

FIGS. 41A and 41B are views showing examples of ranking lists.

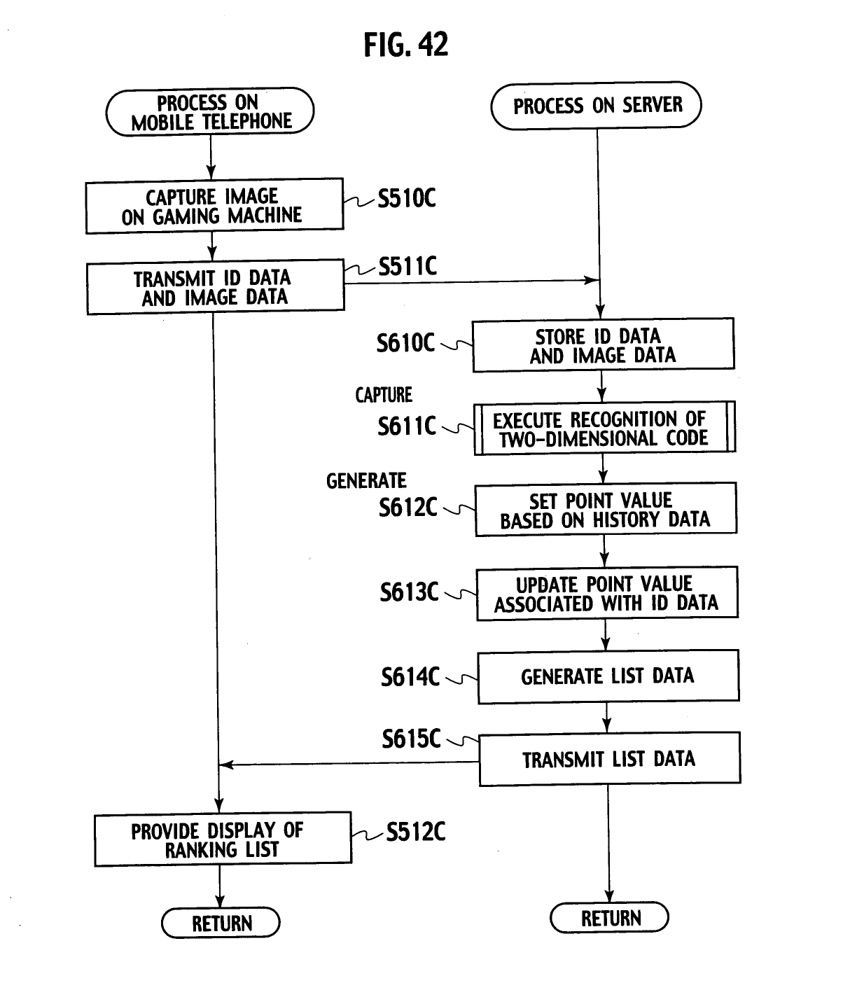

FIG. 42 is a flowchart showing a process to be executed between the mobile phone and the server that comprises the service providing system of the eighth embodiment.

### DETAILED DESCRIPTION OF THE INVENTION

### First Embodiment

FIG. 1 is a network structural view showing one example of a service providing system of a first embodiment according to the present invention. The service providing system 500 is comprised of a pachi-slot gaming machine 1, a mobile phone 300 equipped with a CCD camera 308 (not shown herein and see FIG. 13) playing a role as an image capture device (an image capturing device), and a server 200 operative to transmit data to and receive the same from the mobile phone 300 over the Internet by radio.

First, to describe an outline of the presently filed embodiment, the pachi-slot gaming machine 1 operates to execute the lottery on whether to offer a premium to a player when a game is shifted to a BB (Big Bonus) as one example of a special gaming status after which a liquid crystal display device 5 shows a two-dimensional code 92 in which lottery outcome data, related to an outcome of the relevant lottery when the BB is terminated, is coded under a predetermined coding rule. The player is enabled to capture the two-dimensional code 92 using the CCD camera 308 incorporated in the mobile phone 300.

The mobile phone 300 recognizes the two-dimensional code 92, based on image data acquired when the CCD camera 308 captures the two-dimensional code 92, and generates lottery outcome data (under an encrypted state of lottery outcome data) based on such recognized two-dimensional code 92. Then, coded lottery outcome data is transmitted to the server 200.

The server 200 extracts premium data based on transmitted lottery outcome data from among premium data (such as, for instance, image data serving as an awaiting image, music data like Chaku-Melo (Cellular Phone Ring Melody that is hereinafter referred to as “Chaku-Melo”, etc.), which is preliminarily stored in a storage device (such as, for instance, a hard disc drive 205 (not shown here and see FIG. 14), based on lottery outcome data received from the mobile phone 300. Then, resulting premium data is transmitted to the mobile phone 300.

Thus, with the service providing system 500, the player has a capability of using the CCD camera 308 incorporated in the mobile phone 300 to capture an image of the two-dimensional code 92 displayed over the liquid crystal display device 5 of the pachi-slot gaming machine 1 at the completion of the BB for thereby enabling the mobile phone 300 to acquire lottery outcome data upon which lottery outcome data is transmitted to the server 200 to enable premium data to be acquired from the server 200.

The pachi-slot gaming machine 1, forming the service providing system 500, corresponds to a gaming machine of the present invention. The gaming machine of the present invention is not limited to such an exemplary structure and may have applications such as, for instance, a pinball gaming machine and a slot machine, etc.

Although not only the presently filed embodiment but also all of second to eight embodiments will be described with reference to a case wherein a two-dimensional code is employed as code information, code information, available to be applied to the present invention, may include not only the two-dimensional code but also one-dimensional code (bar code). In particular, further, although the presently filed embodiment will be described in conjunction with a case wherein a QR code (under Registered Trademark) is used as the two-dimensional code, the present invention is not limited to such an exemplary case.

The mobile phone 300 represents one example of a mobile device according to the present invention. Also, the mobile device of the present invention is not particularly limited, provided that it includes an image capture device and takes the form of a structure operative to transmit data to and receive data from a server over a network, and may include a mobile device such as, for instance, a Personal Digital Assistant (PDA) and a mobile device or the like specific for the above-described service providing system.

Further, while the first embodiment will be described in connection with a case where the mobile phone 300 and the server 200 perform the transmission and receiving of data over the radio, the present invention is not limited to such an exemplary case and may be configured to achieve the transmission and receiving of data over a fixed line. That is, the network of the present invention may include wired and wireless transmission channel.

FIG. 2 is a perspective view typically showing one example of the pachi-slot gaming machine shown in FIG. 1. The pachi-slot gaming machine 1 includes a gaming machine that is operative to allow the gaming through the use of game media such as, in addition to coins, medals or tokens or the like and a card, or the like, that store information on a gaming value that has been afforded to a player or will be afforded. Hereunder, description is made of a case where the medals are used. Meanwhile, a gaming machine suitable for this invention is not limited to pachinko-gaming machines and pachi-slot gaming machines, mainly used in Japan, and slot machines configured to be used in various countries also can be used for this invention. Special gaming state for such slot machines can be configured to include a bonus game, for instance a free game.

The liquid crystal display device 5 is located in front of a cabinet 2 by which an overall structure of the pachi-slot gaming machine 1 is formed. The liquid crystal display device 5 includes a transparent liquid crystal panel 34 (not shown) that is operative to switch over a part of or a whole of a display to a transparent/non-transparent status and operative to display the two-dimensional code 92 as code information.

The liquid crystal display device 5 function as a code information display device. While the presently filed embodiment is described with reference to a case wherein the liquid crystal display device 5, serving as the code information display device, is located in an area in front of reels 3, the present invention has nor particular limitation on a positions at which the code information display device is located. Moreover, although the presently filed embodiment is described with reference to a case where the liquid crystal display device 5, serving as the code information display device, is adapted to show even effect images or the like, the present invention may take the form of a structure wherein a display device, adapted to display the effect images or the like, and the code information display device are separately provided from each other.

Further, three reels 3L, 3C, 3R are located as variable display devices in an area rearward of the liquid crystal display device 5. The three reels 3L, 3C, 3R have respective peripheral surfaces, on which a plurality of identifying information, such as graphics, are displayed, and are lined up in single file from left to right.

A pedestal section 10, having a horizontal surface, is formed in an area beneath the liquid crystal display device 5. A medal insertion slot 22 is located in the pedestal section 10 on a right side thereof and a 1-BET switch 11 and a MAXIMUM-BET switch 13 are located in a left side of the pedestal section 10.

An accumulated medal number reset switch 14 is located in front of the pedestal section 10 on a left-leaning side thereof to be operative upon depression to switch over credit/payout modes for the medals gained by the player upon playing a game. With the “payout” mode selected upon switchover operation of the accumulated medal number reset switch 14, the medals are paid-out from a medal payout opening 15, located in a lower area at a front of the cabinet, to be accumulated in a medal receiving section 16. On the contrary, with the “credit” mode selected, a medal number is stored as credit in a memory (such as, for instance, a RAM 43, etc., which will be described below) incorporated in the pachi-slot gaming machine 1.

A start lever 6 is mounted on the cabinet 2 at a right side of the accumulated medal number reset switch 14 to be rotatably operated by the player within a predetermined angular range for rotating the reels 3L, 3C, 3R. Three stop buttons 7L, 7C, 7R are located in front of the pedestal section 10 at a central area thereof to stop the rotations of the three reels 3L, 3C, 3R.

A decision button 26 and a cancel button 27 are located in front of the pedestal section 10 on a right-leaning side thereof. Operating the decision button 26 and cancel button 27 enables the inputting to be made for switchover or command on a display screen of the liquid crystal display device 5. A door-closure and game-closure cancel switch 29 is further located in front of the pedestal section 10 on the right-leaning side thereof. Turning the door-closure and game-closure cancel switch 29 clockwise using a predetermined key allows a front door to be opened or closed and turning the same counterclockwise allows a game-closure cancel to be executed. Meanwhile, the term “game-closure” means that a predetermined upper limit number, and when paid-number of the medals reach this upper-limit, payout of the medals is automatically stopped.

Two speakers 21L, 21R are mounted on an upper area of the cabinet 2 on left and right sides thereof and a dividend display panel 23, which shows a combination on winning symbols and the number of dividend medals, is located between the two speakers 21L, 21R.

FIG. 3 is a view typically showing one example of an image displayed over the liquid crystal display device 5. As shown in FIG. 3, the three reels 3 (3L, 3C, 3R), on respective peripheral surfaces has symbols representing a plurality of identifying information, are rotatably disposed on a back side of the liquid crystal display device 5, whereby the player can recognize the symbols as shown in FIG. 3.

As shown in FIGS. 3-5, the liquid crystal display device 5 is comprised of a front panel 31 and a transparent liquid crystal panel 34 (not shown) disposed on the front panel 31 at a rear surface thereof. The front panel 31 is comprised of a transparent display window 31a and a picture forming area 31b and screen images, displayed on the transparent liquid crystal panel 34 disposed on the rear surface of the front panel 31, is viewable through the display window 31a of the front panel 31.

The two-dimensional code 92 is displayed on a lower area of the transparent liquid crystal panel 34 at a central area thereof and an image is further displayed in an area below the two-dimensional code 92 in a sentence “PLEASE CAPTURE THIS IMAGE WITH CAMERA” with a view to encouraging the player to capture the two-dimensional code 92 with the CCD camera 308 of the mobile phone 300.

Disposed on a left side of the liquid crystal display device 5 at a rear side thereof are various lamps such as a game start display lamp 25, a WIN lamp 17, a medal insertion lamp 24, a MAXIMUM-BET lamp 9c, a 2-BET lamp 9b and a 1-BET lamp 9a, and various display units such as a payout medal number display unit 18, an accumulated medal number display unit 19 and a winning activation number display unit 20. Also, the picture forming area 31b on the front panel 31 is transparent at areas in front of the various lamps and various display units, set forth above, to allow the various lamps and various display units to be viewable.

The 1-BET lamp 9a, the 2-BET lamp 9b and the MAXIMUM-BET lamp 9c are turned on depending on the number of medals (hereinafter referred to as a BET number) bet for one game. One game is completed when medals are paid-out under a situation where all the reels 3L, 3C, 3R are stopped or when the medals are paid-out.

The WIN lamp 17 is turned on with a predetermined probability when an internal winning takes place on BB (Big Bonus) or RB (Regular Bonus) or when the winning on BB or RB is established. The game medal insertion lamp 24 is turned on when inserted medals become possible to accepted. The game start display lamp 25 is turned on when at least one winning line is activated.

The payout number display unit 18 serves to display the number of medals being paid-out when the winning is established; the accumulated medal number display unit 19 serves to display the number of accumulated medals; and the winning activation number display unit 20 displays an RB game available number and an RB game winning available number, etc. These display units are comprised of seven segments, respectively.

As shown in FIGS. 4-5, the liquid crystal display device 5 is comprised of the front panel 31 composed of a protector glass 32 and a display plate 33, the transparent liquid crystal panel 34, an optical waveguide 35, a reflection film 36, fluorescent lamps 37a, 37b, 38a, 38b playing roles as so-called white light sources, lamp holders 39a to 39h and a table carrier package (TCP) on which ICs for driving the transparent liquid crystal panel are mounted. The TCP is formed of a flexible substrate (not shown) that is connected to terminals of the transparent liquid crystal panel 34.

The liquid crystal display device 5 is located in front of the reels 3L, 3C, 3R. Moreover, the reels 3L, 3C, 3R and the liquid crystal display device 5 are provided in space with a predetermined distance from each other.

The protector glass 32 and the display plate 33 are made of transparent members, respectively. The display plate 33 is formed with pictures at positions corresponding to the BET lamps 9a to 9c, respectively. That is, an area of the display plate 33, in which the pictures are formed, represents the picture forming area 31b of the front panel 31 and another area of the display plate 33, in which no picture is formed, represents the display window 31a of the front panel 31 (see FIG. 2). Also, an alternative may be configured such that no picture forming area 31b is formed on the front panel 31 to allow a whole surface of the front panel 31 to form the display window 31a. In such an alternative, no picture may be formed on the display plate 33 or the display plate 33 may be dispensed with. Moreover, electric circuitries for operating the various lamps, located on the display plate 33 at a rear side thereof, and the various display units are not illustrated.

The transparent liquid crystal panel 34 is formed of a transparent substrate, such as a glass plate on which a thin film transistor layer is formed, and opposing transparent substrates between which liquid crystal is sealed in tight. A display mode of the transparent liquid crystal panel 34 is preset to provide a normally white. As used herein, the term “normally white” refers to a structure that makes up a white display (to allow lights transmitted to a display side to be viewable from outside) with the liquid crystal remaining under an inoperative condition. Using the transparent liquid crystal panel 34 structured in a “normally white” which enables a variable display or stop display on identifying information of the symbols displayed on the reels 3L, 3C, 3R to be visible even in a case where no voltage is applied to the transparent liquid crystal panel 34. Thus, by using the transparent liquid crystal panel configured to the normally white, the player can continue a gaming even if the transparent liquid crystal panel 34 is broken. That is, even in the occurrence of such a situation, the player is enabled to play a game with a focus on a variable display mode and a stop display mode on identifying information displayed on the reels 3L, 3C, 3R.

The optical waveguide 35, by which lights, emitted from the fluorescent lamps 37a, 37b, are guided to the transparent liquid crystal panel 34 (for illuminating the transparent liquid crystal panel 34), is located on the transparent liquid crystal panel 34 at a rear side thereof and formed of a transparent member (with a light guiding function) such as acrylic resin, or the like, with a thickness of, for instance, 2 cm.

The reflection film 36 is formed of, for instance, a white-colored polyester film or an aluminum foil with an evaporated silver film and serves to reflect the lights incident on the optical waveguide 35 back toward a front side of the optical waveguide 35. The reflection film 36 includes a reflection area 36A and a non-reflection area (transmitting area) 36B.

The fluorescent lamps 37a, 37b, which are located on the optical waveguide 35 at upper and lower distal ends thereof, respectively, have both ends supported by the lamp holders 39 (see FIG. 4). The lights, emitted from the fluorescent lamps 37a, 37b, are reflected at the reflection area 36A of the reflection film 36 to illuminate the transparent liquid crystal panel 34.

The fluorescent lamps 38a, 38b are located on a rear side of the reflection film 36 at upper and lower positions thereof in a way to face the reels 3L, 3C, 3R. The lights, emitted from the fluorescent lamps 38a, 38b and reflected at the surfaces of the reels 3L, 3C, 3R passes through the non-reflection area 36B, whereby the transparent liquid crystal panel 34 is illuminated.

Thus, with the liquid crystal display device 5, the lights, emitted from the fluorescent lamps 37a, 37b and reflected at the reflection area 36A of the reflection film 36, and the lights, emitted from the fluorescent lamps 38a, 38b and reflected at the surfaces of the reels 3L, 3C, 3R to be incident on the non-reflection area 36B, illuminate the transparent liquid crystal panel 34. Accordingly, the area of the liquid crystal display device 5, corresponding to the non-reflection area 36B of the reflection film 36, represents an area, which is switched over between transparent/non-transparent states, and the area of the liquid crystal display device 5, corresponding to the reflection area 36A of the reflection film 36, falls in a non-transparent status regardless of whether or not the liquid crystal is driven.

With the pachi-slot gaming machine 1, although only a partial area of the liquid crystal display device is an area that can be switched over between the transparent/non-transparent states, the gaming machine of the present invention may be configured such that a display screen of the liquid crystal display device has a whole area that is available to be switched over between the transparent/non-transparent states. In such a case, if the pachi-slot gaming machine 1 takes the form of a structure wherein the whole area of the liquid crystal display device 5 includes an area available to be switched over to a transmitting status or a non-transmitting status, a whole area of the reflection film 36 may be composed of the non-reflection surface area 36B or the reflection film 36 may be omitted.

FIG. 6 is a block diagram showing an internal structure of the pachi-slot gaming machine shown in FIG. 1. A main control circuit 81 is comprised of a major component part such as a microcomputer 40 mounted on a circuit substrate. The microcomputer 40 includes a main CPU 41 operative to perform control operations in accordance with predetermined programs, a ROM 42 and a RAM 43. Connected to the main CPU 41 are a clock pulse generation circuit 144, by which reference clock pulses are preset, and a frequency divider 145, a random number generator 146, which creates a random number subjected to sampling, and a sampling circuit 147. Also, in an alternative, a device for sampling a random number may take the form of a structure that executes samplings on random numbers on operating programs of the main CPU 41.

The ROM 42 stores therein various control commands, or the like, that are transmitted to a sub-control circuit 82. As for the commands, for instance, commands, related to display controls for the display device 2, are stored.

Examples of the commands, related to the display controls for the liquid crystal display device 5, may include, for instance, an effect start command and a completion effect command or the like. The effect start command includes a command that allows the liquid crystal display device 5 to show effect images during a rotation stop process of one of the three reels 3L, 3C, 3R. The completion effect command includes a command that allows the liquid crystal display device 5 to show other effect images during the rotation stop process of all the three reels 3L, 3C, 3R. Further, the ROM 42 stores therein other commands related to the settings of the RB, BB or commands related to the canceling of these modes, by which the settings of or canceling of the RB or BB are notified to the sub-control circuit 82. Also, in place of the various commands associated with the settings of or canceling of the RB or BB, various commands related to the display controls for the liquid crystal display device 5 may be arranged to incorporate data indicative of execution in the RB or BB.

The various commands, set forth above, are retrieved from the ROM 42 by the main CPU 41 with a predetermined condition is established and set to the RAM 43. Then, the commands, set in the RAM 43, are supplied to the sub-control circuit 82 at predetermined timings, respectively. The sub-control circuit 82 executes a variety of operations in response to the commands that are supplied.

Moreover, the sub-control circuit 82 has no probability to input the commands to the main control circuit 81 and communication is established from the main control circuit 81 to the sub-control circuit 82 in one direction. Also, the ROM 42 stores therein a symbol table that allows rotational positions of the reels 3L, 3C, 3R and symbols, drawn on the outer peripheries of the reels 3L, 3C, 3R, to be correlated to each other and stores therein a winning symbol combination table, in which combinations of the symbols forming the winnings, dividend medal numbers for the winnings and winning determination codes for the resulting winnings are correlated to each other, and a lottery odds table needed for the lotteries to determine internal winning combinations. The RAM 43 stores therein, in addition to the commands set forth above, variables and flags or the like, associated with progresses on games such as credit numbers or the like corresponding to the number of medals.

Major peripheral devices (actuators), whose operations are controlled in response to control signals delivered from the microcomputer 40, include various lamps (the 1-BET lamp 9a, the 2-BET lamp 9b, the MAXIMUM-BET lamp 9c, the WIN lamp 17, the game medal insertion lamp 24 and the game start display lamp 25), various display units (the payout medal number display unit 18, the accumulated medal number display unit 19 and the winning activation number display unit 20), a hopper (including an actuator (not shown) for executing the payout) 50 storing medals of which a predetermined number of medals are paid-out in response to a command from a hopper drive circuit 51, and stepping motors 59L, 59C, 59R by which the reels 3L, 3C, 3R are rotatably driven, respectively.

Additionally, a motor drive circuit 49 for controllably driving the driving stepping motors 59L, 59C, 59R, the hopper drive circuit 51 for controllably driving the hopper 50, a lamp drive circuit 55 for controllably driving the various lamps, and a display drive circuit 58 for controllably driving various display units are connected to an output section of the main CPU 41 via I/O ports 48. These drive circuits are responsive to the control signals, such as drive commands, which are outputted from the main CPU 41, respectively, for thereby controlling the operations of the various actuators.

Further, major input signal generators, which create input signals needed for the microcomputer 40 to create control commands, include the start switch 6S, the 1-BET switch 11, the MAXIMUM-BET switch 13, the accumulated medal number reset switch 14, an inserted medal sensor 22, a reset switch 62, a presetting key type switch 63, a reel stop signal circuit 56, a reel position detection circuit 60 and a payout completion signal circuit 61. These component parts are connected to the main CPU 41 via the I/O ports 48, respectively.

The start switch 6S detects the start lever 6 being operated. The inserted medal sensor 22S detects medals being inserted through the medal insertion slot 22. The reel stop signal circuit 56 creates stop signals depending on the respective stop buttons 7L, 7C, 7R being operated. With the decision button 26 and the cancel button 27 being operated, these buttons make it possible to switch over the display screen of the liquid crystal display device 5 while performing the inputting of the commands.

Upon receipt of pulse signals delivered from the reel rotation sensors, the reel position detection circuit 60 transmits signals for detecting positions of the respective reels 3L, 3C, 3R to the main CPU 41. The payout completion signal circuit 61 creates a medal payout completion signal when a count value (the number of medals paid-out from the hopper 50) of the medal detector 50S reaches a designated number of medals. Upon receipt of the medal payout completion signal, the main CPU 41 stops driving the hopper 50 via the hopper drive circuit 51, thereby completing paying out the medals. The medal detector 50S includes a medal sensor, composed of a physical sensor or the like, for detecting medals being paid-out from the hopper 50, resulting in a capability of counting the number of medals being paid-out from the medal sensor.

As shown in FIG. 6, the random number generator 46 creates a random number that belongs to a fixed numeric value range and the sampling circuit 47 executes sampling one random number at a suitable timing after the start lever 6 is operated. Thus, an internal winning combination is determined based on the sampled random number and the lottery odds table stored in the ROM 42. Upon determination of the internal winning combination, the sampling of another random number is executed again for selecting a “stop control table”.

After the reels 3L, 3C, 3R start rotating, the operation is executed to count the number of drive pulses being supplied to the stepping motors 59L, 59C, 59R, respectively, upon which the resulting count value is written into a predetermined area of the RAM 43. Reset pulses are delivered from the reels 3L, 3C, 3R for each one revolution and these pulses are inputted to the main CPU 41 via the reel position detection circuit 60. Due to the reset pulses obtained in such a way, the count value of the drive pulses counted in the RAM 43 is reset to “0”. This allows the RAM 43 to store the count value corresponding to the rotational positions within a range of one revolution on each of the respective reels 3L, 3C, 3R.

In order to allow the rotational positions of the respective reels 3L, 3C, 3R and the symbols drawn on the outer peripheries of the reels 3L, 3C, 3R, set forth above, to be correlated to each other, a symbol table is stored in the ROM 42. With the symbol table, code numbers, sequentially afforded to certain rotational pitches of the respective reels 3L, 3C, 3R, and symbol codes, indicative of the symbols provided in correspondence to the respective code numbers, are correlated to each other.

Further, the ROM 42 stores therein a winning symbol combination table. With the winning symbol combination table, combinations of the symbols on the winnings, dividend medal numbers on the winnings and winning determination codes, indicative of the relevant winnings, are correlated to each other. The winning symbol combination table, set forth above, is referred to when the left reel 3L, the center reel 3C and the right reel 3R are controllably stopped in operation and when a confirmation on winning is performed after all the reels 3L, 3C, 3R have been stopped, respectively.

Under a circumstance where an internal winning occurs upon lottery operation (odds lottery operation) based on the sampling of the above random number, the main CPU 41 delivers signals to the motor drive circuit 49, for controllably stopping the reels 3L, 3C, 3R, based on operation signals, delivered from the reel stop signal circuit 56 on timings at which the stop buttons 7L, 7C, 7R are depressed by the player, and selected “stop control table”.

With the reels 3L, 3C, 3R are stopped in a winning combination, and if the “payout” mode is selected with the accumulated medal number reset switch 14, the main CPU 41 supplies a payout command signal to the hopper drive circuit 51 to allow a predetermined number of medals to be paid-out. When this takes place, the medal detector 50S counts the number of medals being paid-out from the hopper 50 whereby when the resulting count value reaches a predetermined value, a medal payout completion signal is inputted to the main CPU 41. This allows the main CPU 41 to stop driving the hopper 50 via the hopper drive circuit 51, thereby completing the “medal payout process”. In the meanwhile, if the “credit” mode is selected with the accumulated medal number reset switch 14, the RAM 43 stores the number of medals, to be paid-out, as a credit.

The sub-control circuit 82 is connected to the main control circuit 81 equipped with the main CPU 41. The sub-control circuit 82 performs display controls on the liquid crystal display device 5 and output controls on sounds reproduced by the speakers 21L, 21R based on control commands delivered from the main control circuit 81.

FIG. 7 is a block diagram showing a structure of the sub-control circuit shown in FIG. 6. Further, although the presently filed embodiment takes the form of a structure that has a capability of supplying commands from the main control circuit 81 to the sub-control circuit 82 with no capability of supplying signals from the sub-control circuit 82 to the main control circuit 81, the present invention is not limited to such a structure and may take an alternative that enables the signals to be supplied from the sub-control circuit 82 to the main control circuit 81.

The sub-control circuit 82 includes a sub CPU 206, a program ROM 208 and a work RAM 210. Moreover, the decision button 26 and the cancel button 27 are connected to the sub-control circuit 82 via an interface circuit 240. Also, the sub-control circuit 82 is comprised of a display control circuit 250 that performs display controls for the liquid crystal display device 5, and a voice control circuit 230 that performs controls related to sounds to be reproduced by the speakers 21.

The sub-CPU 206 is configured to execute various operations in accordance with programs stored in the program ROM 208 and controls the sub-control circuit 82 in accordance with various commands supplied from the main CPU 41. Especially, the sub-CPU 206 performs display controls for the display control circuit 250. Moreover, the sub-CPU 206 executes the lottery for determining whether to afford a premium to a player at a timing when a command, related to the BB setting, is received from the main control circuit 81, upon which the operation is executed to encode lottery outcome data, related to a lottery outcome, for generating the two-dimensional code 92 for storage in the work RAM 210. Then, the sub-CPU 206 extracts a two-dimensional code display pattern from the program ROM 208 for transmission to a VDP (Video Display Processor) 212. The two-dimensional code display pattern may include various data, such as a position and time interval for the two-dimensional code 92 to be displayed, needed for displaying these data. As will be described below, upon receipt of the two-dimensional display pattern, the VDP 212 executes operation to read out the two-dimensional code from the work RAM 210 for display on the liquid crystal display device 5 based on the relevant two-dimensional display pattern. While the presently filed embodiment will be described with reference to a case wherein lottery outcome data is encoded for generating the two-dimensional code 92, the present invention may be practiced in an alternative wherein the two-dimensional code is preliminarily stored in an image data ROM 216.

The program ROM 208 stores a program for permitting the sub-CPU 206 to control gaming effects to be shown on the liquid crystal display device 5 and, in addition to such a program, also stores various tables such as a table, by which determination is made in relation to the effects, etc. Further, the program ROM 208 stores a plurality of kinds of effect patterns, associated with screen images to be displayed over the liquid crystal display device 5, respectively, and a plurality of kinds of completion effect patterns associated with screen images, respectively, to be provided on display over the liquid crystal display device 5 when all of the reels 3L, 3C, 3R are stopped. In addition, the program ROM 208 stores a two-dimensional code display pattern including various data by which the two-dimensional code 92 is displayed.

Although the presently filed embodiment is structured so as to use the program ROM 208 as record medium for storing the programs and tables or the like, the present invention is not limited to such a structure and may be implemented in another embodiment provided that record medium is of the type that is readable by a computer equipped with a CPU or the like and the programs and tables may be recorded in record media such as, for instance, a hard disc device (a magnetic disc memory), a CD-ROM and DVD-ROM and ROM cartridge or the like. Of course, the programs, recorded in the program ROM 208, may be stored in the ROM 42. Moreover, these programs may not be of the type that is preliminarily stored but may be of the type that is available to be downloaded to be recorded on the work RAM 210 or the like when the same is powered on. Furthermore, the programs may be stored in individual record media, respectively.

Further, with the presently filed embodiment, while the main control circuit 81, including the main CPU 41 and the ROM 42, and the sub-control circuit 82, including the sub-CPU 206 and the program ROM 208, are separately structured, the present invention is not limited to such a structure and may take the form of an alternative that is formed of only the main control circuit 81 including the main CPU 41 and the ROM 42. With such an alternative, the programs stored in the program ROM 208, set forth above, may be stored in the ROM 42 to be executed by the main CPU 41. Of course, the present invention may be structured with only the sub-control circuit 82 including the sub-CPU 206 and the program ROM 208 and with such a structure, the programs stored in the ROM 42, set forth above, may be stored in the program ROM 208 to be executed by the sub-CPU 206.

The work RAM 210 function as a temporary storage area of the sub-CPU 206 to store various flags and values of variables. Additionally, the work RAM 210 stores lottery outcome data, related to the outcome of the lotteries, and the two-dimensional code in which lottery outcome data are encoded. Although with the presently filed embodiment, the work RAM 210 is used as a temporary storage area of the sub-CPU 206, the present invention is not limited to such a configuration and may be realized with storage medium that is made available to be written and read out.

The voice control circuit 230 is comprised of a sound generator IC (controller for voice data) 232, a voice data ROM 234 that stores various voice data, and an amplifier 236 (hereinafter referred to as an “AMP”) by which voice signals are amplified.

The voice generator IC 232 is connected to the sub-CPU 206, the voice data ROM 234 and the AMP 236. The voice generator IC 232 controls voices stored in the voice data ROM 234 to be reproduced by the speakers 21.

The sub-CPU 206 selects one voice data from a plurality of voice data, stored in the voice data ROM 234, based on a command supplied form the main CPU 41. Then, the sub-CPU 206 reads out selected voice data from the voice data ROM 234 to supply the same to the voice generator IC 232. Upon receipt of voice data, the voice generator IC 232 converts voice data into a predetermined voice signal, which in turn is supplied to the AMP 236. The AMP 236 amplifies the voice signal to allow the speakers 21 (21L, 21R) to reproduce voices.

The display control circuit 250 generates screen images depending on a gaming outcome determined by the main CPU 41 or commands inputted from the various buttons 26, 27, while serving to control the screen images to be displayed over the liquid crystal display device 5, and is comprised of an image data processor (hereinafter referred to VDP) 212, an image data ROM 216 that stores various image data, and a D/A converter 218 by which image data are converted to image signals. The VDP 212 is connected to the sub-CPU 206, the image data ROM 216 in which image data are stored, and the D/A converter 218 by which image data are converted to the image signals.

The VDP 212 function as a device, including various circuits such as a so-called split circuit, a screen circuit and a pallet circuit, which enables various operations to be executed for displaying the screen images on the liquid crystal display device 5. That is, the VDP 212 performs display controls for the liquid crystal display device 5. Further, the VDP 212 includes record medium (such as, for instance, a video RAM) that serves as a buffer to cause the screen images to be displayed over the transparent liquid crystal 34 of the liquid crystal display device 5. With such record medium having a predetermined storage area that stores image data, screen images result in display over the transparent liquid crystal 34 of the liquid crystal display device 5 at predetermined timings.

The image data ROM 216 stores, for instance, a background image and character images representing characters, etc. While the presently filed embodiment is described with reference to an exemplary case wherein lottery outcome data is encoded into the two-dimensional code 92, the present invention may be implemented in such a way that the two-dimensional code 92 is preliminarily stored in the image data ROM 216.

The VDP 212 extracts the effect images from the image data ROM 216 depending on image display commands supplied from the sub-CPU 206. Further, upon receipt of a two-dimensional code display pattern from the sub-CPU 206, the VDP 212 extracts a two-dimensional code 92 from the work RAM 210 based on the relevant two-dimensional display pattern.

The VDP 212 serves to store various images, extracted from the image data ROM 216 or the work RAM 210, in a buffer (such as, for instance, a video RAM or the like) such that images are stored in order from an image located in a backside area in a superimposed fashion, that is, in order from a background screen, a character image and a two-dimensional code, to synthesize a screen image that in turn is supplied to the D/A converter 218 at a predetermined timing. The D/A converter 218 converts the screen image into an image signal, which in turn is supplied to the liquid crystal display device 5. As a result, the two-dimensional code 92 is displayed over the liquid crystal display device 5 (see FIG. 2). The player is enabled to capture the two-dimensional code 92, displayed over the liquid crystal display device 5, in image with the CCD camera 308 incorporated in the mobile phone 300. When this takes place, the liquid crystal display device 5 function as a code information display device that displays the two-dimensional code (code information), resulting from coded lottery outcome data related to the lottery outcome, in a mode available to be picked up by the player with the CCD camera 308 (image capture device).

While the first embodiment is described with reference to a case wherein the sub-CPU 206 encodes lottery outcome data into the two-dimensional code 92, the present invention may take the form of an alternative wherein data for forming the two-dimensional code 92 is stored in a storage device incorporated in the gaming machine.

Hereunder, it is supposed that the pachi-slot gaming machine 1 is started up to remain in a steady operation wherein variables, to be used in the main CPU 41, are initialized to predetermined values and the preset values are set to predetermined values, respectively.

FIG. 8 is a flowchart showing a main routine of a game execution process to be carried out in the main control circuit.

First, the main CPU 41 determines whether or not there is a request for automatic medal insertion (step S120). As used herein, the term “request for automatic medal insertion” refers to a situation under which a condition of replay (one of a winning state) a game is established on a preceding game. In the presence of request for automatic medal insertion, the operation is executed to automatically insert medals by a value equal to the number medals requested to be inserted (step S122) while transmitting a medal insertion command to the sub-control circuit 82 (step S123).

In contrast, if determination is made in step S120 that no request for automatic medal insertion is present, the main CPU 41 determines whether or not medals are inserted (step S121). That is, the main CPU 41 determines whether or not the medals are inserted by discriminating whether or not a detection signal, generated by the inserted medal sensor 22S that detects the medals being inserted to the medal insertion opening 22, is received or by discriminating whether or not detection signals, generated by the BET switches (1-BET switch 11 or the MAXIMUM-BET switch 13), are received. If determination is made that the detection signals, generated by the BET switches (1-BET switch 11 or the MAXIMUM-BET switch 13), are received, the main CPU 41 executes the operation to subtract a credit number, equivalent to the number of medals that are bet, from a credit number stored in the RAM 43.

In step S121, if determination is made that no medal is inserted, the main CPU 41 routes the operation back to step S120. Also, in step S121, if determination is made that the medals are inserted or if the operation in step S123 is executed, the main CPU 41 determines whether or not the start lever 6 is operated (step S124). That is, the main CPU 41 serves to determine whether or not an input signal is received from the start switch 6S.

In step S124, if determination is made that no start lever 6 is operated, the main CPU 41 routes the operation back to step S120. On the contrary, if determination is made that the start lever 6 is operated, the main CPU 41 executes operations related to various settings (step S125). While executing the step S125, the operations are executed to perform the samplings on random numbers, generated by the random number generator 146, at timings in which the start lever 6 is operated upon which lottery operations are executed to create an internal winning combination (winning flag) based on a random number, resulting from the resultant samplings, and the lottery odds table stored in the RAM 43. Further, in the step S125, the main CPU 41 executes WIN lamp light-up lottery operation, operation for selecting a stop control table by which the reels 3L, 3C, 3R are stopped, and initializing operation for the rotations of the reels, after which the reels 3L, 3C, 3R are started to rotate.

After the rotations of the reels 3L, 3C, 3R have been started, the operation is executed to count the number of drive pulses transmitted to the stepping motors 59L, 59C, 59R, with the resulting count value being stored in the RAM 43. Reset pulses are obtained from the reels 3L, 3C, 3R for one rotation, respectively, and inputted to the main CPU 41 via the reel position detection circuit 60. The reset pulses, obtained in such a way, clear the count values of the drive pulses, counted by the RAM 43, to “0”. By so doing, the RAM 43 stores the count values, each corresponding to a rotational position in a range within one rotation of each of the reels 31, 3C, 3R.

Further, in order to allow the rotational positions of the reels 3L, 3C, 3R and the symbols, drawn on the outer peripheries of the reels, to be correlated to each other, the symbol table stored in the ROM 42 is configured such that code numbers, sequentially afforded for each of certain rotational pitches of the respective reels 3L, 3C, 3R, and symbol codes, indicative of symbols provided in correspondence to the respective code numbers, are correlated based on a reference on the rotational positions at which the reset pulses, set forth above, are generated. Also, a winning symbol combination table, stored in the ROM 42, is referred to when the reels 3L, 3C, 3R are controllably stopped and when confirmation on the winning is executed after all the reels 3L, 3C, 3R have stopped. After the operation in step S125 is executed, the main CPU 41 shifts the operation to step S126.

In step S126, the main CPU 41 sets an effect start command in the RAM 43. The effect start command function as a command to permit the liquid crystal display device 5 to show a predetermined effect image and includes data related to the internal winning combination determined by the lottery operation set forth above. The effect start command is supplied to the sub-control circuit 82 at a predetermined timing. Upon execution of step S126, the main CPU 41 shifts the operation to step S128.

In step S128, the main CPU 41 determines whether or not the stop buttons 7L, 7C, 7R are turned “ON” (step S128) depending on the presence of or absence of the input signals from the reel stop signal circuit 56. If determination is made that no stop button is turned “ON”, then, the main CPU 41 determines whether or not the value of the automatic stop timer equals to “0” (step S129) and if determination is made that no result equals to at “0”, the operation is routed back to step S128.

On the contrary, in step S128, if determination is made that the stop buttons 7L, 7C, 7R are turned “ON” or in step S129, if determination is made that the value of the automatic stop timer lies at “0”, then, the main CPU 41 causes one of the reels 3L, 3C, 3R, associated with the one of the stop buttons 7L, 7C, 7R, to stop in rotation and, when this takes place, determines the number of sliding symbols based on a winning request (indicative of the internal winning combination), symbol positions (rotational positions of the reels 3L, 3C, 3R during the operations being executed) and the selected stop control tables (step S130).

Subsequently, the main CPU 41 executes the operations to rotate the reels 3L, 3C, 3R in the number of revolutions corresponding to the number of sliding symbols, determined in step S130, upon which the reels 3L, 3C, 3R are caused to stop (step S131), while setting a stop request for one of the reels 3L, 3C, 3R (step S132). When this takes place, the main CPU 41 functions as a variable display stop device that stops variable display of identifying information.

Next, the main CPU 41 determines whether or not all the three reels 3 (3L, 3C, 3R) are stopped (step S135). If determination is made that all the reels 3 (3L, 3C, 3R) are not stopped, then, the operation is routed back to step S128. In contrast, if determination is made that all the reels 3 (3L, 3C, 3R) are stopped, the main CPU 41 executes the retrieving on a winning combination (step S136). When this takes place, the operation is executed referring to the winning symbol combination table stored in the ROM 42. Also, an alternative may be such that determination is made to find whether or not a winning flag is normal and if the winning flag is found not to be normal, the operation may be interrupted upon providing a display of an illegal error.

Then, the main CPU 41 sets a completion effect command in the RAM 43 (step S137). The completion effect command function as a command, by which when the game is completed, an effect image is displayed depending on a gaming outcome, and includes data related to the result of winning retrieval in step S136. The completion effect command is supplied to the sub-control circuit 82 at a predetermined timing.

Subsequently, the main CPU 41 determines whether or not the medals are paid-out, that is, as to the presence of or absence of the number of winnings (step S138). If determination is made that the medals have been paid-out, then, the main CPU 41 allows the number of medals to be accumulated or paid-out depending on a gaming status and winning combination (step S139). In a mode for the medals to be accumulated, the main CPU 41 implements the operation to add the stored credit number to the RAM 43. In contrast, when implementing the payout of medals, the main CPU 41 transmits a payout command signal to the hopper drive circuit 51 to cause a predetermined number of medals to be paid-out from the hopper 50. When this takes place, the medal detector 50S counts the number of medals to be paid-out from the hopper 50 and, when the count value reaches a designated number, a medal payout completion signal is inputted to the main CPU 41. This allows the main CPU 41 to stop driving the hopper 51 via the hopper drive circuit 51, thereby terminating the operation to pay out the medals.

Next, the main CPU 41 determines whether or not the winning occurs on the RB (step S140). If determination is made that the winning occurs on the RB, the main CPU 41 implements the operation related to the setting on the RB (step S141). In step S141, the main CPU 41 executes the operations related to the settings on the lottery odds table for the RB and the winning symbol combination table for the RB. Further, in step S141, the main CPU 41 begins to count the number of winnings in the RB game and commences the operation to display the resulting count value on the winning activation number display unit 20. Upon execution of step S141, the main CPU 41 shifts the operation to step S142.

In step S142, the main CPU 41 sets an RB setting command in the RAM 43. The RB setting command function as a command, by which the effect image for the RB is displayed on the liquid crystal display device 5, and is supplied to the sub-control circuit 82 at a predetermined timing.

In step S140, if determination is made that no winning occurs on the RB or if the operation in step S142 is executed, the main CPU 41 determines whether or not the winning occurs on the BB (step S143). If determination is made that the winning takes place on the BB, the main CPU 41 executes the operation related to the setting on the BB (step S144). In step S144, the main CPU 41 implements the operations for setting the lottery odds table for the BB and the winning symbol combination table for the BB. Also, in step S146, the main CPU 41 begins counting the number of times in which the BB games are practiced, displaying the resulting count value on the winning activation number display unit 20 and counting the number of paid-out medals. When this takes place, the main CPU 41 function as a special gaming status shift device through which the operation is shifted to a special gaming status (BB). Thereafter, the main CPU 41 shifts the operation to step S145.

In step S145, the main CPU 41 sets a BB setting command in the RAM 43. The BB setting command function as a command, by which the effect image for the BB is displayed over the liquid crystal display device 5, and is inputted to the sub-control circuit 82 at a predetermined timing.

In step S143, if determination is made that no winning occurs on the BB or if the operation in step S145 is executed, the main CPU 41 determines whether or not the RB is terminated (step S146). If determination is made that the RB has been terminated, then, the main CPU 41 implements the operation related to cancellation of the RB setting (step S147). In step S148, the main CPU 41 executes the operations to alter the setting from the lottery odds table for the RB and the winning symbol combination table for the RB, set in the operation in step S141, to the lottery odds table for use in a normal gaming state (except for the RB or BB). Thereafter, the main CPU 41 shifts the operation to step S148. In step S148, the main CPU 41 sets an RB cancellation command in the RAM 43. The RB cancellation command function as a command by which the display of the effect image for the RB is stopped while an effect image under a status (except for those of the RB or BB) other than the normal statues is displayed over the liquid crystal display device 5. The RB cancellation command is supplied to the sub-control circuit 82 at a predetermined timing.

In step S146, if no determination is made that the RB is terminated or if the operation in step S148 is executed, then, the main CPU 41 determines whether or not the BB is terminated (step S149). If determination is made that the BB is terminated, then, the main CPU 41 implements the operation related to the cancellation of the setting on the BB (step S150). In step S150, the main CPU 41 executes the operations to alter the setting from the winning symbol combination table for the BB to the lottery odds table for use in the normal gaming state (except for the RB or BB). Thereafter, the main CPU 41 shifts the operation to step S151.

In step S151, the main CPU 41 sets a BB cancellation command in the RAM 43. The BB cancellation command function as a command, by which the display of the effect image for the BB is stopped, while an effect image under a status (except for those of the RB or BB) other than the normal status is displayed over the liquid crystal display device 5. The BB cancellation command is supplied to the sub-control circuit 82 at a predetermined timing. In step S149, if determination is made that no RB is terminated or if the operation in step S151 is executed, the current sub-routine is completed.

FIG. 9 is a flowchart showing a sub-routine of a command receiving process to be implemented in the sub-control circuit in the presently filed embodiment. First, in step S200, the sub-CPU 206 determines whether or not the effect start command is received. If determination is made that no effect start command is received (S200: YES), then, the operation is shifted to step S210. In contrast, if determination is made that the effect start command is received, then, in step S201, the sub-CPU 206 selects an effect pattern, associated with the relevant command, from a plurality of kinds of effect patterns stored in the program ROM 208. With RB flag being set, the sub-CPU 206 selects an effect pattern for the RB. Moreover, with BB flag being set, the sub-CPU 206 selects an effect pattern for the BB. In next step S202, the operation is executed to supply effect pattern data, forming data indicative of an effect pattern, to the display control circuit 250. After the operation in step S202 has been executed, the operation is shifted to step S210.

In step S210, the sub-CPU 206 determines whether or not a completion effect command is received. If determination is made that no completion effect command is received (S210: NO), the operation shifts to step S220. On the contrary, if determination is made that the completion effect command is received, then, in step S221, the sub-CPU 206 selects a completion effect pattern, associated with the relevant command, from among a plurality of kinds of completion effect patterns stored in the program ROM 208. In step S212, completion effect pattern data is supplied to the display control circuit 250. After the operation in step S210 has been executed, the operation proceeds to step S220.

In step S220, the sub-CPU 206 determines whether or not the RB setting command has been received. If determination is made that no RB setting command has been received, the operation proceeds to step S230. On the contrary, if determination is made that the RB setting command has been received, the sub-CPU 206 executes the operation in step S221 to set RB flag. After the operation in step S221 has been executed, the operation proceeds to step S230. Also, RB flag is a flag that is set when the RB is started and cleared when the RB is terminated.

In step S230, the sub-CPU 206 determines whether or not the BB setting command is received. If determination is made that no BB setting command is received, the operation proceeds to step S240. In contrast, if determination is made that the BB setting command has been received, the sub-CPU 206 executes the operation in step S231 to set BB flag. BB flag function as a flag that is set when the BB is started and cleared when the BB is terminated.

After the operation has been executed in step S231, the sub-CPU 206 executes a premium lottery process (step S232). During the execution of operation in step S232, the sub-CPU 206 function as a lottery device that performs the lottery to determine whether or not a premium is afforded to a player. During such operation, first, the sub-CPU 206 executes a random number generation program preliminarily stored in the program ROM 208, upon which one random number is extracted from among a numeric value ranging from 0 to 16383. Then, the sub-CPU 206 determines lottery outcome data associated with extracted one random number by referring to a premium lottery table that is preliminarily stored in the program ROM 208.

FIG. 10 is a view showing one example of the premium lottery table. Although FIG. 10 describes about premium data with a view to showing the correspondence between lottery outcome data (URL) and premium data, the premium data is not stored in the program ROM 208.

In a case where the random number value is involved in a range from 0 to 6143, a URL, serving as a lottery outcome table, is expressed as “http://***.***.003.htm” in which premium data is absent. In this case, an outcome of the lottery is a losing and even if the player accessed to this URL, no premium data can be obtained.

In another case where the random number value is involved in a range from 6144 to 8191, the URL, playing a role as the lottery outcome table, is expressed as “http://***.***.004.htm” wherein premium data includes a “AWAITING IMAGE A”. In this case, by accessing to this URL, an AWAITING IMAGE (wallpaper) A can be obtained as premium data.

In another case where the random number value is involved in a range from 8192 to 10239, the URL, playing a role as the lottery outcome table, is expressed as “http://***.***.005.htm” wherein premium data includes a “AWAITING IMAGE B”. Accordingly, by accessing to this URL, an AWAITING IMAGE (wallpaper) B can be obtained as premium data.

In another case where the random number value is involved in a range from 10240 to 12287, the URL, playing a role as the lottery outcome table, is expressed as “http://***.***.006.htm” wherein premium data includes a “MUSIC DATA X”. Accordingly, by accessing to this URL, a MUSIC DATA X for Chaku-Melo can be obtained as premium data.

In another case where the random number value is involved in a range from 12288 to 14335, the URL, playing the role as the lottery outcome table, is expressed as “http://***.***.007.htm” wherein premium data includes a “MUSIC DATA Y”. Accordingly, by accessing to this URL, a MUSIC DATA Y for Chaku-Melo can be obtained as premium data.

In another case where the random number value is involved in a range from 14336 to 16383, the URL, playing the role as the lottery outcome table, is expressed as “http://***.***.008.htm” wherein premium data includes a “MUSIC DATA Z”. Accordingly, by accessing to this URL, a MUSIC DATA Z for Chaku-Melo can be obtained as premium data.

After the premium lottery process has been executed in step S232, the sub-CPU 206 executes an encoding process to allow the URL, serving as lottery outcome data, to be coded into a two-dimensional code 92 (step S233). The encoding process will be described below in detail with reference to FIG. 11. Then, the sub-CPU 206 stores the two-dimensional code 92, generated in step S233, in the work RAM 210 (step S234).

In step S230, if determination is made that no BB setting command is received or if the operation in step S234 is executed, the sub-CPU 206 determines whether or not the RB cancellation command is received (step S240). If determination is made that the RB setting command is received, RB flag is cleared (step S241).

In step S240, if determination is made that no RB cancellation command is received or if the operation is executed in step S241, the sub-CPU 206 determines whether or not the BB cancellation command is received (step S250). If determination is made that no BB cancellation command is received, the current sub-routine is completed. On the contrary, if determination is made that the BB cancellation command is received, the sub-CPU 206 clears BB flag (step S251). Subsequently, the sub-CPU 206 reads out a two-dimensional display pattern from the program ROM 208 for supply to the display control circuit 250 (step S252). Thereafter, the current sub-routine is completed.

FIG. 11 is a flowchart showing a sub-routine for the encoding process to be retrieved and executed in step S233 of the sub-routine shown in FIG. 9.

First, the sub-CPU 206 sets the URL, serving as lottery outcome data related to the lottery outcome in the premium lottery process (step S233 in FIG. 9), in the work RAM 210 (step S400). The lottery figure shows “http://***.***.004.htm” as one example of the URL serving as lottery outcome data.

Then, the sub-CPU 206 generates a mode identifier depending on letter types (for instance, numerals, alpha-numerals, Chinese characters, etc.) (step S401). Subsequently, the sub-CPU 206 generates a letter number identifier depending on the number of letters of lottery outcome data in the work RAM 210 (step S402). Next, the sub-CPU 206 executes the operation to cause lottery outcome data to be binary coded (step S403). Thereafter, the sub-CPU 206 executes the operation to add a termination pattern to data resulting from the operations in steps S401 to S403 (step S404).

Next, the sub-CPU 206 executes coding word conversion on data resulting from the operation in step S404 (step S405) and, additionally, generates an error correction coded word based on data resulting from the operation in step S405 to add the same to data resulting from the operation in step S405 (step S406). Then, the sub-CPU 206 executes the operation to cause data, resulting from the operation in step S406, to be binary coded into a layout in a matrix form (step S407). Subsequently, the sub-CPU 206 executes operation to mask data, resulting from the operation in step S407, with a predetermined pattern (step S408). Then, the operation is executed to add format information involving an error correction level and a mask identifier (step S409) upon which the two-dimensional code 92 is generated (S410). The resulting two-dimensional code 92 is stored in the work RAM 210. Thereafter, the current sub-routine is completed.

While the presently filed embodiment has been described with reference to an exemplary case wherein only the URL, serving as lottery outcome data, is encoded (in coding) into the two-dimensional code 92, the present invention may be altered such that lottery outcome data and other data (such as, for instance, data indicative of a model of a gaming machine and unique data of the relevant gaming machine for identifying the gaming machine) are encoded. Such various cases will be described later.

FIG. 12 is a flowchart showing a sub-routine of a display control process to be executed in the display control device. The VDP 212 generates an image associated with a variety of data supplied from the sub-CPU 206. If no effect pattern data is supplied from the sub-CPU 206 (that is, no effect pattern is stored) (step S300: NO), the VDP 212 extracts a demo image from the image data ROM 216 for storage in the buffer (step S301).

If effect pattern data is supplied from the sub-CPU 206 (step S300: YES) but no completion effect pattern data is supplied (step S304: NO), the VDP 212 extracts an effect image from the image data ROM 216 for storage in the buffer (step S305).

If effect pattern data is supplied from the sub-CPU 206 (step S300: YES) and completion effect pattern data is supplied (step S304: YES), the VDP 212 extracts the effect image for a completion mode from the image data ROM 216 for storage in the buffer (step S306). If the two-dimensional display pattern data is supplied (step S320: YES) after the operations in steps S301, S305 or S306 have been executed, the VDP 212 extracts the two-dimensional code 92 from the work RAM 210 for storage in the buffer (step S321). When this takes place, the two-dimensional code 92 is stored in a superimposed relation with the effect image extracted in steps S301, S305 or S306 and stored in the buffer. Thereafter, if it stands for timing at which a display of the two-dimensional code 92 is terminated (step S323: YES), then, two-dimensional code display pattern data is cleared (step S324).

Subsequently, the images are outputted to the liquid crystal display device 5 (step S308) at predetermined timings (of, for instance, every 1/30 seconds) (step S307: YES). As a result, the liquid crystal display device 5 shows the two-dimensional code 92 as shown in FIG. 2. In contrast, if no predetermined timing is present (step S307: NO), the operation is routed back to step S307.

Thereafter, if the effect is not completed (step S310: NO), the operation is routed back to step S300. On the contrary, if the effect is completed (step S310: YES), the operation is routed back to step S300 via step S311.

While the presently filed embodiment has been described with reference to a case wherein the premium lottery is carried out at the timing in which the BB is determined, the present invention is not particularly limited to the timing at which the premium lottery is implemented and may be possible to be appropriately set.

The gaming machine of the present invention may preferably shows code information (two-dimensional code 92) when the special gaming status (BB) is terminated. This is because of the fact that due to a capability in which code information is displayed when it is mostly liable for a fever on a game to go down like a time when the special gaming status is terminated, interests and concerns to the game can be raised again. Moreover, although a difficulty is encountered in capturing the code information with an image capture device of a mobile phone even if the same is displayed during a period when the player gets absorbed in the game, time at which the special gaming status is terminated represents a period that marks a chukker in game. Hence, even if the code information is displayed, it does not disturb the player, and therefore the player reliably capture the code information. Also, the gaming machine of the present invention is not limited to such a particular example on the timing at which code information is displayed.

FIG. 13 is a block diagram showing an internal structure of the mobile phone shown in FIG. 1. Also, the mobile phone 300 corresponds to the mobile device of the present invention. The mobile phone 300 is comprised of an operation device 304, a liquid crystal panel 306, a CCD camera 308 serving as an image capture device, a radio device 310, a voice circuit 312, a speaker 314, a microphone 316, a transmission and receiving antenna 318, a non-volatile memory 320, a microcomputer 322 and a secondary battery 324.

The radio device 310 is controlled by the microcomputer 322 to transmit radio waves to and receives the same from a base station over the transmission and receiving antenna 318. The voice circuit 312 outputs a receiving signal, outputted from the radio device 310 via the microcomputer 322, to the speaker 314, while outputting a voice signal, outputted from the microphone 316, to the radio device 310 via the microcomputer 322.

The speaker 314 converts the receiving signal, outputted from the voice circuit 312, into a receiving voice to be outputted and the microphone 316 converts a transmitting signal, generated by an operator, into a voice signal which in turn is outputted to the voice circuit 312. The CCD camera 308 is possible to capture the two-dimensional code 92 displayed over the liquid crystal display device 5 of the pachi-slot gaming machine 1 and the captured image data is stored in the non-volatile memory 320. While the presently filed embodiment is described with reference to an exemplary case where the CCD camera is used as the image capture device, the present invention is not particularly limited to such an exemplary case and may include, for instance, a CMOS sensor or the like.

The non-volatile memory 320 stores, for instance, image data, obtained by the CCD camera 308 upon capturing the two-dimensional code 92, the captured image data for the waiting image, various data, such as music data for Chaku-Melo, and various programs in a non-volatile fashion. The secondary battery 324 supplies electric power to various circuits. The microcomputer 322 is comprised of a CPU, a ROM and a RAM to execute, for instance, sending and receiving operations on phones, generating and sending/receiving operations of electronic mails and Internet operations. Also, the microcomputer 322 executes the sending and receiving of the electronic mails and the sending and receiving of data over the Internet via the radio device 310 and the transmission and receiving antenna 318.

The microcomputer 322 downloads a predetermined program from the server 200 over the Internet for storage in the non-volatile memory 320 based on a predetermined command inputted from the operation device 304. Then, the microcomputer 322 reads out and executes the above-described program from the non-volatile memory 320, providing functions (A) and (B) as described below.

(A) The microcomputer 322 recognizes the two-dimensional code 92 from image data obtained, when the CCD camera 308 captures the two-dimensional code 92, and generates lottery outcome data based on such recognized (captured) two-dimensional code 92. When this takes, the microcomputer 322 function as a code information-recognizing device.

(B) The microcomputer 322 allows the radio device 310 and the transmission and receiving antenna 318 to transmit lottery outcome data, generated in the operation step (A) set forth above, to the server 200 over the Internet. When this takes place, the microcomputer 322 function as a lottery outcome data transmission device.

While the presently filed embodiment is described with reference to a case wherein the mobile phone 300 downloads the programs from the server 200, an alternative may be such that the programs are preliminarily stored (preinstalled) in the non-volatile memory 322 of the mobile phone 300.

FIG. 14 is a block diagram showing an internal structure of the server 200 shown in FIG. 1. The server 200 is comprised of a CPU 201, serving as an arithmetic processing device, a ROM 202, a RAM 203, a communication interface circuit 204 through which communication is established with the mobile phone 300 over the Internet, and a hard disc drive 205.

The hard disc drive 205 stores premium data (such as, for instance, image data for an awaiting image and music data for Chaku-Melo, etc.) for each site with the URL serving as lottery outcome data. The hard disc drive 205 functions as premium data storage device that stores premium data to be transmitted to the mobile phone 300. Upon receipt of the URL, serving as lottery outcome data, and ID data of the mobile phone 300 from the mobile phone 300, the CPU 201 reads out data (such as, for instance, HTML data, etc.), indicative of a site associated with the URL, and premium data, such as those described above, and allows the communication interface circuit 204 to transmit the same to the mobile phone 300 over the Internet. As a result, the liquid crystal display panel 306 of the mobile phone 300 shows the site, associated with URL serving as lottery outcome data, in which premium data can be obtained.

Further, the hard disc drive 205 stores programs to be downloaded to the mobile phone 300. Upon receipt of a signal, requesting the downloading of the programs, from the mobile phone 300, the CPU 201 reads out the programs from the hard disc drive 205 to transmit the same to the mobile phone 300 from the communication interface circuit 204 over the Internet.

FIG. 15 is a flowchart showing a process to be executed between the mobile phone 300 and the server 200. First, the microcomputer 322, incorporated in the mobile phone 300, drives the CCD camera 308, serving as an image capture device, based on a command applied from the operation device 304, causing the CCD camera 308 to capture an image of the two-dimensional code 92 displayed over the liquid crystal display device 5 of the pachi-slot gaming machine 1, (step S500).

Thereafter, the microcomputer 322 stores image data, obtained in step S500, in the non-volatile memory 320 (step S501). Then, the microcomputer 322 executes two-dimensional code recognizing operation (step S502) to recognize the two-dimensional code 92 based on image data obtained in step S500, thereby generating lottery outcome data based on such recognized two-dimensional code 92. The two-dimensional code recognizing operation is described below in detail.

In step S502, the microcomputer 322 function as a code information-recognizing device that recognizes the two-dimensional code 92 based on image data, obtained when the CCD camera 308 (image capture device) captures the two-dimensional code (code information) in image, to generate lottery outcome data based on such recognized two-dimensional data 92.

Next, the microcomputer 322 allows the radio device 310 and the transmitting and receiving antenna 318 to transmit lottery outcome data, obtained in the two-dimensional code recognizing operation executed in step S502, together with ID data of the mobile phone 300 to the server 200 over the Internet (step S503). In step S503, the microcomputer 322 function as a lottery outcome data transmission device that transmits lottery outcome data, generated in step S502, to the server 200.

Upon receipt of lottery outcome data (URL) and ID data of the mobile phone 300 from the mobile phone 300 over the Internet, the CPU 201 incorporated in the server 200 stores lottery outcome data (URL) and ID data, which are set forth above, in the hard disc drive 205 (step S601). Then, the CPU 201 extracts data (such as, for instance, HTML data, etc.), indicative of a site associated with the URL serving as lottery outcome data received in step S601, and premium data associated with such a site from the hard disc drive 205 (step S602). When this takes place, the CPU 201 function as an extraction device that extracts premium data from the hard disc drive 205 (premium data storage device) based on lottery outcome data received from the mobile phone 300. Then, the CPU 201 transmits data, indicative of the site, and premium data to the mobile phone 300 (step S603). The CPU 201 function as a premium data transmission device that transmits premium data, extracted in step S602, to the mobile phone 300.

The microcomputer 322 of the mobile phone 300 stores data (such as data, indicative of the relevant site, and premium data), transmitted from the server 200, in the non-volatile memory 320 (step S504). Thereafter, the microcomputer 322 allows the site to be displayed over the liquid crystal display device 5, depending on the URL serving as lottery outcome data, based on the above data. Then, upon operation of the operation device 304 to input a predetermined command, the player is able to obtain premium data.

FIG. 16 is a flowchart showing a two-dimensional code recognition process to be retrieved and executed in step S501 in the process shown in FIG. 15. First, the microcomputer 322 executes image converting operation on image data stored in the non-volatile memory 320 (step S700). The image converting operation includes operations of extracting image data, for an area in which the two-dimensional code 92 is displayed, from among image data resulting upon capturing the image, correcting an inclination and strain and converting image data into a monochrome image with a predetermined threshold value for thereby obtaining image data including the two-dimensional code 92 as viewed shown in FIG. 2.

Next, the microcomputer 322 extracts the two-dimensional code 92 from image data obtained in step S700 and executes correction such as noise removal or the like (step S701). Then, the microcomputer 322 implements binary-coding operation on the two-dimensional code 92 obtained in step S701 to substitute respective dots, forming the two-dimensional code, to “0” or “1” (step S702) for thereby generating binary coded matrix data (step S703). Subsequently, the microcomputer 322 decodes binary coded matrix data (step S704) for thereby generating lottery outcome data (step S705). Thereafter, the current sub-routine is completed and the operation is shifted to the operation in step S503 of the flowchart shown in FIG. 15.

As set forth above, when the mobile phone 300 transmits the URL, serving as lottery outcome data, and ID data of the mobile phone 300 to the server 200 (step S503 in FIG. 15), the server 200 transmits data (such as, for instance, HTML data, etc.), indicative of the site associated with such a URL, and premium data to the mobile phone 300 (step S603 in FIG. 15), thereby causing an image to be displayed in a manner as shown in FIG. 17. FIG. 17 is a view showing one example of an awaiting image transmitted from the server 200 to the mobile phone 300 as a premium. The liquid crystal panel 306 has a central area provided with a display of the awaiting image representing a character appearing in an effect of the pachi-slot gaming machine 1. Also, a lower area of the liquid crystal panel 306 is provided with two selection items including “RETURN” and “SAVE”. When this takes place, operating the operation device 304 to select the selection item “SAVE” results in operation to cause image data for the awaiting image to be stored in the non-volatile memory 320 of the mobile phone 300.

As set forth above, with the pachi-slot gaming machine 1 and the service providing system 500 of the first embodiment, since the two-dimensional code 92, resulting from coding the URL serving as lottery outcome data related to the premium lottery outcome, is displayed in a mode to be captured with the CCD camera 308 of the mobile phone 300 (see FIG. 2), the player is enabled to capture the two-dimensional code 92 with the CCD camera 308 of the mobile phone 300 to allow the mobile phone 300 to transmit lottery outcome data, resulting from the two-dimensional code 92, to the server 200 whereby premium data, associated with the lottery outcome, can be obtained from the server 200 (see FIG. 17). Therefore, a service can be provided with merits on both sides of game arcade and a gaming machine manufacturer in such a way wherein the game arcade has the abilities to pull in more customers due to a capability of displaying the two-dimensional code 92, needed for the premium to be acquired, on the pachi-slot gaming machine 1 (see FIG. 2) whereas the gaming machine manufacturer is able to allow a support and attachment to be provided on the pachi-slot gaming machine 1 of the relevant gaming machine manufacturer in the game arcade. Further, another advantage resides in that such a service can be provided without causing store clerks to suffer from increased troubles and labors. In addition to pleasures in merely acquiring medals, the player can be provided with new pleasures, which are not influenced by regulations, in such a way that music data for Chaku-Melo and image data for the awaiting image can be obtained as premiums. Thus, even if a drop occurs in gambling spirits of the pachi-slot gaming machine 1 due to the occurrence of strong regulations, the pachi-slot gaming machine 1 is enabled to remain popular, making it possible to prevent the game arcade and the gaming machine manufacturer from suffering losses in profits due to variations in the regulations on the pachi-slot gaming machine 1.

Further, the mobile phone 300 of the first embodiment corresponds to a mobile device of the present invention. The mobile phone 300 has a capability of picking up the two-dimensional code of the pachi-slot gaming machine 1 that displays the two-dimensional code 92 resulting from coding lottery outcome data related to premium lottery outcome to allow lottery outcome data to be generated based on the resulting image data for transmission to the server 200, enabling premium data, associated with lottery outcome, to be obtained from the server 200 (see FIGS. 15 and 16). Accordingly, a service can be provided with advantages on both sides of the game arcade and the gaming machine manufacturer.

### Second Embodiment

Now, a second embodiment according to the present invention is described. While with the service providing system 500 of the first embodiment, the mobile phone 300 includes the code information recognition device, a service providing system of the second embodiment is described with reference to an exemplary case wherein the server 200 includes the code information recognition device. Also, appearances and internal structures (see FIGS. 1 to 7 and FIGS. 13 and 14) of the pachi-slot gaming machine 1, the mobile phone 300 and the server 200, forming the service providing system of the second embodiment, and the processes (see FIGS. 8 to 12) to be executed in the pachi-slot gaming machine 1, which are identical to those of the first embodiment, are herein omitted in description and description is made of only processes to be executed by the mobile phone and the server with reference to FIG. 18. Hereunder, description is made with the same component parts as those of the service providing system of the first embodiment bearing like reference numerals.

First, the microcomputer 322, incorporated in the mobile phone 300, drives the CCD camera 308, serving as the image capture device, based on a command applied from the operation device 304, causing the CCD camera 308 to capture the two-dimensional code 92 appearing in the screen image displayed over the liquid crystal display device 5 of the pachi-slot gaming machine 1 (step S510).

Thereafter, depending on a command applied from the operation device 304 or data indicative of an address preliminarily transmitted from the server 200, the microcomputer 322 accesses a predetermined address (such as, for instance, the URL indicative of a site on the gaming machine manufacture) inside the server 200 to render the radio device 310 and the transmission and receiving antenna 318 operative to cause image data, obtained by the CCD camera 308 capturing the two-dimensional code 92, to be transmitted together with ID data of the mobile phone 300 to the server 200 over the Internet under a communication standard (such as, for instance, FTP or the like) that is known in the art (step S511). When this takes place, the microcomputer 322 of the mobile phone 300 function as an image data transmission device by which image data, obtained when the CCD camera 308 (image capture device) captures the two-dimensional code (code information) 92, is transmitted to the server 200.

Upon receipt of image data and ID data of the mobile phone 300 from the mobile phone 300 over the Internet, the CPU 201, incorporated in the server 200, stores image data and ID data, set forth above, in the hard disc drive 205 (step S610). Then, the CPU 201 of the server 200 executes the two-dimensional code recognition process (step S611) to recognize image data transmitting device based on image data, obtained when the CCD camera 308 (image capture device) of the mobile phone 300 captures the two-dimensional code in image, thereby generating lottery outcome data based on such recognized two-dimensional code 92. The two-dimensional code recognition process, to be executed in the same way as that of the first embodiment, has been already described with reference to FIG. 16 and, hence, description of the same is herein omitted. When executing the operation in step S611, the CPU 201 of the server 200 function as a code information recognition device that recognizes the two-dimensional code based on image data received from the mobile phone 300 to generate lottery outcome data based on such recognized two-dimensional code.

Next, the CPU 201 stores lottery outcome data, obtained upon executing the two-dimensional code recognition process in step S611, in the hard disc drive 205 in correspondence to ID data of the mobile phone 300 (step S612). Then, the CPU 201 extracts data (such as, for instance, HTML data or the like), indicative of a site associated with the URL serving as lottery outcome data obtained upon executing the two-dimensional code recognition process in step S611, and premium data, associated with such a site, from the hard disc drive 205 (step S613). When this takes place, the CPU 201 function as an extracting device that extracts premium data from the hard disc drive 205 (premium data storage device) based on lottery outcome data generated by the code information-recognizing device. Then, the CPU 201 transmits data, indicative of the site, and premium data to the mobile phone 300 (step S614). When this takes place, the CPU 201 function as a premium data transmission device that transmits premium data, extracted in step S613, to the mobile phone 300.

The microcomputer 322 of the mobile phone 300 stores data (i.e., data, indicative of the site, and premium data), transmitted from the server 200, in the non-volatile memory 320 (step S512). Then, the microcomputer 322 allows the liquid crystal display device 5 to show the site associated with the URL, serving as lottery outcome data, based on data described above (see FIG. 17). Thus, the player is enabled to acquire premium data by inputting a predetermined command upon operating the operation device 304.

As mentioned above, with the service providing system of the second embodiment, the two-dimensional code 92, in which lottery outcome data related to an outcome of the premium lottery is coded, is displayed over the pachi-slot gaming machine 1 upon which the player captures the two-dimensional code 92 with the CCD camera 308 of the mobile phone 300 to cause the resulting image data to be transmitted to the server 200 whereby the player is enabled to acquire premium data, depending on the lottery outcome, from the server 200. Therefore, a service can be provided with merits on both sides of game arcade and a gaming machine manufacturer in such a way wherein the game arcade have the abilities to pull in more customers due to a capability of displaying the two-dimensional code 92, needed for the premium to be acquired, on the pachi-slot gaming machine 1 whereas the gaming machine manufacturer is able to allow a support and attachment to be provided on the pachi-slot gaming machine 1 of the relevant gaming machine manufacturer in the game arcade. Further, another advantage resides in that such a service can be provided without causing store clerks to suffer from increased troubles and labors. In addition to pleasures in merely acquiring medals, the player can be provided with new pleasures, which are not influenced by regulations, in such a way that music data for Chaku-Melo and image data for the awaiting image can be obtained as premiums. Thus, even if a drop occurs in gambling spirits of the pachi-slot gaming machine 1 due to the occurrence of strong regulations, the pachi-slot gaming machine 1 is enabled to remain popular, making it possible to prevent the game arcade and the gaming machine manufacturer from suffering losses in profits due to variations in the regulations on the pachi-slot gaming machine 1.

Further, the server 200 of the second embodiment corresponds to a server of the present invention. Such a server 200 is enabled to receive image data, obtained when the CCD camera 308 of the mobile phone 300 captures the two-dimensional code in image on the pachi-slot gaming machine 1, from the mobile phone 300 upon which lottery outcome data is generated based on resulting image data and premium data, associated with the lottery outcome, can be transmitted to the mobile phone 300. Thus, a service can be provided with merits on both sides of the game arcade and the gaming machine manufacturer.

While the embodiment as been described above with reference to en example wherein premium data includes image data for the awaiting image and music data for Chaku-Melo, premium data of the present invention is not limited to such an example. Premium data may include, for instance, data or the like, indicative of a format to allow personal information (such as, for instance, a name and address, etc.) to be inputted for application to the premium, for transmission to the mobile device. In this case, upon operation of the player to input predetermined personal information to the format mentioned above for transmission to the server, the player is enabled to obtain the above premium on a door-to-door service or the like. In such a case, a tangible entity may be adopted as a premium.

With the present invention, data to be coded may include time-limit information. That is, the gaming machine 1 displays the two-dimensional code 92 which is coded based on the lottery outcome data and data designating when this lottery outcome data is generated. In this configuration, the server 200 makes determination, based on date and hour, at which these data are received or generated, and date and hour at which lottery outcome data is coded into the two-dimensional code 92, as to whether or not a predetermined time period (such as, for instance, one day, one week, etc.) has elapsed. If determination is made that the predetermined time period has elapsed, no premium data is transmitted to the mobile device regardless of a lottery outcome on a premium while data may be transmitted to the mobile device to cause the same to show an image representing expiration or loosing in the lottery outcome on the premium.

Further, with the second embodiment, it may be preferred that a gaming machine 1 displays the two-dimensional code 92 which is coded based on the lottery outcome data and data designating when this lottery outcome data is generated (hereinafter, this data referred to as “TOD-data (time of date data)”). In this configuration, the server 200 makes determination, based on the lottery outcome data including the TOD-data and ID data of the mobile device 300, as to whether or not the premium data associated with the same lottery outcome data has been already transmitted in the past after which if determination is made that premium data based on the same lottery outcome data has been already transmitted in the past, no premium data is transmitted to the mobile device while premium data is transmitted to the mobile device to cause the same to show an image representing the loosing on the lottery outcome of the premium. By this configuration, it is possible to prevent premium data from being obtained several times based on the same lottery outcome data.

Hereunder, other embodiments of the present invention are described. Also, the same component parts bear like reference numerals and descriptions of the same are herein omitted.

### Third Embodiment

A third embodiment includes a pachi-slot gaming machine 1A (FIG. 19) in place of the pachi-slot gaming machine 1 shown in FIG. 2 with other structures being roughly similar thereto. Therefore, various features mentioned above may similarly apply to the embodiment described below unless otherwise indicated. Description is made hereunder with a focus on an outline of the presently filed embodiment on points differing from the first embodiment.

Also, with the presently filed embodiment, the pachi-slot gaming machine 1A features that the liquid crystal display device 5 shows a display of the two-dimensional code 92 which is coded based on unique model data (i.e., model information shown at 5A in FIGS. 19, 20) preliminary determined for each model of the pachi-slot gaming machine 1A, when a BB (Big Bonus) in a special gaming status is terminated (see FIG. 20).

Describing the outline of the presently filed embodiment, the mobile phone 300 recognizes the two-dimensional code 92, based on image data obtained when capturing the two-dimensional code 92 with the CCD camera 308, thereby generating model data based on such recognized two-dimensional code 92. Then, this model data is transmitted to the server 200.

The hard disc drive 205 (see FIG. 14), incorporated in the server 200, stores premium data (such as, for instance, image data for an awaiting image involving characters or the like appearing in an effect of the relevant model, and music data, etc., for Chaku-Melo including music to be used in the effect of the relevant model) and the server 200 extracts premium data based on model data received from the mobile phone 300. Then, extracted premium data is transmitted to the mobile phone 300.

Thus, with the service providing system 500, the player is enabled to obtain model data with the mobile phone 300 upon operation of the CCD camera 308, equipped in the mobile phone 300, to capture the two-dimensional code 92 displayed over the liquid crystal display device 5 of the pachi-slot gaming machine 1A when the BB is terminated, whereby upon transmitting such model data to the server 200, premium data, associated with the relevant model, can be obtained from the server 200. Thus, the third embodiment differs from the first embodiment in that the model data is employed in place of lottery outcome data. Therefore, the sub-control circuit 82 operates in a different manner as described below.

With the third embodiment, the sub-control circuit 206 reads out the model data, stored in the program ROM 208, at a timing in which a command, related to the BB cancellation, is received from the main control circuit 81 to encode relevant model data into the two-dimensional code 92 which is stored in the work RAM 210. While the presently filed embodiment is described with reference to en exemplary case wherein the model data is encoded to generate the two-dimensional code 92, the present invention may be implemented such that the two-dimensional code 92 is preliminarily stored in the image data ROM 216, etc.

With the presently filed embodiment, the model data, stored in the program ROM 208, includes a URL that is uniquely set for each model.

Further, the image data ROM 216 stores, for instance, a background image and character images or the like, indicative of characters. While the presently filed embodiment is described with reference to an exemplary case wherein model data is encoded to generate the two-dimensional code 92, the present invention may be configured such that the two-dimensional code 92 is preliminarily stored in the image data ROM 216.

The VDP 212 extracts an effect image from the image data ROM 216 depending on an image display command supplied from the sub-CPU 206. Moreover, the VDP 212 extracts the two-dimensional code 92 from the work RAM 210 based on a two-dimensional code display pattern upon receipt of the relevant two-dimensional code display pattern from the sub-COU 206.

When this takes place, the liquid crystal display device 5 serves as a code information display device that shows the two-dimensional code (code information) 92 which is coded based on the model data determined for each model of the pachi-slot gaming machine 1A so that the CCD camera 308 (image capture device) captures the two-dimensional code 92 from outside of the gaming machine 1A (see “5A” in FIG. 20).

In order to provide a display of model data 5A shown in FIG. 20, in particular, a command receiving process routine, shown in FIG. 21, is executed in the third embodiment in operations different from those of the first embodiment. The command receiving process routine of the presently filed embodiment is described below with reference to FIG. 21. Also, as will be understood upon comparison between steps in FIG. 9 (showing the command receiving process routine of the first embodiment) and steps in FIG. 21, the operations in steps S200A to S230A are identical to the operations in steps S200 to S230 in FIG. 9 and, hence, description of the same steps are herein omitted.

With the operation in step S230 A in the third embodiment, if determination is made that no BB setting command is received, the operation is shifted to step S240A. On the contrary, if determination is made that the BB setting command is received, the CPU 206 executes the operation in step S231A to set BB flag. The BB flag is a flag that is set at a start of the BB and cleared at a termination of the BB. Upon executing the operation in step S231A, the operation is shifted to step S240A. Accordingly, in this embodiment, there are no steps (S232 to S234), related to the premium lottery process included in the first embodiment, after RB flag has been set in step S231A in the third embodiment.

In step S230A, if determination is made that no BB setting command is received or if the operation is executed in step S231A, the sub-CPU 206 determines whether or not an RB cancellation command is received (step S240A). If determination is made that the RB cancellation command is received, then, RB flag is cleared (step S241A).

In step S240A, if determination is made that no RB cancellation command is received or if the operation is executed in step S241A, the sub-CPU 206 determines whether or not a BB cancellation command is received (step S250A). If determination is made that no BB cancellation command is received, then, the current sub-routine is completed.

On the contrary, if determination is made that the BB cancellation command is received, the sub-CPU 206 clears BB flag (step S251A). Next, the sub-CPU 206 executes an encoding process that will be described below, thereby coding the URL, serving as model data, into a two-dimensional code 92 (step S252A).

Now, model data is described.

FIG. 22 is a view for illustrating the relationship among model data, model names and premium data. Also, although the lottery figure describes about premium data, no premium data is stored in the program ROM 208.

In a case where the model of the pachi-slot gaming machine 1A is ◯◯◯◯, a URL, serving as model data (model information), is expressed as “http://***.***.003.htm” wherein premium data includes image data for an awaiting image (i.e., a wallpaper to be displayed over a liquid crystal display device of a mobile phone during non-call thereof). Accordingly, by accessing to this URL site, image data for the awaiting image on ◯◯◯ ◯ can be obtained as premium data. Likewise, URLs function as the model data are determined for models of the pachi-slot gaming machines 1A, respectively, and the model data are correlated with premium data, respectively.

Next, the sub-CPU 206 stores the two-dimensional code 92, generated in step S252A, in the work RAM 210 (step S253A). Then, the sub-CPU 206 reads out two-dimensional code display pattern data from the program ROM 208 for supply to the display control circuit 250 (step S254A). Subsequently, the current sub-routine is completed. Thus, the third embodiment features executing the operations, related to model data, in steps S251A to 254A in place step S251 in a manner different from the first embodiment.

FIG. 23 is a flowchart showing a sub-routine for an encoding process to be read out and executed in step S252A of the sub-routine shown in FIG. 22. Also, as will be understood upon comparison between steps of FIG. 11 and steps of FIG. 23, the biggest difference between the encoding process in the first embodiment and the encoding process in the third embodiment resides in a fact that in various steps, a model data URL is set in place of lottery outcome data. Various steps are described below.

First, the sub-CPU 206 sets the URL (see FIG. 22), serving as the model data stored in the program ROM 208, in the work RAM 210 (step S400A). In the lottery figure, there is shown “http://***.***.004.htm” as one example of the URL serving as the model data.

Next, the sub-CPU 206 generates mode identifiers depending on letter types (such as, for instance, numerals, alpha-numerals, Chinese characters, etc.) (step S401A). Subsequently, the sub-CPU 206 generates a letter number identifier depending on the number of letters of model data in the work RAM 210 (step S402A). Then, the sub-CPU 206 executes the operation to cause model data to be binary coded (step S403A). Subsequent steps S404A to 410A are similar to steps S404 to S410 of the first embodiment and, hence, redundant description is herein omitted.

Next, the sub-CPU 206 executes coding word conversion on data resulting from the operation in step S404A (step S405A) and, additionally, generates an error correction coded word based on data resulting from the operation in step S405A to add the same to data resulting from the operation in step S405A (step S406A). Then, the sub-CPU 206 executes the operation to cause data, resulting from the operation in step S406A, to be binary coded into a layout in a matrix form (step S407A). Subsequently, the sub-CPU 206 executes operation to mask data, resulting from the operation in step S407A, with a predetermined pattern (step S408A). The resulting two-dimensional code 92, generated in such a way, is stored in the work RAM 210. Thereafter, the current sub-routine is completed.

While the presently filed embodiment has been described with reference to an exemplary case wherein only the URL, serving as the model data, is encoded (in coding) into the two-dimensional code 92, the present invention may be altered such that the model data and other data (such as, for instance, unique data indicative of the relevant gaming machine for identifying the gaming machine per se) are encoded.

Also, subsequent display control operations are executed in the same operating routine as those shown in FIG. 12 and, hence, description of the display control operations of the presently filed embodiment is herein omitted. Moreover, even with the presently filed embodiment, the mobile phone 300 and the server 200 also have the same structures as those shown in FIGS. 13 and 14 and, hence, redundant description is herein omitted.

Now, the operations to be executed between the mobile phone 300 and a server 200 of the presently filed embodiment are described (see FIG. 24). Also, as will be understood upon comparison between steps in FIG. 24 and steps in FIG. 15 (first embodiment), a difference in the operations between the server 200 and the mobile phone 300 of the presently filed embodiment resides in a fact that operations in steps S503A, S601A, S602A are executed by using in place of using the lottery outcome data. Various steps are described below.

First, the microcomputer 322, equipped by the mobile phone 300, controls the CCD camera 308, serving as the image capture device, based on a command inputted via the operation device 304, causing the CCD camera 308 to capture the two-dimensional code 92 displayed over the liquid crystal display device 5 of the pachi-slot gaming machine 1A (step S500A).

Thereafter, the microcomputer 322 stores image data, obtained in step S500A, in the non-volatile memory 320 (step S501A). Then, the microcomputer 322 executes the two-dimensional code recognizing process (step S502A) to recognize the two-dimensional code 92 from image data, based on image data obtained in step S500A, thereby generating the model data based on the recognized two-dimensional code 92. The two-dimensional code recognizing process is described below.

In step S502A, the microcomputer 322 function as a code information-recognizing device that recognizes the two-dimensional code 92 based on image data, obtained when the CCD camera 308 (image capture device) captures the two-dimensional code (code information) 92 in image, to generate model data based on the recognized two-dimensional code.

Next, the microcomputer 322 allows the radio device 310 and the transmitting and receiving antenna 318 to transmit model data, obtained in the two-dimensional code recognizing operation executed in step S502A, together with ID data of the mobile phone 300, to the server 200 over the Internet (step S503A). In step S503A, the microcomputer 322 function as a model data transmission device that transmits model data, generated in step S502A, to the server 200.

Upon receipt of model data (URL) and ID data of the mobile phone 300 from the mobile phone 300 over the Internet, the CPU 201 equipped in the server 200 stores the model data (URL) and ID data, which are preliminary determined set for the above, in the hard disc drive 205 (step S601A). Then, the CPU 201 extracts data (such as, for instance, HTML data, etc.), indicative of a site associated with the URL serving as the model data received in step S601A, and the premium data, associated with such a site, from the hard disc drive 205 (step S602A). When this takes place, the CPU 201 function as an extraction device that extracts the premium data from the hard disc drive 205 (premium data storage device) based on the model data received from the mobile phone 300. Then, the CPU 201 transmits data indicative of the relevant site and premium data to the mobile phone 300 (step S603A). The CPU 201 function as a premium data transmission device that transmits premium data, extracted in step S602A, to the mobile phone 300.

The microcomputer 322 of the mobile phone 300 stores data (such as data, indicative of the relevant site, and free the gift data), transmitted from the server 200, in the non-volatile memory 320 (step S504A). Thereafter, the microcomputer 322 allows the liquid crystal display device 5 to show the site associated with the URL, serving as the model data, based on the above data stored in the mobile phone 300. Then, upon operation of the operation device 304 to input a predetermined command, the player is able to obtain the premium data.

FIG. 25 is a flowchart showing a two-dimensional code recognition process to be retrieved and executed in step S501A in the process shown in FIG. 24. Even here, a difference in operation between the two-dimensional code recognition process of the first embodiment and that of the presently filed embodiment resides in a fact that the operation in step S705A is executed to generate the model data in place of generating the lottery outcome data. That is, with the presently filed embodiment, the model data is generated based on binary matrix data that is decoded in the operations up to step S704A (step S705A). Thereafter, the current sub-routine is completed and the operation is shifted to step S503A of the flowchart shown in FIG. 15. Also, the operations in steps S700A to S704A are similar to those of steps S700 to S704 of the first embodiment (FIG. 16) and, hence, redundant description is herein omitted.

As set forth above, when the mobile phone 300 transmits the URL, serving as model data, and ID data of the mobile phone 300 to the server 200 (step S503A in FIG. 24), data (such as, for instance, HTML data, etc.), indicative of a site associated with such a URL, and premium data are transmitted from the server 200 to the mobile phone 300 (step S603A in FIG. 24). Also, with such operations, the liquid crystal panel 306 of the mobile phone 300 shows the same image as that of the first embodiment (see FIG. 17).

As set forth above, with the pachi-slot gaming machine 1A and the service providing system 500A of the third embodiment, since the two-dimensional code 92 which is coded based on the model data preliminary determined for each model of the pachi-slot gaming machine 1A, is displayed so that the CCD camera 308 of the mobile phone 300 (see FIGS. 19 and 20) captures the two-dimensional code 92, the player is enabled to capture the two-dimensional code 92 in image with the CCD camera 308 of the mobile phone 300 to allow the mobile phone 300 to transmit model data, generated based on the two-dimensional code 92, to the server 200 whereby premium data, associated with the model of the pachi-slot gaming machine 1A, can be acquired from the server 200 (see FIG. 17). Therefore, a service can be provided with merits on both sides of game arcade and a gaming machine manufacturer in such a way wherein the game arcade have the abilities to pull in more customers due to a capability of displaying the two-dimensional code 92, needed for the premium to be acquired, on the pachi-slot gaming machine 1A (see FIG. 19) whereas the gaming machine manufacturer is able to allow a support and attachment to be provided on the pachi-slot gaming machine 1A of the relevant gaming machine manufacturer in the game arcade. Further, another advantage resides in that such a service can be provided without causing store clerks to suffer from increased troubles and labors. Moreover, providing different premiums depending on models, respectively, (see FIG. 22) provides a capability for the player to enkindle a collection desire for the premiums, resulting in improvement over popularity in an unpopular model. In addition to pleasures in merely acquiring medals, the player can be provided with new pleasures, which are not influenced by regulations, in such a way that music data for Chaku-Melo and image data for the awaiting image can be obtained the as premiums. Thus, even if a drop occurs in gambling spirits of the pachi-slot gaming machine 1A due to the occurrence of strong regulations, the pachi-slot gaming machine 1A is enabled to remain popular, making it possible to prevent the game arcade and the gaming machine manufacturer from suffering losses in profits due to variations in the regulations on the pachi-slot gaming machine 1A.

Further, the mobile phone 300 of the third embodiment corresponds to a mobile device of the present invention. The mobile phone 300 has a capability of picking up the two-dimensional code 92 which is coded based on the model data preliminary determined for each model of the pachi-slot gaming machine 1A and is displayed on the pachi-slot gaming machine 1A. By using the image data, the mobile phone 300 creates the model data, whereafter transmits the model data to the sever 200 whereby the premium data, associated with model data, can be acquired from the server 200 (see FIGS. 24 and 25). Accordingly, a service can be provided with advantages on both sides of the game arcade and the gaming machine manufacturer.

### Fourth Embodiment

Next, a fourth embodiment according to the present invention is described. While the service providing system 500A of the third embodiment includes the mobile phone 300 equipped with the code information recognition device, the service providing system of the fourth embodiment is described with reference to a case wherein the server 200 includes the code information recognition device. Also, the pachi-slot gaming machine 1A, the mobile phone 300 and the server 200, comprising the service providing system of the fourth embodiment, have the same appearances and internal structures as those of the third embodiment, while the pachi-slot gaming machine 1A is executed in the same operations as those of the third embodiment, and description of the same is herein omitted. Additionally, as will be understood upon comparison between FIG. 26 and FIG. 18, a difference between the fourth embodiment and the second embodiment resides in that model data is used in place of lottery outcome data in the operations in steps S612A, S613A. Accordingly, description is herein made of only steps (step S612A, S613A) that are different from those of the first embodiment shown in FIG. 18.

With the fourth embodiment, the CPU 201 allows the model data, resulting upon the execution of the two-dimensional code recognition process in step S611A, to be correlated with ID data of the mobile phone 300 for storage in the hard disc drive 205 (step S612A). Next, the CPU 201 extracts data (such as, for instance, HTML data or the like), indicative of a site with the URL serving as model data, which is obtained in the two-dimensional code recognition operation in step S611A, and the premium data, associated with such a site, from the hard disc drive 205 (step S613A). When this takes place, the CPU 201 function as an extracting device that extracts premium data from the hard disc drive 205 (premium data storage device) based on model data generated by the code information recognition device. Then, the CPU 201 transmits data, indicative of the site, and the premium data to the mobile phone 300 (step S614A). When this takes place, the CPU 201 function as a premium transmission device that transmits the premium data, extracted in step S613A, to the mobile phone 300.

Next, the microcomputer 322 of the mobile phone 300 stores data (data indicative of the site and the premium data), transmitted from the server 200, in the non-volatile memory 320 (step S512). Then, the microcomputer 322 allows the liquid crystal panel 306 to show the site, associated with the URL serving as the model data, based on data set forth above (see FIG. 17). Thus, the player is enabled to obtain the premium data upon operating the operation device 304 to input a predetermined command.

As mentioned above, with the service providing system of the fourth embodiment, the pachi-slot gaming machine 1A displays the two-dimensional code 92 which is coded based on the model data, to allow the player to capture the two-dimensional code 92 in image with the CCD camera 308 of the mobile phone 300 to cause the resulting image data to be transmitted to the server 200 whereby the player is able to obtain premium data from the server 200 depending on a model (model data) of the pachi-slot gaming machine 1A. Therefore, a service can be provided with merits on both sides of game arcade and a gaming machine manufacturer in such a way wherein the game arcade have the abilities to pull in more customers due to a capability of displaying the two-dimensional code 92, needed for the premium to be acquired, on the pachi-slot gaming machine 1A whereas the gaming machine manufacturer is able to allow a support and attachment to be provided on the pachi-slot gaming machine 1A of the relevant gaming machine manufacturer in the game arcade. Further, another advantage resides in that such a service can be provided without causing store clerks to suffer from increased troubles and labors. Moreover, providing different premiums depending on models, respectively, provides a capability for the player to enkindle a collection desire for the premiums, resulting in improvement over popularity in an unpopular model. In addition to pleasures in merely acquiring medals, the player can be provided with new pleasures, which are not influenced by regulations, in such a way that music data for Chaku-Melo and image data for the awaiting image can be obtained as the premiums. Thus, even if a drop occurs in gambling spirits of the pachi-slot gaming machine 1A due to the occurrence of strong regulations, the pachi-slot gaming machine 1A is enabled to remain popular, making it possible to prevent the game arcade and the gaming machine manufacturer from suffering losses in profits due to variations in the regulations on the pachi-slot gaming machine 1A.

Further, the server 200 of the fourth embodiment corresponds to a server of the present invention. The server 200 is operative to receive image data, obtained when the CCD camera 308 of the mobile phone 300 captures the two-dimensional code 92 displayed on the pachi-slot gaming machine 1A, to generate the model data based on the resulting image data whereby the premium data, associated with the model of the pachi-slot gaming machine 1A, can be transmitted to the mobile phone 300. Accordingly, a service can be provided with advantages on both sides of the game arcade and the gaming machine manufacturer.

Although the third and fourth embodiment have been described with reference to examples wherein the premium data includes image data and music data, the present invention is not limited to various modes of the premium as similarly mentioned above with reference to the first and second embodiments.

Also, with the third and fourth embodiments, data to be coded may be possible to contain time-limit information. That is, the gaming machine 1A displays the two-dimensional code 92 which is coded based on the model data and data designating when this model data is generated. In this configuration, the server 200 makes determination, based on date and hour, at which these data are received or generated, and date and hour at which model data is coded into the two-dimensional code 92, as to whether or not a predetermined time period (such as, for instance, one day, one week, etc.) has elapsed. If determination is made that the predetermined time period has elapsed, no premium data is transmitted to the mobile device while data may be transmitted to the mobile device to cause the same to show an image representing the occurrence of expiration in time limit.

Further, with the present invention, it may be preferred that the gaming machine 1A displays the two-dimensional code 92 which is coded based on the model data and data designating when this model data is generated (TOD-data). In this configuration, the server 200 makes determination, based on the model data including the TOD-data and ID data of the mobile device, as to whether or not the premium data associated with the same model data has been already transmitted in the past after which if determination is made that premium data based on the same model data has been already transmitted in the past, no premium data is transmitted to the mobile device. By this configuration, it is possible to prevent premium data from being obtained several times based on the same model data.

### Fifth Embodiment

Now, a fifth embodiment according to the present invention is described. The fifth embodiment has features that payout number data is set in step of “setting lottery outcome data” in step S400 shown in FIG. 11. Other structures of the presently filed embodiment are similar to those of the first embodiment and, hence, duplicated description is herein omitted.

FIG. 27 is a network structural view showing one example of a service providing system of a fifth embodiment. As shown in FIGS. 27 and 28, a pachi-slot gaming machine 1B of the presently filed embodiment is structured such that a payout medal number (as at 5B) is displayed on the liquid crystal display device 5.

That is, with the pachi-slot gaming machine 1B, the liquid crystal display device 5 shows the two-dimensional code 92 which is coded based on the payout number data (i.e., data displayed as “WIN 450: MEDALS” in FIGS. 27 and 28) determined depending on the number of paid-out medals (game media) during play in the BB, when the BB remaining under the special gaming status is terminated. The player is enabled to capture the two-dimensional code 92 in image with the CCD camera 308 of the mobile phone 300.

The mobile phone 300 recognizes the two-dimensional code 92 captured by the CCD camera 308, thereby generating the payout number data based on the recognized two-dimensional code 92. Then, payout number data is transmitted to the server 200.

With the presently filed embodiment, the hard drive disc 205 (not shown and see FIG. 14), equipped by the server 200, stores the premium data (such as, for instance, image data for the awaiting image, music data for Chaku-Melo, etc.) in correspondence to payout number data, determined depending on the number of payout, and the server 200 extracts the premium data based on payout number data received from the mobile phone 300. Then, extracted the premium data is transmitted to the mobile phone 300.

Thus, with the service providing system 500B, the player operates the CCD camera 308, incorporated in the mobile phone 300, to capture the two-dimensional code 92 displayed over the liquid crystal display device 5 of the pachi-slot gaming machine 1B, when the BB is terminated, to enable the mobile phone 300 to obtain payout number data upon which the resulting payout number data is transmitted to the server 200 whereby the player is enabled to acquire the premium data, associated with the relevant payout number, from the server 200.

Moreover, with the presently filed embodiment, other structures of the system are similar to those described above with reference to FIGS. 4 to 6 and, so, description of the same is herein omitted. Besides, even with the presently filed embodiment, the sub-control circuit 82 has the same structure as that shown in FIG. 7 but differs in points described below.

That is, while the presently filed embodiment is described with reference to a case wherein as a point different from the first embodiment, the operation is executed to encode payout number data in place of encoding lottery outcome data, as mentioned below, to generate the two-dimensional code 92, the presently filed embodiment may be implemented in such a way to allow the two-dimensional code to be preliminarily stored in the image data ROM 216 or the like.

Moreover, the program ROM 208 stores the payout number data which is preliminary determined depending on the payout number in the BB under the special gamming status. With the presently filed embodiment, the payout number data includes a URL that is determined depending on the payout number in the BB.

Further, with the presently filed embodiment, the work RAM 210 stores the two-dimensional code 92 which is coded based on the payout number data. In addition, the work RAM 210 stores data indicative of the payout number supplied from the main control circuit 81.

While the presently filed embodiment is described with reference to a case wherein the image data ROM 216 serves to encode payout number data into the two-dimensional code 92, the present invention may be implemented such that the two-dimensional code 92 is preliminarily stored in the image data ROM 216.

The VDP 212 stores various images, extracted from the image data ROM 216 or the work RAM 210, in a buffer (such as, for instance, a video Ram, etc.) in order starting from an image located in a rear area, that is, for instance, in order from a background image, a character image and the two-dimensional code 92, in a superimposed fashion, thereby permitting an image to be synthesized for supply to the D/A converter 218 at a predetermined timing. The D/A converter 218 converts such an image into an image signal, which in turn is supplied to the liquid crystal display device. As a result, the two-dimensional code 92 is displayed over the liquid crystal display device 5 (see FIG. 2). The player is enabled to capture the two-dimensional code 92, displayed over the liquid crystal display device 5, in image with the CCD camera 308 equipped by the mobile phone 300. When this takes place, the liquid crystal display device 5 function as a code information display device that displays the two-dimensional code 92 (code information) which is coded based on the payout number data that is determined depending on the number of payout so that the CCD camera 308 (image capture device) captures the two-dimensional code 92 from outside of the gaming machine 1B.

Furthermore, while the presently filed embodiment is described with reference to an exemplary case wherein the sub-CPU 206 encodes payout number data to generate the two-dimensional code 92, the present invention may be implemented in such away as to store the two-dimensional code 92 in a storage device incorporated by a gaming machine.

Hereunder, it is supposed that the pachi-slot gaming machine 1B is started up and the variables for use in the main CPU 41 are initialized to respective predetermined values and stands in steady operation under a condition where preset values are set to predetermined values, respectively.

Here, a game execution process is implemented in the same sequence as that described with reference to FIG. 8 even in the fifth embodiment and, hence, description related to the game execution process sub-routine is herein omitted.

FIG. 29 is a flowchart showing a sub-routine of a payout number counting process to be executed in the main control circuit. This sub-routine includes interrupt operation to be retrieved and executed at a predetermined cycle when the operations shown in FIG. 8 are executed.

First, the main CPU 41 determines whether or not the winning occurs on the BB (step S170B). This operation includes operation corresponding to the operation in step S143B shown in FIG. 8. If determination is made that the winning occurs on the BB, then, the main CPU 41 sets the payout number for medals, stored in the RAM 43 at a predetermined area thereof, to an initial value of “0” (step S171B).

Next, the main CPU 41 determines whether or not the medals are paid-out (step S172B). This operation represents operation corresponding to the operation in step S139B shown in FIG. 8. If determination is made that the medals are paid-out, then, the main CPU 41 determines whether or not the game stands in the BB (step S173B). Also, the BB starts at the operation of step S144B shown in FIG. 8 and is terminated at the operation of step S150B shown in FIG. 8, and the main CPU 41 determines whether or not the game stands in the BB depending on whether or not a gaming operation is in these steps S144B and S150B.

In step S173B, if determination is made that the game stands in the BB, then, the main CPU 41 executes the operation to count the payout number (step S174B). During such operation, the main CPU 41 adds the number of medals, accumulated or paid-out in the operation in step S139 shown in FIG. 8, to the number of paid-out medals stored in the RAM 43, thereby updating the payout number of medals stored in the RAM 43. For instance, under circumstances where the payout number of medals, already stored in the RAM 43, includes 30 of medals, if the number of medals paid-out in the operation in step S139 shown in FIG. 8 is 15 of medals, then, the main CPU 41 executes the operation in step S174 in a way to update the payout number of medals stored in the RAM 43 to be 45 of medals.

Next, the main CPU 41 determines whether or not the BB is terminated (step S175B). This operation corresponds to the operation in step S149 shown in FIG. 8. If determination is made that the BB is terminated, then, the CPU terminates counting the payout number (step S176B). Thereafter, the current sub-routine is completed. Upon executing the sub-routine shown in FIG. 29, the RAM 43 stores the payout number of medals in the special gaming status. Also, the payout number of medals, stored in the RAM 43, is transmitted to the sub-control circuit 82 at a predetermined timing for storage in the work RAM 210.

While the presently filed embodiment has been described in connection with a case wherein the number of paid-out medals is counted by the main control circuit 81, an alternative may be such that the sub-control circuit 82 is configured in a way to count the number of paid-out medals. The payout number of game media in the present invention includes a number available to be generated based on the payout number of game media. The number, available to be generated based on the payout number of game media, may include, for instance, a difference (so-called differential number of medals) between the number of paid-out game media and the number of inserted game media and a number (so-called payout rate) or the like obtained upon dividing the number of paid-out game media by the number of inserted game media. While the presently filed embodiment has been described in conjunction with a case wherein the number of game media is counted under the special gaming status, the present invention is not limited to such a case. For instance, an alternative may also be configured in a structure so as to count the number of paid-out game media during a predetermined time period and in another alternative, the number of paid-out game media may be counted until the number of inserted game media reaches a predetermined number.

FIG. 30 is a flowchart related to a command receiving process routine to be executed in the presently filed embodiment. Various steps shown in FIG. 30 are similar to those of the third embodiment and, hence, duplicated description is herein omitted.

Now, description is made of payout number data. FIG. 31 is a view showing one example of a payout number data table. The payout number data table is stored in the program RAM 208. Also, the lottery figure describes premium data with a view to representing the correspondence between payout number data and premium data, but no premium data is stored in the program RAM 208.

If the number of paid-out medals for the BB (under the special gaming status) is less than 200, a URL serving as payout number data is expressed as “http://***.***.003.htm” wherein the premium data is absent. In this case, a lottery outcome is loosing and even if this URL is accessed, premium data cannot be obtained.

If the number of paid-out medals for the BB (under the special gaming status) exceeds 200 of medals and is less than 250 of medals, the URL serving as payout number data is expressed as “http://***.***.004.htm” wherein premium data represents “AWAITING IMAGE A”. Accordingly, if this URL is accessed, image data for the “AWAITING IMAGE A” can be obtained as premium data.

If the number of paid-out medals for the BB (under the special gaming status) exceeds 250 of medals and is less than 300 of medals, the URL serving as payout number data is expressed as “http://***.***.005.htm” wherein premium data represents “AWAITING IMAGE B”. Accordingly, if this URL is accessed, image data for the “AWAITING IMAGE B” can be obtained as premium data.

If the number of paid-out medals for the BB (under the special gaming status) exceeds 300 of medals and is less than 350 of medals, the URL serving as payout number data is expressed as “http://***.***.006.htm” wherein premium data represents “MUSIC DATA X”. Accordingly, if this URL is accessed, “MUSIC DATA X” can be obtained as premium data.

If the number of paid-out medals for the BB (under the special gaming status) exceeds 350 of medals and is less than 400 of medals, the URL serving as payout number data is expressed as “http://***.***.007.htm” wherein premium data represents “MUSIC DATA Y”. Accordingly, if this URL is accessed, “MUSIC DATA Y” can be obtained as premium data for Chaku-Melo.

If the number of paid-out medals for the BB (under the special gaming status) exceeds 400 of medals and is less than 450 of medals, the URL serving as payout number data is expressed as “http://***.***.008.htm” wherein premium data represents “MUSIC DATA Z”. Accordingly, if this URL is accessed, image data for the “MUSIC DATA Z” can be obtained as premium data for Chaku-Melo.

In step S252B, the operation is executed referring to payout number data table (see FIG. 31) stored in the program ROM 208 to extract payout number data, determined depending on the relevant payout number, based on the payout number stored in the work RAM 210 upon which resulting payout data is encoded into a two-dimensional code 92.

Next, the CPU 206 stores the two-dimensional code 92, generated in step S252B, in the work RAM 210 (step S253B). Then, the sub-CPU 206 reads out two-dimensional code display pattern data from the program RAM 208 for supply to the display control circuit 250 (step S254B). Thereafter, the current sub-routine is completed.

FIG. 32 is a flowchart showing a sub-routine for a encoding process to be read out and executed in step S252B of the sub-routine shown in FIG. 30. As will be understood upon comparison between the process shown in FIG. 11 and the process shown in FIG. 32, the biggest difference between the encoding process of the first embodiment and the encoding process in the fifth embodiment resides in a fact that step S400B is set with payout number data in place of lottery outcome data. Hereunder, various steps are described.

First, the CPU 206 sets the URL (see FIG. 31), serving as payout number data stored in the program ROM 203, in the work RAM 210 (step S400B). In FIG. 31, “http://***.***.004.htm” is shown as one example of the URL serving as payout number data.

Then, the sub-CPU 206 generates a mode identifier depending on letter types (for instance, numerals, alpha-numerals, Chinese characters, etc.) (step S401B). Subsequently, the sub-CPU 206 generates a letter number identifier depending on the number of letters of payout number data in the work RAM 210 (step S402B). Next, the sub-CPU 206 executes the operation to cause payout number data to be binary coded (step S403B). Thereafter, the sub-CPU 206 executes the operation to add a termination pattern to data resulting from the operations in steps S401B to S403B (step S404B).

Next, the sub-CPU 206 executes coding word conversion on data resulting from the operation in step S404B (step S405B) and, additionally, generates an error correction coded word based on data resulting from the operation in step S405B to add the same to data resulting from the operation in step S405B (step S406B). Then, the sub-CPU 206 executes the operation to cause data, resulting from the operation in step S406B, to be binary coded into a layout in a matrix form (step S407B). Subsequently, the sub-CPU 206 executes operation to mask data, resulting from the operation in step S407B, with a predetermined pattern (step S408B). Then, the operation is executed to add format information involving an error correction level and a mask identifier (step S409B) upon which the two-dimensional code 92 is generated (S410B). The resulting two-dimensional code 92 is stored in the work RAM 210. Thereafter, the current sub-routine is completed.

While the presently filed embodiment has been described with reference to an exemplary case wherein only the URL, serving as payout number data, is encoded (in coding) into the two-dimensional code 92, the present invention may be altered such that payout number data and other data (such as, for instance, the payout number, data indicative of a model of a gaming machine and unique data of the relevant gaming machine for identifying the gaming machine) are encoded.

Also, the sub-routine, related to the display process, of the presently filed embodiment is identical to that of the first embodiment shown in FIG. 12 and, hence, description of the same is herein omitted. With the present invention with the pachi-slot gaming machine 1B, code information may be preferably displayed when the special gaming status is terminated. This is because of the fact that shows code information at time when the player is mostly liable to loose excitement for gaming like at the end of the special gaming status enables interests and concerns on the gaming to be raised again. Further, although the player is hard to capture an image with the CCD camera of the mobile phone 300 even if code information is displayed when the player gets engrossed in gaming, a time at which the special gaming status is ended represents a time at which a chukker occurs on a game and the player is able to reliably capture code information in image without suffering from disturbance in gaming even in the presence of a display of code information. Also, a time at which code information is displayed in the gaming machine 1B is not limited to such a particular example.

Moreover, the mobile phone 300 and the server 200, employed in the presently filed embodiment, have the same structures as those of the first embodiment described with reference to FIGS. 13 and 14 and, hence, description of the same is herein omitted.

FIG. 33 is a flowchart showing a process to be executed by the mobile phone 300 and the server 200 in the presently filed embodiment. The presently filed embodiment differs from the first and third embodiments in that the operations are executed using payout number data in place of the lottery outcome data and the model data in steps S503 (S503A), S601 (S601A), S602 (S602A), S603 (S603A) (steps S503B, S601B, S602B, S603B).

In step S502B in the presently filed embodiment, the microcomputer 322 function as a code information recognition device that recognizes the two-dimensional code 92 from captured image data, obtained when the CCD camera 308 (image capture device) to generate payout number data based on recognized two-dimensional code.

Next, the microcomputer 322 allows the radio device 310 and the transmitting and receiving antenna 318 to transmit payout number data, obtained in the two-dimensional code recognizing operation executed in step S502B, together with ID data of the mobile phone 300, to the server 200 over the Internet (step S503B). In step S503B, the microcomputer 322 function as a payout number data transmission device that transmits payout number data, generated in step S502B, to the server 200.

Upon receipt of payout number data (URL) and ID data of the mobile phone 300 from the mobile phone 300 over the Internet, the CPU 201 of the server 200 stores payout number data (URL) and ID data in the hard disc drive 205 (step S601B).

Then, the CPU 201 extracts data (such as, for instance, HTML data, etc.), indicative of a site associated with the URL serving as payout number data received in step S601B, and premium data associated with such a site from the hard disc drive 205 (step S602B). When this takes place, the CPU 201 function as an extraction device that extracts premium data from the hard disc drive 205 (premium data storage device) based on payout number data received from the mobile phone 300. Then, the CPU 201 transmits data, indicative of the relevant site, and premium data to the mobile phone 300 (step S603B). The CPU 201B function as a premium data transmission device that transmits premium data, extracted in step S602B, to the mobile phone 300.

Also, other steps are similar to those executed in FIGS. 15 and 24 and, so, duplicated description is herein omitted.

FIG. 34 is a flowchart showing a two-dimensional code recognition process, of the presently filed embodiment, to be retrieved and executed in step S502B in the process shown in FIG. 33. As will be understood upon comparison between the process in FIG. 34 and the processes in FIGS. 16 and 25, the two-dimensional code recognition process of the fifth embodiment differs from the processes of the first and third embodiments in that the operation in step S705B is executed for step of generating a payout number data in place of step of generating lottery outcome data (step of generating model data).

More particularly, the two-dimensional code recognition process of the presently filed embodiment features that the operation is executed to create payout number data based on two-dimensional matrix data decoded in step S704B (step S705B). Thereafter, the current sub-routine is completed and the operation is shifted to step S503B of the flowchart shown in FIG. 33. Other steps are similar to those of the first and third embodiments and, hence, description of the same is herein omitted.

As set forth above, when the mobile phone 300 transmits the URL, serving as payout number data, and ID data of the mobile phone 300 to the server 200 (step S503B in FIG. 32), the server 200 transmits data (such as, for instance, HTML data, etc.), indicative of a site associated with such a URL, and premium data to the mobile phone 300 (step S603 in FIG. 33) whereby the liquid crystal display device 5 of the mobile phone 300 shows an image in a manner as shown in FIG. 17. Such operations are similar to those of the first and third embodiments and, so, detailed description of the same is herein omitted.

As set forth above, with the pachi-slot gaming machine 1B and the service providing system 500B of the fifth embodiment, since the two-dimensional code 92 which is coded based the payout number data (5B) determined depending on the number of paid-out medals so that the CCD camera 308 of the mobile phone 300 captures the two-dimensional code 92. Hence, the player is enabled to capture the two-dimensional code 92 in image with the CCD camera 308 of the mobile phone 300 to allow the mobile phone 300 to transmit payout number data, resulting from the two-dimensional code 92, to the server 200 whereby, for instance, the player is enabled to obtain premiums depending on the payout number such that the greater in the payout number, the higher will be the rare music data for Chaku-Melo and image data or the like for the awaiting image to be obtained (see FIGS. 17 and 31). Therefore, a service can be provided with merits on both sides of game arcade and a gaming machine manufacturer in such a way wherein the game arcade have the abilities to pull in more customers due to a capability of displaying the two-dimensional code 92, needed for the premium to be acquired, on the pachi-slot gaming machine 1B whereas the gaming machine manufacturer is able to allow a support and attachment to be provided on the pachi-slot gaming machine 1B of the relevant gaming machine manufacturer in the game arcade. Further, another advantage resides in that such a service can be provided without causing store clerks to suffer from increased troubles and labors. Moreover, providing different premiums depending on the payout number (see FIG. 31) enables the player to have increased competitive spirit, resulting in improvement over interests and concerns on the gaming. In addition to pleasures in merely acquiring medals, the player can be provided with new pleasures, which are not influenced by regulations, in such a way that music data for Chaku-Melo and image data for the awaiting image can be obtained as premiums depending on the payout number. Thus, even if a drop occurs in gambling spirits of the pachi-slot gaming machine 1B due to the occurrence of strong regulations, the pachi-slot gaming machine 1B is enabled to remain popular, making it possible to prevent the game arcade and the gaming machine manufacturer from suffering losses in profits due to variations in the regulations on the pachi-slot gaming machine 1B.

Further, the mobile phone 300 of the fifth embodiment corresponds to a mobile device of the present invention. The mobile phone 300 has a capability of capturing the two-dimensional code 92 which is coded based on payout number data determined depending on the number of paid-out medals and shown on the pachi-slot gaming machine 1B. The mobile phone 300 creates payout number data based on the captured image data and transmits the payout number data to the server 200, whereby player obtains premium data, associated with the payout number data, from the server 200 (see FIGS. 33 and 34). Accordingly, a service can be provided with advantages on both sides of the game arcade and the gaming machine manufacturer.

### Sixth Embodiment

Now, a sixth embodiment according to the present invention is described. A gaming machine according to the sixth embodiment has a structure including the structure of the fifth embodiment that is modified in the same manner as those of the second and fourth embodiments set forth above.

While with the service providing system 500B of the fifth embodiment, the mobile phone 300 has included the code information recognition device, a service providing system of the sixth embodiment is described with reference to an exemplary case wherein the server 200 includes the code information recognition device. Also, the pachi-slot gaming machine 1B, the mobile phone 300 and the server 200, comprising the service providing system of the sixth embodiment, have the same appearances and internal structures as those of the fifth embodiment, while the operations of the pachi-slot gaming machine are executed in the same manner as that of the fifth embodiment, and description of the same is herein omitted with description being herein made of operations to be executed by the mobile phone 300 and the server 200. Hereunder, the same component parts as those of the service providing system of the fifth embodiment bear like reference numerals for description.

FIG. 35 is a flowchart showing a process to be executed between the mobile phone 300 and the server 200 forming the service providing system of the sixth embodiment. First, the microcomputer 322, equipped in the mobile phone 300, drives the CCD camera 308 serving as the image capture device to allow the CCD camera 308 to capture the two-dimensional code 92 displayed over the liquid crystal display device 5 of the pachi-slot gaming machine 1B (step S510B) based on a command inputted via the operation device 304.

Thereafter, the microcomputer 322 accesses a predetermined address (such as, for instance, a URL indicative of a site of a gaming machine manufacture) in the server 200 based on the command applied from the operation device 304, or data indicative of an address that is preliminarily transmitted from the server 200, and allows the radio device 310 and the transmission and receiving antenna 318 to transmit image data, obtained when the CCD camera 308 captures the two-dimensional code 92, together with ID data of the mobile phone 300 to the server 200 over the Internet in concord with a communication standard (such as, for instance, FTP or the like) that is known in the art (step S511B). When this takes place, the microcomputer 322 of the mobile phone 300 function as the image data transmission device that transmits image data, obtained when the CCD camera 308 (image capture device) captures the two-dimensional code 92 (code information) in image, to the server 200.

Upon receipt of image data and ID data of the mobile phone 300 from the mobile phone 300 over the Internet, the CPU 201 of the server 200, stores sent image data and ID data of the mobile phone 300 in the hard disc drive 205 (step S610B). Then, the CPU 201 executes the two-dimensional code recognition process (step S611B) to recognize the two-dimensional code 92 based on captured image data (code information), thereby generating payout number data based on such a recognized two-dimensional code. The two-dimensional code recognition process is executed in the same way as that of the fifth embodiment and has been already described with reference to FIG. 34 and, hence, description of the same is herein omitted. When executing the operation in step S611B, the CPU 201 of the server 200 function as a code information recognition device that recognizes the two-dimensional code 92 based on image data sent from the mobile phone 300 to generate payout number data based on such recognized two-dimensional code.

Next, the CPU 201 causes payout number data, obtained upon executing the two-dimensional code recognition process in step S611B, to be stored in the hard disc drive 205 in correspondence with ID data of the mobile phone 300 (step S612B). Then, the CPU 201 extracts data (such as, for instance, HTML data or the like), indicative of a site with the URL serving as payout number data obtained upon executing the two-dimensional code recognition process in step S611B, and premium data, associated with such a site, from the hard disc drive 205 (step S613B). When this takes place, the CPU 201 function as an extracting device that extracts premium data from the hard disc drive 205 (premium data storage device) based on payout number data generated by the code information recognition device. Then, the CPU 201 transmits data, indicative of the site, and premium data to the mobile phone 300 (step S614B). When this takes place, the CPU 201 function as the premium data transmission device that transmits premium data, extracted in step S613B, to the mobile phone 300.

The microcomputer 322 of the mobile phone 300 stores data (data, indicative of the site, and premium data), transmitted from the server 200, in the non-volatile memory 320 (step S512B). Then, the microcomputer 322 allows the liquid crystal display device 5 to show a site with the URL, serving as payout number data, based on data described above (see FIG. 17). Thus, the player is enabled to acquire premium data by inputting a predetermined command upon operating the operation device 304.

As mentioned above, with the service providing system of the sixth embodiment, the two-dimensional code 92 which is coded based on payout number data determined depending on the payout number of medals is displayed over the pachi-slot gaming machine 1B, by capturing the two-dimensional code 92 with the CCD camera 308 of the mobile phone 300, the mobile device transmits obtained image data to the server 200 whereby the player is able to acquire premium data, depending on payout number, from the server 200. Therefore, a service can be provided with merits on both sides of game arcade and a gaming machine manufacturer in such a way wherein the game arcade have the abilities to pull in more customers due to a capability of displaying the two-dimensional code 92, needed for the premium to be acquired, on the pachi-slot gaming machine 1B whereas the gaming machine manufacturer is able to allow a support and attachment to be provided on the pachi-slot gaming machine 1B of the relevant gaming machine manufacturer in the game arcade. Further, another advantage resides in that such a service can be provided without causing store clerks to suffer from increased troubles and labors. Moreover, providing different premiums depending on the payout number enables the player to have increased competitive spirit, resulting in improvement over interests and concerns on the gaming. In addition to pleasures in merely acquiring medals, the player can be provided with new pleasures, which are not influenced by regulations, in such a way that music data for Chaku-Melo and image data for the awaiting image can be obtained as premiums depending on the payout number. Thus, even if a drop occurs in gambling spirits of the pachi-slot gaming machine 1B due to the occurrence of strong regulations, the pachi-slot gaming machine 1B is enabled to remain popular, making it possible to prevent the game arcade and the gaming machine manufacturer from suffering losses in profits due to variations in the regulations on the pachi-slot gaming machine 1B.

Further, the server 200 of the sixth embodiment corresponds to the server of the present invention. With such a server 200, image data, obtained when the CCD camera 308 of the mobile phone 300 captures the two-dimensional code 92 displayed on the pachi-slot gaming machine 1B, is received from the mobile phone 300 upon which payout number data is generated based on resulting image data and premium data, depending on the payout number, can be transmitted to the mobile phone 300. Thus, a service can be provided with merits on both sides of the game arcade and the gaming machine manufacturer.

While even the fifth and sixth embodiments have been described with reference to an example wherein premium data includes image data and music data, various modes of the premiums may not be particularly limited like the manners as described above with reference to the first and second embodiments.

With the fifth and sixth embodiments, data to be coded may be possible to include time-limit information. That is, a gaming machine displays a two-dimensional code 92 which is coded based on the coding payout number data and data designating when this payout number data is generated. In this configuration, the sever 200 makes determination, based on date and hour, at which these data are received or generated, and date and hour at which payout number data is coded into the two-dimensional code 92, as to whether or not a predetermined time period (such as, for instance, one day, one week, etc.) has elapsed. If determination is made that the predetermined time period has elapsed, no premium data is transmitted to a mobile device while data may be transmitted to the mobile device to cause the same to show an image representing the occurrence of expiration in time limit.

Further, with the present embodiment, it may be preferred that a gaming machine displays a two-dimensional code 92 which is coded based on payout number data and data designating when this payout number data is generated (TOD-data). In this configuration, the server 200 makes determination, based on payout number data including the TOD-data and ID data of the mobile device 300, as to whether or not premium data associated with the same payout number data has been already transmitted in the past after which if determination is made that premium data based on the same payout number data has been already transmitted in the past, no premium data is transmitted to the mobile device. By this configuration, it is possible to prevent premium data from being obtained several times based on the same model data.

### Seventh Embodiment

Now, a seventh embodiment according to the present invention is described. A pachi-slot gaming machine 1C of the presently filed embodiment has the same structure as the pachi-slot gaming machine 1 shown in FIG. 1. Also, a system structure of the presently filed embodiment is similar to the structure shown in FIG. 1 and, so, duplicated description is herein omitted.

To describe an outline of the presently filed embodiment, the presently filed embodiment features that the liquid crystal display device 5 shows code information resulting from coding history data. Detailed description is made below.

With the pachi-slot gaming machine 1C of the presently filed embodiment, the liquid crystal display device 5 shows the two-dimensional code 92 which is coded based on payout number of medals for the BB (one of a special gaming mode) when the BB under is terminated. Further, the two-dimensional code 92 contains data (hereinafter also referred to as URL data) indicative of a coded URL. Moreover, with the presently filed embodiment, the URL represents, for instance, a predetermined address (such as, for instance, a site of a gaming manufacturer) in the server 200. Also, with the presently filed embodiment, data indicative of the payout number of medals for the BB corresponds to history data in the present invention. The player is able to capture the two-dimensional code 92 with the CCD camera 308 incorporated in the mobile phone 300 (see FIG. 3).

Upon recognizing the two-dimensional code 92 based on image data obtained when the CCD camera 308 captures the two-dimensional code 92, the mobile phone 300 generates history data (the payout number of medals being paid-out during the BB) based on such a recognized two-dimensional code. Further, the mobile phone 300 generates URL data based on such a recognized two-dimensional code. Then, the mobile phone 300 accesses a predetermined address in the server 200 based on URL data, mentioned above, and allows history data to be transmitted together with ID data (such as, for instance, an own telephone number and a device identification number, or the like, of the mobile phone 300) to the server 200. Also, the device identification number represents an identifying number that is set for each mobile phone 300 on a process in which mobile phones 300 are manufactured by a manufacturing and marketing manufacturer for the mobile phones 300. Even if the player buy a new model of the mobile phone 300 and replace the new one with old mobile phone, the player's telephone number does not changed, on the contrary, the device identification number of the mobile phone is changed for each alteration in model. Further, while the presently filed embodiment is described with reference to an exemplary case wherein the two-dimensional code 92 which is coded based the history data and URL data is displayed, the present invention is not limited to such an exemplary case and may be implemented in such a way wherein, for instance, URL data is allocated for each history data to allow the two-dimensional data 92, resulting from coding URL data associated with history data. Moreover, an alternative may be such that the two-dimensional code 92, resulting from coding only history data, is displayed.

The server 200 sets a point value depending on history data and the point value is accumulatively added to each ID data for storage in the hard disc drive 205 (see FIG. 14). The server 200 creates list data, indicative of a list (ranking list) in which the point value is ranked for each ID data based on ID data and point value stored in the hard disc drive 205, for transmission to the mobile phone 300.

Thus, the service providing system 500C allows the CCD camera 308 of the mobile phone 300 to capture the two-dimensional code 92, displayed over the liquid crystal display device 5 of the pachi-slot gaming machine 1C when the BB is completed, to enable the mobile phone 300 to obtain history data upon which resulting history data is transmitted together with ID data of the mobile phone 300 to the server 200 to provide a capability of acquiring a ranking list related to the point values based on history data.

Further, while the seventh embodiment is described with reference to an exemplary case wherein data is transmitted and received between the mobile phone 300 and the server 200 over radio communication, the present invention is not limited to such an exemplary case and data may be transmitted and received over a cable. That is, a communication line of the present invention may include radio and cable transmission channels.

With the presently filed embodiment, the sub-CPU 206 reads out history data, stored in the work RAM 210, and URL data, preliminarily stored in the program ROM 208, at a timing when a command, related to the cancellation of the BB, is received from the main control circuit 81, upon which the operation is executed to encode the relevant history data and URL data to generate a two-dimensional code 92 for storage in the work RAM 210. Then, the sub-CPU 206 extracts a two-dimensional code display pattern from the program ROM 208 for transmission to the VDP 212. The two-dimensional code display pattern may include various data, such as a position and time interval in which the two-dimensional code 92 is displayed, for displaying these data. As will be described below, upon receipt of the two-dimensional display pattern, the VDP 212 executes operation to read out the two-dimensional code 92 from the work RAM 210 for display on the liquid crystal display device 5 based on the relevant two-dimensional display pattern. While the presently filed embodiment will be described with reference to a case wherein history data is encoded to generate the two-dimensional code 92, the present invention may be implemented in such a way to preliminarily store the two-dimensional code 92 in the image data ROM 216.

The work RAM 210 has a function to store various flags and variable values in a temporary storage area of the sub-CPU 206. Additionally, the work RAM 210 stores the two-dimensional code 92 which is coded based on history data. Also, while with the presently filed embodiment, the work RAM 210 is employed as the temporary storage area of the sub-CPU 206, the present invention is not limited such an arrangement and may be implemented in an alternative that includes record medium with read/write capabilities.

The image data ROM 216 stores, for instance, background images and character images indicative of characters or the like. While the presently filed embodiment is described with reference to an exemplary case where history data and URL data are encoded into a two-dimensional code 92, the present invention may be arranged to preliminarily store the two-dimensional code 92, associated with history data and URL data, in the image data ROM 216.

The VDP 212 extracts effect images from the image data ROM 216 depending on image display commands supplied from the sub-CPU 206. Further, upon receipt of a two-dimensional code display pattern from the sub-CPU 206, the VDP 212 extracts a two-dimensional code 92 from the work RAM 210 based on the relevant two-dimensional display pattern.

The VDP 212 allows various images, extracted from the image data ROM 216 or the work RAM 210, to be synthesized into an image upon sequentially storing the images starting from an image located in a backside, that is, in an order of a background screen, a character image and the two-dimensional code 92 in the buffer (for instance, the video RAM or the like) in a superimposed fashion, thereby supplying the image to the D/A converter 218 at a predetermined timing. The D/A converter 218 converts the screen image into an image signal, which in turn is supplied to the liquid crystal display device 5. As a result, the two-dimensional code 92 is displayed over the liquid crystal display device 5 (see FIG. 2). The player is enabled to capture the two-dimensional code 92, displayed over the liquid crystal display device 5, in image with the CCD camera 308 equipped in the mobile phone 300. When this takes place, the liquid crystal display device 5 function as a code information display device that displays the two-dimensional code (code information) 92 which is coded based on history data so that the CCD camera 308 (image capture device) captures the two-dimensional code 92.

While the seventh embodiment is described with reference to a case wherein the sub-CPU 206 encodes history data and URL data into the two-dimensional code 92, the present invention may be altered such that the two-dimensional data 92 is stored in a storage device equipped by the gaming machine 1C. In this case, the history data (the number of the game media being paid-out in the special gaming status) is stored in the control RAM 42 (a history data storage device) of the gaming machine 1C (see FIG. 6). Additionally, the history data stored in the control RAM 42 is transferred to the WORK RAM 210 (see FIG. 7) at a predetermined timing. Further, in this embodiment, the history data is not limited to the number of the game media being paid-out in the special gaming state, the history data can be determined based on gaming outcome data that is generated based on an outcome of a gaming during predetermined period. The history data can also be configured to include, for instance, a difference (so-called differential number of medals) between the number of paid-out game media and the number of inserted game media or a number (so-called payout rate) obtained upon dividing the number of paid-out game media by the number of inserted game media.

Hereunder, it is supposed that the pachi-slot gaming machine 1C is started up under conditions wherein the variables, to be sued in the main CPU 41, are initialized to predetermined values and the preset values are set to predetermined values, respectively.

The pachi-slot gaming machine 1C, with such a structure mentioned above, operates on the same game execution process routine as that of the first embodiment and, hence, description of the same is herein omitted. Also, the sub-routine of the payout number count process to be executed in the presently filed embodiment is similar to that shown in FIG. 29 that is referred to in connection with the third embodiment and, so, description of the same is herein omitted. Moreover, with the presently filed embodiment, a command receiving process routine is executed in the same manner as that of the third embodiment (FIG. 21) and, hence, description of the same is herein omitted.

Now, description is made of a sub-routine of an encoding process of the presently filed embodiment with reference to FIG. 36. As will be understood upon comparison between the processes shown in FIG. 36 and FIGS. 11 and 31, the biggest difference between the encoding process in the seventh embodiment and the encoding processes in the first and fifth embodiments resides in the fact that the operation is executed in step S400C to set history data and URL data in place of setting lottery outcome data (model data). Hereunder, various steps are described.

First, the CPU 206 sets the URL data and history data, i.e., data indicative of the payout number of medals for the BB, in the work RAM 210 (step S400C). Then, the sub-CPU 206 generates a mode identifier depending on letter types (for instance, numerals, alpha-numerals, Chinese characters, etc.) associated with URL data and history data (step S401C). Subsequently, the sub-CPU 206 generates a letter number identifier depending on the number of letters of URL data and history data in the work RAM 210 (step S402C). Next, the sub-CPU 206 executes the operation to cause URL data and history data to be binary coded (step S403C). Thereafter, the sub-CPU 206 executes the operation to add a termination pattern to data resulting from the operations in steps S401C to S403C (step S404C).

Next, the sub-CPU 206 executes coding word conversion on data resulting from the operation in step S404C (step S405C) and, additionally, generates an error correction coded word based on data resulting from the operation in step S405C to add the same to data resulting from the operation in step S405C (step S406C). Then, the sub-CPU 206 executes the operation to cause data, resulting from the operation in step S406C, to be binary coded into a layout in a matrix form (step S407C). Subsequently, the sub-CPU 206 executes operation to mask data, resulting from the operation in step S407C, with a predetermined pattern (step S408C). Then, the operation is executed to add format information involving an error correction level and a mask identifier (step S409C) upon which the two-dimensional code 92 is generated (S410C). The resulting two-dimensional code 92 is stored in the work RAM 210. Thereafter, the current sub-routine is completed.

While the presently filed embodiment has been described with reference to an exemplary case wherein the URL data and history data, i.e., data indicative of the payout number of medals for the BB are encoded (coded) into the two-dimensional code 92, the present invention may be implemented in such a way to perform the encoding including other data (such as, for instance, data indicative of a name or designation of a player and a model of a gaming machine, unique data of the relevant gaming machine to allow the gaming machine per se to be identified, etc.).

Even with the presently filed embodiment, the mobile phone 300 has the same structure as that of the first embodiment and, therefore, description of a structure of the mobile phone 300 is herein omitted (see FIG. 13). Also, with the seventh embodiment, the microcomputer 322 of the mobile phone 300 downloads a predetermined program from the server 200 over the Internet for storage in the non-volatile memory 320 based on a predetermined command inputted via the operation device 304. Then, the microcomputer 322 reads out and executes the above-described program from the non-volatile memory 320, providing functions (A) and (B) as described below.

(A) The microcomputer 322 recognizes the two-dimensional code 92 which is captured with the CCD camera 308, and generates history data based on the recognized two-dimensional code 92. When this takes, the microcomputer 322 function as a code information recognition device.

(B) The microcomputer 322 allows the radio device 310 and the transmission and receiving antenna 318 to transmit history data, generated in the process (A) set forth above, together with unique data (such as, for instance, an own telephone number or the like of the mobile phone 300) of the mobile phone 300, to the server 200 over the Internet based on the URL set forth above. When this takes place, the microcomputer 322 function as a history data transmission device.

While the presently filed embodiment is described with reference to a case wherein the mobile phone 300 downloads the programs from the server 200, an alternative may be such that the programs are preliminarily stored (preinstalled) in the non-volatile memory 322 of the mobile phone 300.

Also, the server 200 of the presently filed embodiment has the same structure as that of the first embodiment shown in FIG. 14 and, hence, detailed description related to such a structure is herein omitted.

The hard disc drive 205 of the server 200 stores a point value conversion table (see FIG. 38) to convert history data into a point value. Upon receipt of history data from the mobile phone 300, the CPU 201 sets a point value based on relevant history data by referring to the point value conversion table mentioned above.

The hard disc drive 205 stores a point value for each unique ID data of the mobile phone 300 (see FIGS. 39A and 39B). The hard disc drive 205 function as a point value storage device that stores the point value for each ID data of the mobile phone 300. While the presently filed embodiment is described with reference to an exemplary case wherein the point value is stored for each ID data of the mobile phone 300, the present invention may be implemented in a way to allow the point value to be stored for each player identifying information for identifying a player. Upon setting the point value based on history data, the CPU 201 accumulatively adds the relevant point value to the point values stored in the hard disc drive 205, thereby updating the point values. When this takes place, the CPU 201 function as a point updating device. Then, the CPU 201 creates list data, indicative of a ranking list, based on ID data and point values stored in the hard disc drive 205. When this takes place, the CPU 201 function as a list data generating device.

Consecutively, the CPU 201 allows the communication interface circuit 204 to transmit the relevant list data to the mobile phone 300 via the Internet. When this takes place, the CPU 201 function as a list data transmission device. As a result, the liquid crystal display panel 306 of the mobile phone 300 is provided with a display of the ranking list (see FIGS. 41A and 41B).

Further, the hard disc drive 205 stores programs to be down loaded to the mobile phone 300. Upon receipt of a signal requesting to down load the programs from the mobile phone 300, the CPU 201 reads out the programs from the hard disc drive 205 and transmits the programs to the mobile phone 300 from the communication interface circuit 204 over the Internet.

FIG. 37 is a flowchart showing a process to be executed between the mobile phone 300 and the server 200. First, the microcomputer 322, equipped in the mobile phone 300, drives the CCD camera 308 serving as the image capture device to allow the CCD camera 308 to capture the two-dimensional code 92 contained in the screen image displayed over the liquid crystal display device 5 of the pachi-slot gaming machine 1C based on a command inputted via the operation device 304 (step S500C).

Subsequently, the microcomputer 322 stores image data, obtained in step S500C, in the non-volatile memory 320 (step S501C). Next, the microcomputer 322 executes the two-dimensional code recognition process (step S502C) and recognize the two-dimensional code 92 based on image data obtained in step S500C, thereby generating history data and URL data based on based on such a recognized two-dimensional code. The two-dimensional code recognition process is described below in detail.

In step S502C, the microcomputer 322 function as a code information recognition device that recognizes the two-dimensional code 92 based on image data obtained when the CCD camera 308 (image capture device) captures the two-dimensional code (code information) 92 and generates history data based on such a recognized two-dimensional code.

Next, the microcomputer 322 allows the radio device 310 and transmission and receiving antenna 318 to transmit history data, obtained in the two-dimensional recognition process executed in step S502C, and unique ID data (such as, for instance, the own telephone number of the mobile phone 300, the device identification number of the mobile phone 300, etc.) of the mobile phone 300 to the server 200 over the Internet based on URL data obtained in the two-dimensional recognition process (step S503C). In step S503C, the microcomputer 322 function as a history data transmission device that transmits history data, generated in step S502C, to the server 200. While the presently filed embodiment is described with reference to an exemplary case wherein history data is transmitted together with unique ID data of the mobile phone 300 to the server 200, the present invention may be implemented in such a way wherein history data is transmitted together with player identification information to the server 200.

Upon receipt of history data and unique ID data of the mobile phone 300 from the mobile phone 300 over the Internet, the CPU 201 equipped in the server 200 sets a point value by referring to a point value conversion table, which is preliminarily stored in the hard drive disc 205, based on history data set forth above (step S601C).

FIG. 38 is a view showing one example of the point value conversion table. With the point value conversion table, payout numbers of medals being paid-out during the BB are correlated with the point values. In particular, a point value of “0” is allocated to the payout number of “0 to 200”. A point value “1” is allocated to the payout number of “201 to 250”. A point value “2” is allocated to the payout number of “251 to 300”. A point value “4” is allocated to the payout number of “301 to 350”. A point value of “6” is allocated to the payout number of “351 to 400”. A point value of “10” is allocated to the payout number of “401 to 450”.

Accordingly, if data indicative of the payout number “450” of medals for the BB is received from the mobile phone 300 as history data, the CPU 201 executes the operation in step S601C to set a point value of “10” by referring to the point value conversion table (see FIG. 38) stored in the hard disc drive 205.

Next, the CPU 201 of the sever 200 updates the point value in an accumulative point value table, stored in the hard disc drive 205 (point value storage device), based on the point value, set in step S601C, and ID data received from the mobile phone 300 (step S602C). When executing the operation in step S602C, the CPU 201 function as a point value updating device.

FIG. 39A is a view showing one example of the accumulative point value table. With the accumulative point value table, names of players and associated accumulative points are allocated to ID data of the mobile phone 300. ID data of the mobile phone 300 represents an own telephone number. The names of the players indicate names or designations of the players, respectively. The name of the player can be arbitrarily set upon inputting a predetermined command via the operation device 304 of the mobile phone 300. A ranking list has no display of ID data per se of the mobile phone 300 and is provided with a display of a name of a player associated with the relevant ID data (see FIGS. 41A and 41B). The accumulative point value represents a point value resulting from the operations in steps S601C and 602C executed several times for each ID data.

Accordingly, if a mobile phone 300 of a player named “AAA” is operated to transmit data, indicative of the payout number of “450” of medals being paid-out during the BB, as history data, then, the CPU 201 sets the point value of “10” and executes the operation in step S602C to allow the point value of “10” to be added to the accumulative point value of “500”, stored in the hard disc drive 205, thereby updating the accumulative point value, stored in the hard disc drive 205, to a point value of “510”.

While the accumulative point value table, shown in FIG. 39A, represents an accumulative point value table for a case wherein a point value is accumulatively added for each ID data regardless of the pachi-slot gaming machine 1C, the presently filed embodiment may be altered such that the point value is accumulatively added for each ID data and model of the pachi-slot gaming machine 1C.

FIG. 39B is a view showing another example of the accumulative point value table. With the accumulative point value table, the names of the players and associated accumulative point values are allocated for ID data of the mobile phones 300 and the models of the pachi-slot gaming machines 1C, respectively. Thus, the accumulative point value of ID data “090-4567-****” (ID data “DDD”) is individually stored for each model in such a way that an accumulative point value of a model “◯◯◯◯” lies at a value of “150” and an accumulative point value of a model “XXXX” lies at a value of “50”.

With the present invention, s shown in FIG. 39B, the point value storage device (hard disc drive 205) may be preferably arranged to store the point value for unique ID data of the mobile phone 300 and each model of the gaming machine. This is because the list data, indicative of a ranking list for each model of a gaming machine, is generated to make it possible to transmit resulting list data to a mobile device whereby a player is enabled to figure out own gaming skills more in detail. Of course, the present invention is not limited to such an example and may be implemented in a way to store the point value for each ID data regardless of the model of the gaming machine as shown in FIG. 39A. In an event that the point value storage device (hard disc drive 205) is configured to store a point value for each unique ID data of a mobile device and model of a gaming machine as shown in FIG. 39B, the code information display device 5, equipped by the gaming machine 1C, may be configured in a way to display a two-dimensional code 92 resulting from coding data indicative of history data and model of the gaming machine.

Further, while the presently filed embodiment is described with reference to an exemplary case (see FIGS. 39A, 39B) wherein the point value is stored for each unique ID of the mobile phone 300 (such as, for instance, own telephone number, etc., of the mobile phone 300), an alternative may be such that the point values are stored in allocation to the names of the payers, respectively. In such a case, the name of the player corresponds to player identifying information by which a particular player is identified. With the present invention, player identifying information is not particularly limited and may include, for instance, a designation or name that are inputted when the mobile device is operated by the player. Moreover, player identifying information may be inputted upon operation of the mobile device executed by the player. Under circumstances where an arrangement is made to allow the point value to be stored for each player identifying information, even if the player changes the mobile phone 300 and uses another mobile device, inputting identical player identifying information allows a new point value to be added to the point value already stored in the point value storage device, providing a capability for a service providing system to ensure a continuity in ranking.

Upon executing the operation in step S602C, the CPU 201 generates list data, indicative of a ranking list, based on the point value stored in the hard disc drive 205 and unique ID is data of the mobile phone 300 (step S603C). Also, the ranking list will be described later. When executing the operation in step S603C, the CPU 201 function as a list data preparation device.

Next, the CPU 201 allows the communication interface circuit 204 to transmit list data, generated in step S603C, to the mobile phone 300 over the Internet (step S604C). When this takes place, the CPU 201 function as a list data transmission device.

Upon receipt of list data from the server 200, the microcomputer 322 of the mobile phone 300 allows the liquid crystal display panel 306 to show the ranking list based on relevant list data (step S504C). Also, the ranking list will be described later in detail.

FIG. 40 is a flowchart showing a two-dimensional code recognition process to be read out and executed in the operation in step S502C shown in FIG. 37. Also, as will be understood upon comparison between the process shown in FIG. 16 and the process shown in FIG. 40, the two-dimensional code recognition process in the presently filed embodiment features that the operation is executed in step S 705C to generate history data and URL data in place of generating lottery outcome data. Such a process is described below in detail.

First, the microcomputer 322 executes an image conversion process on image data stored in the non-volatile memory 320 (step S700C). The image conversion process includes step of extracting image data, in an area displayed with the two-dimensional code 92, from image data obtained when captured, step of correcting an inclination and distortion of image data and step of converting image data into a monoclonal image with a predetermined threshold value to obtain image data involving the two-dimensional code 92.

Next, the microcomputer 322 extracts the two-dimensional code 92 from image data obtained in step S700C to execute corrections such as removing noise, etc., (step S701C). Subsequently, the microcomputer 322 executes binary-coding operation on the two-dimensional code 92 obtained in step S701C to cause respective dots, forming the two-dimensional code 92, to be substituted into “0” or “1” (step S702C) for thereby generating binary-coded matrix data (step S703C). Then, the microcomputer 322 decodes binary-coded matrix data (step S704C), thereby generating history data and URL data (step S705C). Thereafter, the current sub-routine is completed and the operation is shifted to step S503C in the flowchart shown in FIG. 37.

As set forth above, upon operation of the mobile phone 300 to transmit history data, together with unique ID data of the mobile phone 300, to the server 200 based on URL data (step S503C in FIG. 37), the server 200 generates list data for transmission to the mobile phone 300 (steps S603C and 604C in FIG. 37). As a result, the liquid crystal panel 306 of the mobile phone 300 shows a ranking list as shown in FIGS. 41A and 41B.

FIG. 41A is a view typically showing one example of the ranking list. Provided in the liquid crystal panel 306 at a central area thereof is a display of the ranking list in which names of players and point values are ranked in order of descending point values. This ranking list is provided in display due to list data that is generated by the server 200 based on the accumulative point value table shown in FIG. 39A.

FIG. 41B is a view typically showing another example of the ranking list. Provided in the liquid crystal panel 306 at a central area thereof is a display of the ranking list in which names of players and point values are ranked in order of descending point values in respect of a model “◯◯◯◯”. This ranking list is displayed in accordance with the list data that is generated by the server 200 based on the accumulative point value table shown in FIG. 39B. While modes in FIGS. 41A and 41B show the names of the players in place of ID data, the present invention may also be implemented in such a way to display predetermined data, associated with ID data, in the ranking list.

As mentioned above, with the service providing system 500 and the pachi-slot gaming machine 1C of the seventh embodiment, the two-dimensional code 92 which is coded based on history data (i.e., data indicative of the payout number of medals in the BB) so that the CCD camera 308 of the mobile phone 300 (see FIG. 2) and, for instance, the player is enabled to capture the two-dimensional code 92 with the CCD camera 308 of the mobile phone 300 in image to cause history data, resulting from the captured two-dimensional code 92, to be transmitted from the mobile phone 300 to the server 200. And the server 200 transmits list data, indicative of the ranking lists (see FIGS. 41A and 41B) to the mobile phone 300. This results in a capability for the player to confirm a content of the ranking list on the mobile phone 300 to confirm own gaming skills. Accordingly, a service can be provided with merits on both sides of game arcade and a gaming machine manufacturer in such a way that the game arcade have the abilities to pull in more customers due to an ability of the pachi-slot gaming machine 1C for displaying the two-dimensional code 92 needed for obtaining the ranking list whereas the gaming machine manufacturer is able to provide the game arcade with a support and attachment for the pachi-slot gaming machine 1C manufactured by the relevant gaming machine manufacturer due to the presence of the ranking list available for the players to be mutually motivated to have increased competitive spirits upon comparison among the players in a gaming level for the pachi-slot gaming machine 1C. Further, another advantage resides in that such a service can be provided without causing store clerks to have increased troubles and labors. In addition to the pleasures in merely acquiring medals, the players can be provided with new pleasures with no influence from regulations under which the players make their efforts to get involved in higher ranks in the ranking list or makes competitions in the gaming levels. Thus, even when a drop occurs in gambling spirits of the pachi-slot gaming machine 1C in the presence of strong regulations, it becomes possible for the pachi-slot gaming machine 1C to remain popular, making it possible to prevent the game arcade and the gaming machine manufacturer from suffering losses in profits due to variations in the regulations for the pachi-slot gaming machine 1C.

Further, the mobile phone 300 of the seventh embodiment corresponds to the mobile device of the present invention. With such a mobile phone 300, the player is enabled to capture the two-dimensional code 92 which is coded based on history data (data indicative of payout number of medals being paid-out during the BB) and shown on the display device 5 of the pachi-slot gaming machine 1C, and the mobile phone 300 decoded the history data being coded in the captured image data (two-dimensional data 92) whereby transmitting the decoded history data to the sever 200. By these process, the sever 200 transmits list data, indicative of the ranking list, to the mobile phone 300 (see FIGS. 41A and 41B). Accordingly, a service can be provided with merits on both sides of the game arcade and the gaming machine manufacturer in such a way that the game arcade have the abilities to pull in more customers due to the presence of the two-dimensional code 92 displayed by the pachi-slot gaming machine 1C and the players can be motivated to have increased competitive spirits upon mutually comparing the respective gaming levels of the pachi-slot gaming machine 1C. In addition to the pleasures in merely acquiring medals, the players can be provided with new pleasures with no influence from regulations under which the players make their efforts to get involved in higher ranks in the ranking list or makes competitions in the gaming levels. Thus, even when a drop occurs in gambling spirits of the pachi-slot gaming machine 1C in the presence of strong regulations, the pachi-slot gaming machine 1C is enabled to remain popular, making it possible to prevent the game arcade and the gaming machine manufacturer from suffering losses in profits due to variations in the regulations for the pachi-slot gaming machine 1C.

### Eighth Embodiment

While with the service providing system 500C of the eighth embodiment, the mobile phone 300 has been described as including the code information recognition device, the service providing system of the eighth embodiment is described with reference to a case wherein the server 200 includes the code information recognition device. Also, appearances and internal structures of the pachi-slot gaming machine, the mobile phone 300 and the server 200, comprising the service providing system of the eighth embodiment, and the processes to be executed in the pachi-slot gaming machine, which are identical to those of the seventh embodiment, are herein omitted in description and description is made of only processes to be executed by the mobile phone 300 and the server 200. Hereunder, description is made with the same component parts as those of the service providing system of the seventh embodiment bearing like reference numerals.

FIG. 42 is a flowchart showing a process to be executed between the mobile phone 300 and the server 200 by which the service providing system of the eighth embodiment is formed. First, the microcomputer 322, equipped by the mobile phone 300, drives the CCD camera 308, serving as the image capture device, based on a command inputted via the operation device 304, causing the CCD camera 308 to capture the two-dimensional code 92 displayed over the liquid crystal display device 5 of the pachi-slot gaming machine 1C (step S510C).

Thereafter, the microcomputer 322 accesses a predetermined address (such as, for instance, the URL indicative of a site of the gaming machine manufacture) inside the server 200, based on the command inputted via the operation device 304 or data indicative of an address preliminarily transmitted from the server 200, and operates the radio device 310 and the transmission and receiving antenna 318 to cause image data, obtained by the CCD camera 308 when the two-dimensional code 92 is captured, to be transmitted together with ID data of the mobile phone 300 to the server 200 over the Internet under a communication standard (such as, for instance, FTP or the like) that is known in the art (step S511C). When this takes place, the microcomputer 322 of the mobile phone 300 function as an image data transmission device that transmits image data, obtained when the CCD camera 308 (image capture device) captures the two-dimensional code (code information) 92 in image, to the server 200. While the presently filed embodiment is described with reference to an exemplary case wherein image data is transmitted together with unique data of the mobile phone 300 to the server 200, the present invention may be implemented in such a way to allow image data to be transmitted together with player identifying information.

Upon receipt of image data and ID data of the mobile phone 300 from the mobile phone 300 over the Internet, the CPU 201, incorporated in the server 200, stores the image data and ID data, set forth above, in the hard disc drive 205 (step S610C). While the presently filed embodiment is described with reference to an exemplary case wherein image data is stored in the hard disc drive 205 for each ID data, the present invention may be configured such that if image data is received together with player identifying information from the mobile device, such image data is stored for each player identifying information. Then, the CPU 201 executes the two-dimensional code recognition process (step S611C) to recognize the two-dimensional code 92 based on image data, obtained when the CCD camera 308 (image capture device) of the mobile phone 300 captures the image, thereby generating history data based on such recognized two-dimensional code 92. The two-dimensional code recognition process is executed in the same way as that of the first embodiment and has been already described with reference to FIG. 39 and, hence, description of the same is herein omitted. When executing the operation in step S611C, the CPU 201 of the server 200 function as a code information recognition device that recognizes the two-dimensional code 92 based on image data received from the mobile phone 300 to generate history data based on such recognized two-dimensional code 92.

Next, the CPU 201 sets a point value by referring to the point value table (see FIG. 38), which is preliminarily stored in the hard disc drive 205, based on history data obtained in executing the two-dimensional code recognition process in step S611C (step S612C). Then, the CPU 201 updates the point value in the accumulative point value table (see FIG. 39), stored in the hard drive disc drive 205, based on the point value set in step S612C, and ID data received from the mobile phone 300 (step S613C). While the presently filed embodiment is described with reference to an exemplary case wherein the point value is stored for each ID data, the present invention may take an alternative wherein the point value is stored for each player identifying information. Then, the CPU 201 generates a list data, indicative of a ranking list, based on the point value, stored in the hard drive disc 205, and unique ID data of the mobile phone 300 (step SS614C), while allowing the communication interface circuit 204 to transmit the list data to the mobile phone 300 over the Internet (step S615C). Upon receipt of the list data from the server 200, the microcomputer 322 of the mobile phone 300, the liquid crystal panel 306 shows the ranking list based on the relevant list data (step S512C). As a result, the ranking list comes to be displayed over the liquid crystal panel 306 of the mobile phone 300 as shown in FIGS. 41A and 41B.

As mentioned above, with the service providing system of the eighth embodiment, the two-dimensional code 92 which is coded based on the history data (data indicative of the payout number of medals in the BB) and is displayed over the pachi-slot gaming machine 1C to enable the player to capture the two-dimensional code 92 with the CCD camera 308 of the mobile phone 300 in image to cause the resulting image data to be transmitted to the server 200 whereby the list data, indicative of the ranking list (see FIGS. 41A and 41B), is transmitted from the server 200 to the mobile phone 300. By this configuration, the player to confirm the content of the ranking list over the mobile phone 300 for thereby confirming own gaming skills. Accordingly, a service can be provided with merits on both sides of game arcade and a gaming machine manufacturer in such a way that the game arcade have the abilities to pull in more customers due to an ability of the pachi-slot gaming machine 1C for displaying the two-dimensional code 92 needed for obtaining the ranking list whereas the gaming machine manufacturer is able to provide the game arcade with a support and attachment for the pachi-slot gaming machine 1C manufactured by the relevant gaming machine manufacturer due to the presence of the ranking list available for the players to be mutually motivated to have increased competitive spirits upon comparison among the players in a gaming level on the pachi-slot gaming machine 1C. Further, another advantage resides in that such a service can be provided without causing store clerks to have increased troubles and labors. In addition to the pleasures in merely acquiring medals, the players can be provided with new pleasures with no influence from regulations under which the players make their efforts to get involved in higher ranks in the ranking list or makes competitions in the gaming levels. Thus, even when a drop occurs in gambling spirits of the pachi-slot gaming machine 1C in the presence of strong regulations, the pachi-slot gaming machine 1C is enabled to remain popular, making it possible to prevent the game arcade and the gaming machine manufacturer from suffering losses in profits due to variations in the regulations for the pachi-slot gaming machine 1C.

Further, the server 200 of the eighth embodiment corresponds to the server of the present invention. The server 200 is enabled to receives image data, obtained when the CCD camera 308 of the mobile phone 300 captures the two-dimensional code 92 in image from the pachi-slot gaming machine 1C, from the mobile phone 300 to generate list data, indicative of the ranking list with the point values being ranked for respective ID data, based on history data for transmission to the mobile phone 300. Accordingly, a service can be provided with merits on both sides of the game arcade and the gaming machine manufacturer.

With the present invention, data to be coded may be possible to include time-limit information. That is, a gaming machine displays a two-dimensional code 92 which is coded based on the history data and data designating when this history data is generated. In this configuration, the sever 200 makes determination, based on date and hour, at which these data are received or generated, and date and hour at which history data is coded into the two-dimensional code 92, as to whether or not a predetermined time period (such as, for instance, one day, one week, etc.) has elapsed. If determination is made that the predetermined time period has elapsed, no premium data is transmitted to the mobile device while data may be transmitted to the mobile device to cause the same to show an image representing the occurrence of expiration in time limit.

Further, with the present embodiment, it may be preferred that a gaming machine 1C displays the two-dimensional code 92 which is coded based on the history data and data designating when this history data is generated (TOD-data). In this configuration, the server 200 makes determination, based on history data including the TOD-data and ID data of the mobile device, as to whether or not the same history data is received in the past upon which if determination is made that the same history data is received, no point value is set based on relevant history data. By this configuration, it is possible to preclude the point values from being set several times based on the same history data.

Further, while the above presently filed embodiment has been described in conjunction with a case wherein the server 200 creates the list data, indicative of the list ranked with the point values for respective ID data based on history data, the present invention may be altered in a configuration wherein the server creates a list data indicative of a list in which history data per se are ranked for respective ID data.

In the foregoing, while various embodiments have been discussed above, these embodiments are meant to be merely as illustrative of concrete examples and not limiting to the present invention. Thus, various modifications and changes may be suitably made to concrete structures of various component parts. Further, the advantageous effects described with reference to the various embodiments are meant to be merely as illustrative of the most favorable effects resulting form the present invention and the advantageous effects of the present invention are not limited to those described in conjunction with the various embodiments of the present invention.

According to the present invention, a service can be provided with advantages on both sides of game arcade and a gaming machine manufacturer to allow players to have supports and attachments on a gaming machine marketed by the gaming machine manufacturer while, additionally, precluding the game arcade and gaming machine manufacturer from suffering adverse affects in earnings caused by variations in regulations for the gaming machines.

Further, according to the present invention, it is possible to combine above described various embodiments.

Further, in the foregoing, while various embodiments have been discussed above, these embodiments are meant to be merely as illustrative of concrete examples and not limiting to the present invention and various modifications and changes may be suitably made to concrete structures of various component parts. Further, the advantageous effects described with reference to the various embodiments are meant to be merely as illustrative of the most favorable effects resulting form the present invention and the advantageous effects of the present invention are not limited to those described in conjunction with the various embodiments of the present invention.

Although the invention has been described above by reference to certain embodiments of the present invention, the invention is not limited to the embodiments described above and modifications will occur to those skilled in the art, in light of the teachings. The scope of the invention is defined with reference to the following claims.

What is claimed is:

1. A gaming machine comprising:
a lottery device executing a lottery for determining whether to afford premium to a player; and
a code information display device displaying code information which is generated based on coded lottery outcome data related to an outcome of the lottery executed by the lottery device so that an image capture device captures the code information from an outside of the gaming machine.

2. The gaming machine according to claim 1, further comprising:
a variable display device providing a variably display of a plurality of symbols;
a variable display stop device stopping the variable display of the symbols; and
a special gaming status shift device shifting an operation to a special gaming status to be advantageous for a player when the symbols are stopped in a predetermined winning combination;
wherein the code information display device displays the code information when the special gaming status is terminated.

3. A service providing system comprising:
a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine;
a mobile device equipped with the image capture device; and
a server operative to transmit data to and receive the same from the mobile device via a network, wherein
the mobile device further includes:
an image data transmission device transmitting image data, obtained when the image capture device captures the code information, to the server;
the server further includes:
a premium data storage device storing the premium data to be transmitted to the mobile device;
a code information recognition device recognizing the code information based on the image data received from the mobile device and generating the lottery outcome data based on the recognized code information;
an extraction device extracting the premium data from the premium data storage device based on the lottery outcome data generated by the code information recognition device; and
a premium data transmission device by which the premium data, extracted by the extraction device, is transmitted to the mobile device.

4. A service providing system comprising:
a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine;
a mobile device equipped with the image capture device; and
a server operative to transmit data to and receive the same from the mobile device via a network, wherein
the mobile device further includes;
a code information recognition device which recognizes the code information based on image data obtained when the image capture device captures the code information and the code information recognition device generating the lottery outcome data based on the recognized code information; and
a lottery outcome data transmission device that transmits the lottery outcome data, generated by the code information recognition device, to the server;
and wherein the server includes:
a premium data storage device storing the premium data to be transmitted to the mobile device;
an extraction device extracting the premium data from the premium data storage device based on the lottery outcome data received from the mobile device; and
a premium data transmission device transmitting the premium data, extracted by the extraction device, to the mobile device.

5. A server to be used in a service providing system comprising a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine; a mobile device equipped with the image capture device, wherein
the server operative to transmit data to and receive the same from the mobile device via a network and includes
a premium data storage device storing the premium data to be transmitted to the mobile device;
a code information recognition device recognizing the code information based on image data received from the mobile device and generating the lottery outcome data based on the recognized code information;
an extraction device extracting the premium data from the premium data storage device based on the lottery outcome data generated by the code information recognition device; and
a premium data transmission device by which the premium data, extracted by the extraction device, is transmitted to the mobile device.

6. A mobile device to be used in a service providing system comprising a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine; and a server operative to transmit data to and receive the same from the mobile device via a network, wherein
the mobile device equipped with the image capture device and includes a code information recognition device which recognizes the code information based on image data obtained when the image capture device captures the code information and generates the lottery outcome data based on the recognized code information; and
a lottery outcome data transmission device transmitting the lottery outcome data, generated by the code information recognition device, to the mobile device.

7. A gaming machine comprising:
a code information display device displaying code information which is coded based on model information uniquely numbered for each model of the gaming machine so that an image capture device captures the code information from an outside of the gaming machine.

8. The gaming machine according to claim 7, further comprising:
a variable display device providing a variable display of a plurality of symbols;
a variable display stop device stopping the variable display of the symbols; and
a special gaming status shift device shifting an operation to a special gaming status to be advantageous for a player when the symbols are stopped in a predetermined winning combination, wherein
the code information display device displays the code information when the special gaming status is started or the special gaming status is terminated.

9. A service providing system comprising:
a gaming machine including a code information display device displaying code information which is coded based on model information uniquely numbered for each model of the gaming machine so that an image capture device captures the code information from an outside of the gaming machine;
a mobile device equipped with the image capture device; and
a server operative to transmit data to and receive the same from the mobile device via a network, wherein
the mobile device further includes:
an image data transmission device transmitting image data, obtained when the image capture device captures the code information, to the server;
the server further includes:
a premium data storage device storing premium data to be transmitted to the mobile device in association with the model information uniquely numbered for each model of the gaming machine;
a code information recognition device recognizing the code information based on the image data received from the mobile device and generating the model data based on the recognized code information;
an extraction device extracting the premium data from the premium data storage device based on the model information generated by the code information recognition device; and
a premium data transmission device by which the premium data, extracted by the extraction device, is transmitted to the mobile device.

10. A service providing system comprising:
a gaming machine including a code information display device displaying code information which is coded based on model information uniquely numbered for each model of the gaming machine so that an image capture device captures the code information from an outside of the gaming machine;
a mobile device equipped with the image capture device; and
a server operative to transmit data to and receive the same from the mobile device via a network, wherein
the mobile device further includes:
a code information recognition device recognizing the code information based on image data obtained when the image capture device captures the code information and generating the model information based on the recognized code information; and
a model information transmission device that transmits the model information, generated by the code information recognition device, to the server;
and wherein the server further includes:
a premium data storage device storing premium data to be transmitted to the mobile device in association with the model information uniquely numbered for each model of the gaming machine;
an extraction device extracting the premium data from the premium data storage device based on the model information received from the mobile device; and
a premium data transmission device transmitting the premium data, extracted by the extraction device, to the mobile device.

11. A server to be used in a service providing system comprising a gaming machine including a code information display device displaying code information which is coded based on model information uniquely numbered for each model of the gaming machine so that an image capture device captures the code information from an outside from the gaming machine; and a mobile device equipped with the image capture device, wherein
the server operative to transmit data to and receive the same from the mobile device via network and includes:
a premium data storage device storing premium data to be transmitted to the mobile device in association with the model information;
a code information recognition device recognizing the code information based on image data received from the mobile device and generating the model information based on the recognized code information;
an extraction device extracting the premium data from the premium data storage device based on the model information generated by the code information recognition device; and
a premium data transmission device transmitting premium data, extracted by the extraction device, to the mobile device.

12. A mobile device to be used in a service providing system comprising a gaming machine including a code information display device displaying code information which is coded based on model information uniquely numbered for each model of the gaming machine so that an image capture device captures the code information from an outside of the gaming machine; and a server operative to transmit data to and receive the same from the mobile device via a network, wherein
the mobile device equipped with the image capture device and includes:
a code information recognition device recognizing the code information based on image data obtained when the image capture device captures the code information and generating the model information based on the recognized code information; and
a model information transmission device that transmits the model information, generated by the code information recognition device, to the server.

13. A gaming machine comprising:
a payout device paying out a predetermined number of game media when a predetermined condition is established;
a payout number storage device storing a payout number of game media being paid-out by the payout device; and
a code information display device displaying code information which is coded based on payout number data generated depending on the payout number stored in the payout number storage device so that an image capture device captures the code information from an outside of the gaming machine.

14. A gaming machine according to claim 13, further comprising:
a variable display device providing a variable display of a plurality of symbols;
a variable display stop device stopping the variable display of the symbols; and
a special gaming status shift device shifting an operation to a special gaming status to be advantageous for a player when the symbols are stopped in a predetermined winning combination, wherein
the payout number storage device stores the payout number of the game media in the special gaming status.

15. A service providing system comprising:
a gaming machine including: a payout device paying out a predetermined number of game media when a predetermined condition is established; a payout number storage device storing a payout number of the game media paid-out by the payout device; and a code information display device displaying code information which is coded based on payout number data generated depending on payout number stored in the payout number storage device so that an image capture device captures the code information from an outside of the gaming machine;
a mobile device equipped with the image capture device; and
a server operative to transmit data to and receive the same from the mobile device via a network, wherein
the mobile device further includes:
an image data transmission device transmitting image data, obtained when the image capture device captures the code information, to the server;
the server further includes:
a premium data storage device storing premium data, to be transmitted to the mobile device, in association with the payout number data which is generated depending on the payout number of game media;
a code information recognition device recognizing the code information based on the image data received from the mobile device and generating the payout number data based on the recognized code information;
an extraction device extracting the premium data from the premium data storage device based on the payout number data generated by the code information recognition device; and
a premium data transmission device by which the premium data, extracted by the extraction device, is transmitted to the mobile device.

16. A service providing system comprising:
a gaming machine including: a payout device paying out a predetermined number of game media when a predetermined condition is established; a payout number storage device storing a payout number of the game media paid-out by the payout device; and a code information display device displaying code information which is coded based on payout number data generated depending on the payout number stored in the payout number storage device so that an image capture device captures the code information from an outside of the gaming machine;
a mobile device equipped with the image capture device; and
a server operative to transmit data to and receive the same from the mobile device via a network, wherein
the mobile further includes a code information recognition device which recognizes the code information based on image data obtained when the image capture device captures the code information and the includes and generates the payout number data based on the recognized code information; and
a payout number data transmission device that transmits the payout number data, generated by the code information recognition device, to the server;
and wherein the server further includes:
a premium data storage device storing premium data, to be transmitted to the mobile device, in association with the payout number data which is generated depending on the payout number of game media;
an extraction device extracting the premium data from the premium data storage device based on the payout number data received from the mobile device; and
a premium data transmission device transmitting the premium data, extracted by the extraction device, to the mobile device.

17. A server to be used in a service providing system having: a gaming machine including: a payout device paying out a predetermined number of game media when a predetermined condition is established; a payout number storage device storing a payout number of the game media paid-out by the payout device; and a code information display device displaying code information which is coded based on payout number data generated depending on the payout number stored in the payout number storage device so that an image capture device captures the code information from an outside of the gaming machine;
a mobile device equipped with the image capture device; and
the server operative to transmit data to and receive the same from the mobile device via a network, wherein
the server further includes:
a premium data storage device storing premium data, to be transmitted to the mobile device, in association with the payout number data which is generated depending on a payout number of game media;
a code information recognition device recognizing the code information based on the image data received from the mobile device and generating the payout number data based on the recognized code information;
an extraction device extracting the premium data from the premium data storage device based on the payout number data generated by the code information recognition device;
a premium data transmission device by which the premium data, extracted by the extraction device, is transmitted to the mobile device.

18. A mobile device to be used in a service providing system having: a gaming machine including: a payout device paying out a predetermined number of game media when a predetermined condition is established; a payout number storage device storing a payout number of the game media paid-out by the payout device; and a code information display device displaying code information which is coded based on payout number data generated depending on the payout number stored in the payout number storage device so that an image capture device captures the code information from an outside of the gaming machine; and a server operative to transmit data to and receive the same from the mobile device via a network, wherein
the mobile device equipped with the image capture device and includes a code information recognition device which recognizes the code information based on image data obtained when the image capture device captures the code information; and
a payout number data transmission device that transmits the payout number data, generated by the code information recognition device, to the server.

19. A service providing system having a gaming machine, a mobile device equipped with an image capture device, and a server operative to transmit data to and receive the same from the mobile device via a network, wherein
the gaming machine further includes:
a history data storage device storing history data related to a gaming outcome;
a code information display device displaying code information which is coded based on the history data stored in the history data storage device so that the image capture device captures the code information at a predetermined timing;
the mobile device further includes:
an image data transmission device transmitting image data, obtained when the image capture device captures the code information, together with unique ID data of the mobile device or player identifying information for identifying players to the server;
the server further includes:
a point value storage device storing a point value for each of the unique ID data of the mobile device or each of the player identifying information;
a code information recognition device recognizing the code information based on the image data received from the mobile device and generating the history data based on the recognized code information;
a point value updating device setting the point value based on the history data, generated by the code information recognition device, and updating the point value, stored in the point value storage device, in correspondence to the ID data and the player identifying information based on the point value and the ID data or the player identifying information received from the mobile device;
a list data generator generating list data, indicative of a list in which the point values are ranked for the ID data or the player identifying information, respectively, based on the ID data, stored in the point value storage device, or the player identifying information and the point value; and
a list data transmission device transmitting the list data, generated by the list data generator, to the mobile device.

20. A service providing system having a gaming machine, a mobile device equipped with an image capture device, and a server operative to perform transmission and receiving of data with the mobile device via a network, wherein
the gaming machine further includes:
a history data storage device storing history data related to a gaming outcome;
a code information display device displaying code information which is coded based on the history data stored in the history data storage device so that the image capture device captures the code information at a predetermined timing,
the mobile device further includes;
a code information recognition device which recognizes the code information based on image data obtained when the image capture device captures the code information and generates the history data based on the recognized code information; and
a history data transmission device transmitting the history data, generated by the code information recognition device, together with unique ID data of the mobile device and player identifying information for identifying players to the server; and
the server further includes:
a point value storage device storing a point value for each of the unique ID data of the mobile device or each of the player identifying information;
a point value updating device setting the point value based on the history data, received from the mobile device, and updating the point value, stored in the point value storage device, in correspondence to the ID data or the player identifying information, based on the point value and the ID data or the player identifying information received from the mobile device;
a list data generator generating list data, indicative of a list in which the point values are ranked for the ID data or the player identifying information, respectively, based on the ID data, stored in the point value storage device, or the player identifying information and the point value; and
a list data transmission device transmitting the list data, generated by the list data generator, to the mobile device.

21. A gaming machine to be used in a service providing system having the gaming machine, a mobile device equipped with an image capture device, and a server operative to perform transmission and receiving of data with the mobile device via a network, wherein the gaming machine includes:
a history data storage device storing history data related to a gaming outcome; and
a code information display device displaying code information which is generated based on the coded history data stored in the history data storage device so that the image capture device captures the code information at a predetermined timing.

22. A server to be used in a service providing system having a gaming machine which generates code information coded based on game history data related to a game outcome, a mobile device equipped with an image capture device, and the server, wherein the server includes:
a point value storage device storing a point value for each of unique ID data of the mobile device or each of player identifying information;
a code information recognition device recognizing the code information based on image data, received from the mobile device, and generating history data based on the recognized code information;
a point value updating device setting the point value based on history data, generated by the code information recognition device, and updating the point value, stored in the point value storage device, in correspondence to the ID data or the player identifying information, based on the point value and the ID data or the player identifying information received from the mobile device;
a list data generator generating list data, indicative of a list in which the point values are ranked for the ID data or the player identifying information, respectively, based on the ID data, stored in the point value storage device, or the player identifying information and the point value; and
a list data transmission device transmitting the list data, generated by the list data generator, to the mobile device.

23. A mobile device with an image capture device to be used in a service providing system having a gaming machine which generate code information coded based on game history data related to a game outcome, the mobile device, and a server which connects the gaming machine and the mobile device, wherein
the mobile device recognizes the code information based on image data obtained when the image capture device captures the code information and includes:
a code information recognition device recognizing the code information based on the image data, obtained when the image capture device capture the code information, and generating the history data based on the recognized code information; and a history data transmission device transmitting the history data, recognized by the code information recognition device, together with a unique ID data of the mobile device or a player identifying information to the server.

What is claimed is:

1. A gaming machine comprising:
a lottery device executing a lottery for determining whether to afford premium to a player; and
a code information display device displaying code information which is generated based on coded lottery outcome data related to an outcome of the lottery executed by the lottery device so that an image capture device captures the code information from an outside of the gaming machine.

2. The gaming machine according to claim 1, further comprising:
a variable display device providing a variably display of a plurality of symbols;
a variable display stop device stopping the variable display of the symbols; and
a special gaming status shift device shifting an operation to a special gaming status to be advantageous for a player when the symbols are stopped in a predetermined winning combination;
wherein the code information display device displays the code information when the special gaming status is terminated.

3. A service providing system comprising:
a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine;
a mobile device equipped with the image capture device; and
a server operative to transmit data to and receive the same from the mobile device via a network, wherein
the mobile device further includes:
an image data transmission device transmitting image data, obtained when the image capture device captures the code information, to the server;
the server further includes:
a premium data storage device storing the premium data to be transmitted to the mobile device;
a code information recognition device recognizing the code information based on the image data received from the mobile device and generating the lottery outcome data based on the recognized code information;
an extraction device extracting the premium data from the premium data storage device based on the lottery outcome data generated by the code information recognition device; and
a premium data transmission device by which the premium data, extracted by the extraction device, is transmitted to the mobile device.

4. A service providing system comprising:
a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine;
a mobile device equipped with the image capture device; and
a server operative to transmit data to and receive the same from the mobile device via a network, wherein
the mobile device further includes;
a code information recognition device which recognizes the code information based on image data obtained when the image capture device captures the code information and the code information recognition device generating the lottery outcome data based on the recognized code information; and
a lottery outcome data transmission device that transmits the lottery outcome data, generated by the code information recognition device, to the server;
and wherein the server includes:
a premium data storage device storing the premium data to be transmitted to the mobile device;
an extraction device extracting the premium data from the premium data storage device based on the lottery outcome data received from the mobile device; and
a premium data transmission device transmitting the premium data, extracted by the extraction device, to the mobile device.

5. A server to be used in a service providing system comprising a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine; a mobile device equipped with the image capture device, wherein
the server operative to transmit data to and receive the same from the mobile device via a network and includes
a premium data storage device storing the premium data to be transmitted to the mobile device;
a code information recognition device recognizing the code information based on image data received from the mobile device and generating the lottery outcome data based on the recognized code information;
an extraction device extracting the premium data from the premium data storage device based on the lottery outcome data generated by the code information recognition device; and
a premium data transmission device by which the premium data, extracted by the extraction device, is transmitted to the mobile device.

6. A mobile device to be used in a service providing system comprising a gaming machine including a lottery device executing a lottery for determining whether to afford premium to a player; and a code information display device displaying code information which is generated based on coded lottery outcome data related to an outcome of the lottery executed by the lottery device so that an image capture device captures the code information from an outside of the gaming machine; and a server operative to transmit data to and receive the same from the mobile device via a network, wherein
the mobile device equipped with the image capture device and includes a code information recognition device which recognizes the code information based on image data obtained when the image capture device captures the code information and generates the lottery outcome data based on the recognized code information; and
a lottery outcome data transmission device transmitting the lottery outcome data, generated by the code information recognition device, to the mobile device.

7. A gaming machine comprising:
a code information display device displaying code information which is coded based on model information uniquely numbered for each model of the gaming machine so that an image capture device captures the code information from an outside of the gaming machine.

8. The gaming machine according to claim 7, further comprising:
a variable display device providing a variable display of a plurality of symbols;
a variable display stop device stopping the variable display of the symbols; and
a special gaming status shift device shifting an operation to a special gaming status to be advantageous for a player when the symbols are stopped in a predetermined winning combination, wherein
the code information display device displays the code information when the special gaming status is started or the special gaming status is terminated.

9. A service providing system comprising:
a gaming machine including a code information display device displaying code information which is coded based on model information uniquely numbered for each model of the gaming machine so that an image capture device captures the code information from an outside of the gaming machine;
a mobile device equipped with the image capture device; and
a server operative to transmit data to and receive the same from the mobile device via a network, wherein
the mobile device further includes:
an image data transmission device transmitting image data, obtained when the image capture device captures the code information, to the server;
the server further includes:
a premium data storage device storing premium data to be transmitted to the mobile device in association with the model information uniquely numbered for each model of the gaming machine;
a code information recognition device recognizing the code information based on the image data received from the mobile device and generating the model data based on the recognized code information;
an extraction device extracting the premium data from the premium data storage device based on the model information generated by the code information recognition device; and
a premium data transmission device by which the premium data, extracted by the extraction device, is transmitted to the mobile device.

10. A service providing system comprising:
a gaming machine including a code information display device displaying code information which is coded based on model information uniquely numbered for each model of the gaming machine so that an image capture device captures the code information from an outside of the gaming machine;
a mobile device equipped with the image capture device; and
a server operative to transmit data to and receive the same from the mobile device via a network, wherein
the mobile device further includes:
a code information recognition device recognizing the code information based on image data obtained when the image capture device captures the code information and generating the model information based on the recognized code information; and
a model information transmission device that transmits the model information, generated by the code information recognition device, to the server;
and wherein the server further includes:
a premium data storage device storing premium data to be transmitted to the mobile device in association with the model information uniquely numbered for each model of the gaming machine;
an extraction device extracting the premium data from the premium data storage device based on the model information received from the mobile device; and
a premium data transmission device transmitting the premium data, extracted by the extraction device, to the mobile device.

11. A server to be used in a service providing system comprising a gaming machine including a code information display device displaying code information which is coded based on model information uniquely numbered for each model of the gaming machine so that an image capture device captures the code information from an outside from the gaming machine; and a mobile device equipped with the image capture device, wherein the server operative to transmit data to and receive the same from the mobile device via network and includes:
a premium data storage device storing premium data to be transmitted to the mobile device in association with the model information;
a code information recognition device recognizing the code information based on image data received from the mobile device and generating the model information based on the recognized code information;
an extraction device extracting the premium data from the premium data storage device based on the model information generated by the code information recognition device; and
a premium data transmission device transmitting premium data, extracted by the extraction device, to the mobile device.

12. A mobile device to be used in a service providing system comprising a gaming machine including a code information display device displaying code information which is coded based on model information uniquely numbered for each model of the gaming machine so that an image capture device captures the code information from an outside of the gaming machine; and a server operative to transmit data to and receive the same from the mobile device via a network, wherein
the mobile device equipped with the image capture device and includes:
a code information recognition device recognizing the code information based on image data obtained when the image capture device captures the code information and generating the model information based on the recognized code information; and
a model information transmission device that transmits the model information, generated by the code information recognition device, to the server.

13. A gaming machine comprising:
a payout device paying out a predetermined number of game media when a predetermined condition is established;
a payout number storage device storing a payout number of game media being paid-out by the payout device; and
a code information display device displaying code information which is coded based on payout number data generated depending on the payout number stored in the payout number storage device so that an image capture device captures the code information from an outside of the gaming machine.

14. A gaming machine according to claim 13, further comprising:
a variable display device providing a variable display of a plurality of symbols;
a variable display stop device stopping the variable display of the symbols; and
a special gaming status shift device shifting an operation to a special gaming status to be advantageous for a player when the symbols are stopped in a predetermined winning combination, wherein
the payout number storage device stores the payout number of the game media in the special gaming status.

15. A service providing system comprising:
a gaming machine including: a payout device paying out a predetermined number of game media when a predetermined condition is established; a payout number storage device storing a payout number of the game media paid-out by the payout device; and a code information display device displaying code information which is coded based on payout number data generated depending on payout number stored in the payout number storage device so that an image capture device captures the code information from an outside of the gaming machine;
a mobile device equipped with the image capture device; and
a server operative to transmit data to and receive the same from the mobile device via a network, wherein
the mobile device further includes:
an image data transmission device transmitting image data, obtained when the image capture device captures the code information, to the server;
the server further includes:
a premium data storage device storing premium data, to be transmitted to the mobile device, in association with the payout number data which is generated depending on the payout number of game media;
a code information recognition device recognizing the code information based on the image data received from the mobile device and generating the payout number data based on the recognized code information;
an extraction device extracting the premium data from the premium data storage device based on the payout number data generated by the code information recognition device; and
a premium data transmission device by which the premium data, extracted by the extraction device, is transmitted to the mobile device.

16. A service providing system comprising:
a gaming machine including: a payout device paying out a predetermined number of game media when a predetermined condition is established; a payout number storage device storing a payout number of the game media paid-out by the payout device; and a code information display device displaying code information which is coded based on payout number data generated depending on the payout number stored in the payout number storage device so that an image capture device captures the code information from an outside of the gaming machine;
a mobile device equipped with the image capture device; and
a server operative to transmit data to and receive the same from the mobile device via a network, wherein
the mobile further includes a code information recognition device which recognizes the code information based on image data obtained when the image capture device captures the code information and the includes and generates the payout number data based on the recognized code information; and
a payout number data transmission device that transmits the payout number data, generated by the code information recognition device, to the server;
and wherein the server further includes:
a premium data storage device storing premium data, to be transmitted to the mobile device, in association with the payout number data which is generated depending on the payout number of game media;
an extraction device extracting the premium data from the premium data storage device based on the payout number data received from the mobile device; and
a premium data transmission device transmitting the premium data, extracted by the extraction device, to the mobile device.

17. A server to be used in a service providing system having: a gaming machine including: a payout device paying out a predetermined number of game media when a predetermined condition is established; a payout number storage device storing a payout number of the game media paid-out by the payout device; and a code information display device displaying code information which is coded based on payout number data generated depending on the payout number stored in the payout number storage device so that an image capture device captures the code information from an outside of the gaming machine;
a mobile device equipped with the image capture device; and
the server operative to transmit data to and receive the same from the mobile device via a network, wherein
the server further includes:
a premium data storage device storing premium data, to be transmitted to the mobile device, in association with the payout number data which is generated depending on a payout number of game media;
a code information recognition device recognizing the code information based on the image data received from the mobile device and generating the payout number data based on the recognized code information;
an extraction device extracting the premium data from the premium data storage device based on the payout number data generated by the code information recognition device;
a premium data transmission device by which the premium data, extracted by the extraction device, is transmitted to the mobile device.

18. A mobile device to be used in a service providing system having: a gaming machine including: a payout device paying out a predetermined number of game media when a predetermined condition is established; a payout number storage device storing a payout number of the game media paid-out by the payout device; and a code information display device displaying code information which is coded based on payout number data generated depending on the payout number stored in the payout number storage device so that an image capture device captures the code information from an outside of the gaming machine; and a server operative to transmit data to and receive the same from the mobile device via a network, wherein
the mobile device equipped with the image capture device and includes a code information recognition device which recognizes the code information based on image data obtained when the image capture device captures the code information; and
a payout number data transmission device that transmits the payout number data, generated by the code information recognition device, to the server.

19. A service providing system having a gaming machine, a mobile device equipped with an image capture device, and a server operative to transmit data to and receive the same from the mobile device via a network, wherein
the gaming machine further includes:
a history data storage device storing history data related to a gaming outcome;
a code information display device displaying code information which is coded based on the history data stored in the history data storage device so that the image capture device captures the code information at a predetermined timing;
the mobile device further includes:
an image data transmission device transmitting image data, obtained when the image capture device captures the code information, together with unique ID data of the mobile device or player identifying information for identifying players to the server;
the server further includes:
a point value storage device storing a point value for each of the unique ID data of the mobile device or each of the player identifying information;
a code information recognition device recognizing the code information based on the image data received from the mobile device and generating the history data based on the recognized code information;
a point value updating device setting the point value based on the history data, generated by the code information recognition device, and updating the point value, stored in the point value storage device, in correspondence to the ID data and the player identifying information based on the point value and the ID data or the player identifying information received from the mobile device;
a list data generator generating list data, indicative of a list in which the point values are ranked for the ID data or the player identifying information, respectively, based on the ID data, stored in the point value storage device, or the player identifying information and the point value; and
a list data transmission device transmitting the list data, generated by the list data generator, to the mobile device.

20. A service providing system having a gaming machine, a mobile device equipped with an image capture device, and a server operative to perform transmission and receiving of data with the mobile device via a network, wherein
the gaming machine further includes:
a history data storage device storing history data related to a gaming outcome;
a code information display device displaying code information which is coded based on the history data stored in the history data storage device so that the image capture device captures the code information at a predetermined timing,
the mobile device further includes;
a code information recognition device which recognizes the code information based on image data obtained when the image capture device captures the code information and generates the history data based on the recognized code information; and
a history data transmission device transmitting the history data, generated by the code information recognition device, together with unique ID data of the mobile device and player identifying information for identifying players to the server; and
the server further includes:
a point value storage device storing a point value for each of the unique ID data of the mobile device or each of the player identifying information;
a point value updating device setting the point value based on the history data, received from the mobile device, and updating the point value, stored in the point value storage device, in correspondence to the ID data or the player identifying information, based on the point value and the ID data or the player identifying information received from the mobile device;
a list data generator generating list data, indicative of a list in which the point values are ranked for the ID data or the player identifying information, respectively, based on the ID data, stored in the point value storage device, or the player identifying information and the point value; and
a list data transmission device transmitting the list data, generated by the list data generator, to the mobile device.

21. A gaming machine to be used in a service providing system having the gaming machine, a mobile device equipped with an image capture device, and a server operative to perform transmission and receiving of data with the mobile device via a network, wherein the gaming machine includes:
a history data storage device storing history data related to a gaming outcome; and
a code information display device displaying code information which is generated based on the coded history data stored in the history data storage device so that the image capture device captures the code information at a predetermined timing.

22. A server to be used in a service providing system having a gaming machine which generates code information coded based on game history data related to a game outcome, a mobile device equipped with an image capture device, and the server, wherein the server includes:
a point value storage device storing a point value for each of unique ID data of the mobile device or each of player identifying information;
a code information recognition device recognizing the code information based on image data, received from the mobile device, and generating history data based on the recognized code information;
a point value updating device setting the point value based on history data, generated by the code information recognition device, and updating the point value, stored in the point value storage device, in correspondence to the ID data or the player identifying information, based on the point value and the ID data or the player identifying information received from the mobile device;
a list data generator generating list data, indicative of a list in which the point values are ranked for the ID data or the player identifying information, respectively, based on the ID data, stored in the point value storage device, or the player identifying information and the point value; and
a list data transmission device transmitting the list data, generated by the list data generator, to the mobile device.

23. A mobile device with an image capture device to be used in a service providing system having a gaming machine which generate code information coded based on game history data related to a game outcome, the mobile device, and a server which connects the gaming machine and the mobile device, wherein
the mobile device recognizes the code information based on image data obtained when the image capture device captures the code information and includes:
a code information recognition device recognizing the code information based on the image data, obtained when the image capture device capture the code information, and generating the history data based on the recognized code information; and a history data transmission device transmitting the history data, recognized by the code information recognition device, together with a unique ID data of the mobile device or a player identifying information to the server.
